(19) United States
(12) Patent Application Publication
(10) Pub. No.: US 2012/0212064 A1
(43) Pub. Date: Aug. 23, 2012

(54) Methods and Devices for Controlling a Photovoltaic Panel in a Three Phase Power Generation System

(75) Inventors: Sorin Andrei Spanoche, Santa Clara, CA (US); Kent Kernahan, Cupertino, CA (US); Ion Opris, San Jose, CA (US); Paul Scrobohaci, Menlo Park, CA (US); Peter Curzon, Concord, CA (US); Richard Moeller, Sunnyvale, CA (US); Shiloh Hawley, Sunnyvale, CA (US); Aldrin Aviananda, San Jose, CA (US); David Stewart, Sunnyvale, CA (US); Felipe Fuks, Sunnyvale, CA (US); Marc Elpel, Sunnyvale, CA (US)

(73) Assignee: Array Converter Inc., Sunnyvale, CA (US)

(21) Appl. No.: 13/277,977

(22) Filed: Oct. 20, 2011

Related U.S. Application Data
(63) Continuation-in-part of application No. 12/861,815, filed on Aug. 23, 2010.
(60) Provisional application No. 61/432,973, filed on Jan. 14, 2011.

(51) Int. Cl. H02J 1/00; H02M 7/537

(52) U.S. Cl. 307/82; 363/131

(57) ABSTRACT

Methods, apparatus and systems for controlling a photovoltaic panel, to output three-phase power while ensuring the power source operates safely include determining a temperature of the photovoltaic panel, determining a voltage provided from the photovoltaic panel, determining a parameter based on the voltage and the temperature and controlling a DC to three-phase power converter based on the determined parameter. The three-phase power converter may be a pulse amplitude modulated current converter (PAMCC), configured to output first, second and third pulse amplitude modulated current pulse from three terminals controlled in timing and phase so that when respective outputs of multiple PAMCCs are connected, each phase of the plurality of PAMCCs is demodulated to produce a three-phase alternating current output. The PAMCC may be controlled through tables of pulse durations based on the determined parameter. The voltage output may be controlled through a fast control loop and through a slower control loop.

### RELATED APPLICATIONS

This application is a continuation in part of and claims priority to U.S. patent application Ser. No. 12/861,815 entitled “Three Phase Power Generation from a Plurality of Direct Current Sources” filed Aug. 23, 2010. This application also claims the benefit of priority to U.S. provisional Patent Application 61/432,973 entitled “Methods For Controlling A Photovoltaic Panel In A Three Phase Power Generation System” filed Jan. 14, 2011. The entire contents of both applications are incorporated herein by reference.

### FIELD OF THE INVENTION

The present invention relates generally to control of a power generation system connected to a direct current source, and more particularly to a three-phase power generation system.

### BACKGROUND

Photovoltaic panels (“PV”) provide electrical current when exposed to light. For a given level of insolation, the output voltage and current are a function of the load, and their product may be defined as the power delivered by the PV to its load. When the output is open circuit, voltage may be maximized and there may be no current. Likewise when the output terminals of a PV are shorted the current may be maximized but there may be very low voltage across the terminals. In both cases there may be no power delivered. The relationship between power and current is a nonlinear one which may be described by a characteristic current versus voltage curve (“IV curve”). The characteristic curve may be found by experimentation or by testing a panel when it completes manufacture. A complete characterization may be a family of curves, each curve corresponding to a specific value of insolation. It may be desirable to operate a given PV or collection of them at a condition that maximizes the power deliverable to a corresponding load.

FIG. 1 illustrates the current state of the art which provides a number of solar panels configured in a series arrangement. The power from the panels may be converted from direct current to alternating current. However, the efficiency of the string of panels is dramatically degraded by diminished output by any one of the series-connected panels. Sources of diminished output range from bird droppings to shade or partial shade of a portion of the series of panels from overhanging trees. A representation of an example embodiment is illustrated utilizing PV panels 102.1 and 102.n.

FIG. 2 illustrates an example of a conventional grid-connected photovoltaic system, wherein the power provided by the solar system is driven into the grid system of a utility. A representative configuration of a system 202 includes a plurality of panels with a single inverter for converting the direct current provided by the panels into alternating current electrical power. A representation of an example embodiment configuration of self monitoring module integrated micro-inverters is illustrated by system 204.

PVs are expected by their makers to last at least twenty five years. However, the inverters used in today's installations require very large, high capacitance electrolytic capacitors. These capacitors suffer from temperature extremes, their lifetime particularly shortened by high temperature, such as that experienced on a roof. The liquid in these capacitors will eventually leak out of their canisters, and must be replaced in as little as five years by an experienced technician. This leads to an increased lifetime total cost of ownership. An example inverter circuit including an electrolytic capacitor 302 is illustrated in FIG. 3.

### BRIEF DESCRIPTION OF THE DRAWINGS

The accompanying drawings, which are incorporated herein and constitute part of this specification, illustrate exemplary aspects of the invention, and, together with the general description given above and the detailed description given below, serve to explain features of the invention.

FIG. 1 is a component diagram of prior art PV systems and a present embodiment.

FIG. 2 is a component diagram of grid-connected photovoltaic systems showing conventional systems and a present embodiment.

FIG. 3 is a circuit diagram of a prior art inverter circuit.

FIG. 4 is a circuit diagram of a single pulse amplitude modulated current converter.

FIG. 5 is a circuit diagram of a pulse amplitude modulated current converter with a transistor completing the circuit to charge inductors while reconstruction filters produce current pulses for the grid positive half phase.

FIG. 6 is a circuit diagram of a pulse amplitude modulated current converter with current flowing into the reconstruction filters for the grid positive half phase.

FIG. 7 is a circuit diagram of a pulse amplitude modulated current converter with a transistor completing the circuit to charge inductors while reconstruction filters produce current pulses for the grid negative half phase.

FIG. 8 is a circuit diagram of a pulse amplitude modulated current converter with current flowing into the reconstruction filters for the grid negative half phase.

FIG. 9 is a graph relating the timing of drive signals and current.

FIG. 10 is a graph showing a portion of current in a sine wave of current.

FIG. 11 is a graph showing the pulses provided by a single pulse amplitude modulated current converter.

FIG. 12 is a graph showing the pulses provided by two pulse amplitude modulated current converters and their total, summed current.

FIG. 13 is a graph showing the pulses provided by eight pulse amplitude modulated current converters and their total, summed current.

FIG. 14 is a circuit diagram of an alternative circuit for a single pulse amplitude modulated current converter.

FIG. 15 is a graph defining basic phase relationships in a three phase electrical system.

FIG. 16 is a graph showing an example of a most negative voltage phase providing current to two other phases according to the various embodiments.

FIG. 17 is a graph showing an example of a most positive voltage phase providing current to two other phases according to the various embodiments.

FIG. 18 is a circuit diagram of an example of a three phase pulse amplitude modulated current converter configured as an output circuit according to an embodiment.

FIG. 19 is a circuit diagram of an example three phase pulse amplitude modulated current converter configured as a delta output circuit according to an embodiment.

FIG. 20 is a circuit diagram showing the current path for an exemplary conversion cycle related to the current I_{BA} illustrated in FIG. 16.

FIG. 21 is a circuit diagram showing the current path for an exemplary conversion cycle related to the current I_{BC} illustrated in FIG. 16.

FIG. 22 is a graph defining current and time terms as used in various embodiments.

FIG. 23 is a circuit diagram of an example controller for a photovoltaic panel.

FIGS. 24A & 24B are process flow diagrams illustrating an aspect method for calibrating a pulse amplitude modulated current converter.

FIG. 25 is process flow diagram illustrating an aspect method for updating scale factors and various tables.

FIG. 26 is a graph showing the various time periods comprising a switching time according to the various embodiments.

FIG. 27 is a process flow diagram illustrating an aspect method for controlling the three-phase generator output switches.

FIG. 28 is a graph illustrating a portion of an ideal output voltage signal with an example of an actual output signal superimposed.

FIG. 29 is a graph showing current/voltage curves of a photovoltaic panel with various uniform values of insolation.

FIG. 30 is a graph showing current/voltage curves of a photovoltaic panel with various levels of shading of one cell within a photovoltaic panel with an otherwise uniform value of insolation.

FIG. 31 is a graph showing a family of IV curves for a photovoltaic panel, overlaid with various piecewise linear regions.

FIG. 32 is a state diagram illustrating approximations of states for a control device for controlling a photovoltaic panel.

FIG. 33 is a circuit diagram of photovoltaic panel and controller system.

FIG. 34 is a thermal model of a photovoltaic panel.

FIGS. 35A-35G are circuit diagrams of an embodiment controller for a photovoltaic panel for use in a three-phase pulse amplitude modulated current converter system.

FIGS. 36A-36F are circuit diagrams of another embodiment controller for a photovoltaic panel for use in a three-phase pulse amplitude modulated current converter system.

FIG. 37 is process flow diagram illustrating an aspect method for updating tables in response changes in the panel IV curve.

FIG. 38 is a graph showing a family of IV curves for a photovoltaic panel, overlaid with various piecewise linear regions.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

It may be desirable to operate a given PV or collection of PVs at a condition that maximizes the power deliverable to a corresponding load. The maximum power point (“MPPT”) may be considered to be the maximum area under the characteristic IV curve for a given level of insolation. A PV may be controlled by setting its output voltage, thus the current available may be a function of the illumination level. The power available from the PV is then a function of the controlled output voltage and the current generated by the panel. The voltage at which MPPT is attained may differ for different levels of illumination.

The light level experienced by a PV changes during a day as the sun rises and falls. In addition, passing clouds, birds, wind turbine blades, and aircraft may change the light incident on a PV at any instant. Longer term, a PV may experience a change of net light received due to dust and soiling accumulating on the panel, tree growth or nearby construction casting shadows on the panel, and cleaning which may remove dust and soiling. Thus, a control mechanism is needed to keep the PV operating at or near an ideal output voltage for producing power regardless of the light available at any given moment. Due to the possibility of a short duration change in light level, for example due to passing wind turbine blades, it is desirable for the control system to rapidly respond to short-duration changes.

In many instances PVs are used to generate electrical power for a grid system in which the power generated is three phase electricity. A power conversion apparatus, for example an array converter as described herein, may convert the direct current provided by a PV or collection of PVs into the desired three phase power. When the multiphase power is connected to a grid power system, noise and other errors in the grid power may affect the efficiency of power delivery to the grid by the power generation system. It may be beneficial for a power conversion control system to diminish any noise or mismatch between the power generator and a grid to which it is connected.

The amount of power derived from a PV may be substantial, enough to damage connected electronics or even the PV itself. It may be desirable to monitor actual and target operational conditions and override instant or anticipated operation outside of a safe operational envelope.

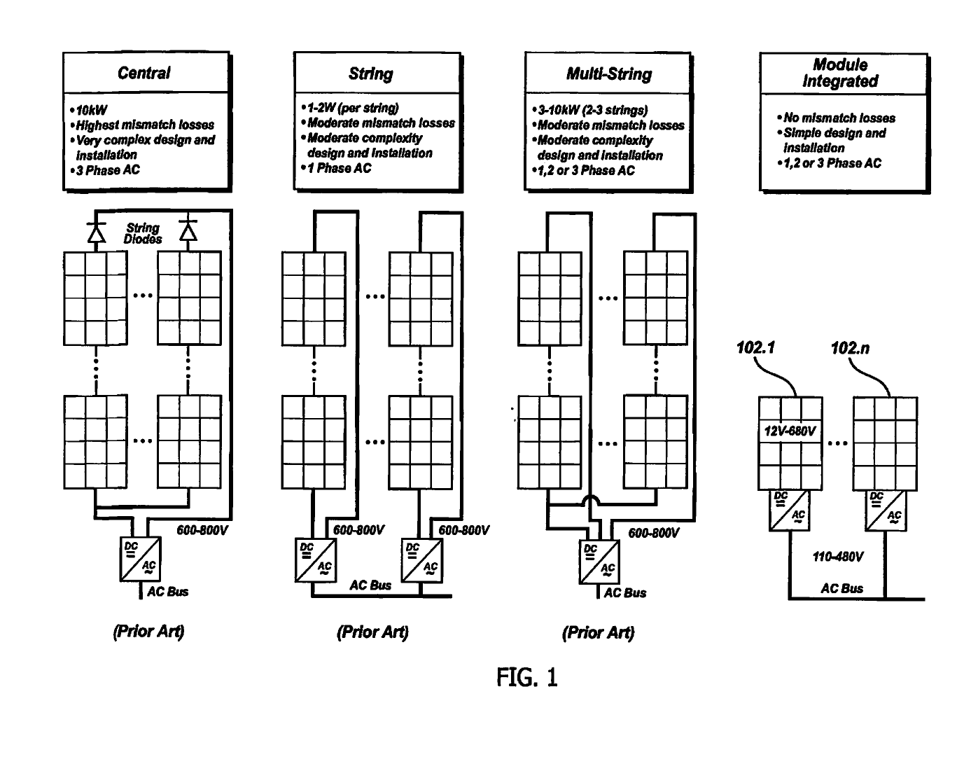

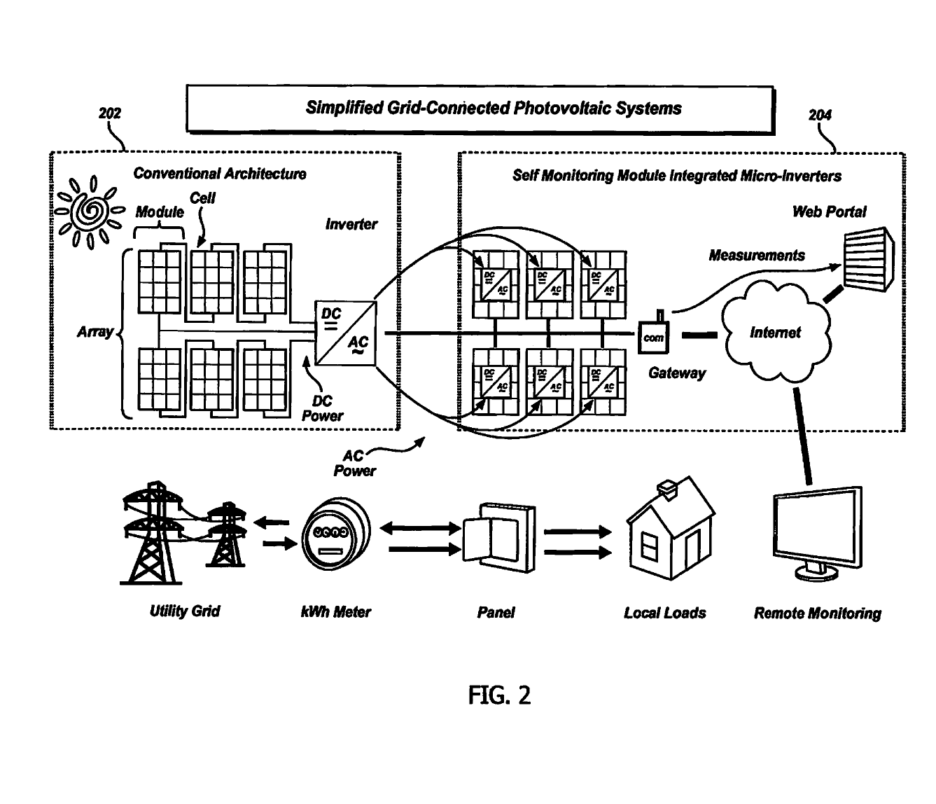

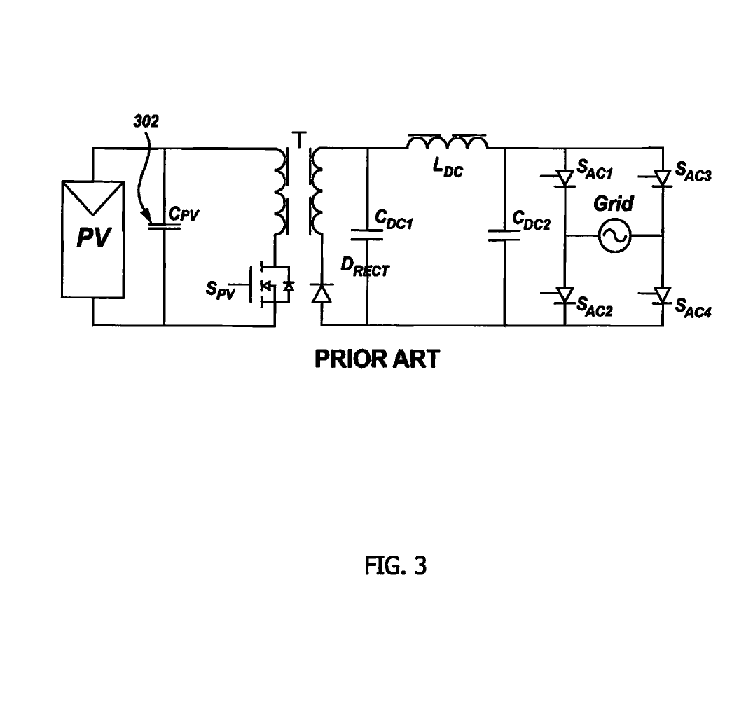

A direct current (DC) pulse amplitude modulated (“PAM”) current converter, denominated a “PAMCC”, may be connected to an individual solar panel (“PV”), and in some embodiments may be configured to output three-phase alternating current (AC). A representation of an example embodiment is illustrated in FIG. 1 utilizing PV panels 102.1 and 102.n, which is shown in FIG. 1. A representation of an example embodiment of the present invention is illustrated in FIG. 2 as system 204. Note that each panel of 204 includes a converter.

A solar panel typically may be comprised of a plurality, commonly seventy-two, individual solar cells connected in series, wherein each cell may provide approximately 0.5 volt at some current, the current being a function of the intensity of light flux impinging upon the panel. The PAMCC may receive direct current (“DC”) from a PV and may provide pulse amplitude modulated current at its output. The pulse amplitude modulated current pulses may typically be discontinuous or close to discontinuous with each pulse going from near zero current to the modulated current and returning to near zero between each pulse. The pulses may be produced at a high frequency relative to the signal modulated on a sequence of pulses. The signal modulated onto a sequence of pulses may represent portions of a lower frequency sine wave or other lower frequency waveform, including DC. When the PAMCC's output is connected in parallel with the outputs of similar PAMCCs an array of PAMCCs may be formed, wherein the output pulses of the PAMCCs may be out of phase with respect to each other. An array of PAMCCs may be constructed to form a distributed multiphase inverter whose combined output may be the demodulated sum of the current pulse amplitude modulated by each PAMCC. If the signal modulated onto the series of discontinuous or near discontinuous pulses produced by each PAMCC is an AC current sine wave, then a demodulated, continuous AC current waveform may be produced by the array of PAMCCs. This AC current waveform may be suitable for use by both the “load”, meaning the premises that may be powered or partially powered by the system, and may be suitable for connection to a grid. For example, in some embodiments an array of a plurality of PV-plus-PAMCC modules may be connected together to nominally provide split-phase, Edison system 60 cps 240 volt AC to a home.

In the various embodiments, a PAMCC may be controlled by a controller executing a control loop. The control loop may be embodied in a program stored in memory that is executed by a processor or by a state machine, or by programmable logic, such as a field programmable gate array (“FPGA”) that is part of the controller. In some embodiments the control loop may be partitioned between firmware and logic. In the various embodiments the control loop may comprise a fast “inner loop” portion that runs continuously, and a one or more slower “outer loops” which may require more time to complete. The outer loops may from time to time change various values that may be saved in shared memory, wherein the faster inner loop may use an instant value that has been most recently saved into shared memory, and the outer loops may update their various values asynchronously to the inner loop.

In the various embodiments, startup values may be prepositioned in memory for a given three-phase PAMCC. During startup the prepositioned values may be used by the control loop, then the values may be modified during ongoing operation. In the various embodiments a table of look up values may speed up calculation speeds, wherein the values may be modified by a scaling factor responsive to instant conditions. The scaling factors may be influenced primarily by temperature and instant insolation, and, optionally, by other conditions. Each of the three phases may be corrected against an ideal output curve, thereby also balancing the power.

Various embodiments may be suitable for power conversion from any direct current source to an arbitrary output signal configuration. Examples of suitable direct current sources include batteries, wind turbines, geothermal, chemical, tidal and piezoelectric power sources. Examples of output signal configurations include sinusoidal alternating current, direct current, trapezoidal, Gaussian, square wave, triangle wave, and adaptive signals. Adaptive signals may include, for example, modifying the output waveforms on a cycle-by-cycle or other time period basis to adapt to, modify, or cancel the effect of transient noise or other conditions. Such signals may also include symbols modulated or superimposed on the base (carrier) signal as a method for communicating between modules, subsystems, or out of systems modes.

To clearly describe the operation of the present invention, the operation of a similar two-phase system is described first. The operation of a three phase system according to the present invention then involves a different output stage.

In a single phase system, a PAMCC may be connected to an individual solar panel (PV). A solar panel typically may be comprised of a number, commonly seventy-two, of individual solar cells connected in series, wherein each cell may provide approximately 0.5 volt at some current. The current produced by individual solar cells is a function of the intensity of light flux impinging upon the panel. The PAMCC may receive direct current (DC) from a PV and may provide pulse amplitude modulated current at its output. The pulse amplitude modulated current pulses may typically be discontinuous or close to discontinuous with each pulse going from near zero current to the modulated current and returning to near zero between each pulse. The pulses may be produced at a high frequency relative to the signal modulated on a sequence of pulses. The signal modulated onto a sequence of pulses may represent portions of a lower frequency sine wave (e.g., a 60 Hz AC current waveform) or other lower frequency waveform, including DC.

When the PAMCCs output is connected in parallel with the outputs of similar PAMCCs, an array of PAMCCs may be formed in which the output pulses of the PAMCCs may be out of phase with THD (Total Harmonic Distortion) PCM (Pulse Code Modulation). PCM is a digital representation of an analog signal where the magnitude of the signal is sampled regularly at uniform intervals, then quantized to a series of symbols in a digital (usually binary) code. THD is a measure of noise on a signal with respect to each other. An array of PAMCCs form a distributed multiphase inverter whose combined output is the demodulated sum of the current pulse amplitude modulated by each PAMCC. If the signal modulated onto the series of discontinuous or near discontinuous pulses produced by each PAMCC was an AC current sine wave, then a demodulated, continuous AC current waveform may be produced by the array of PAMCCs. This AC current waveform may be suitable for use by both the “load”, meaning the premises that may be powered or partially power by the system, and suitable for connection to a grid. For example, in some embodiments an array of a plurality of PV-plus-PAMCC modules may be connected together to nominally provide a split-phase, Edison system 60 cps 240 volt AC to a home.

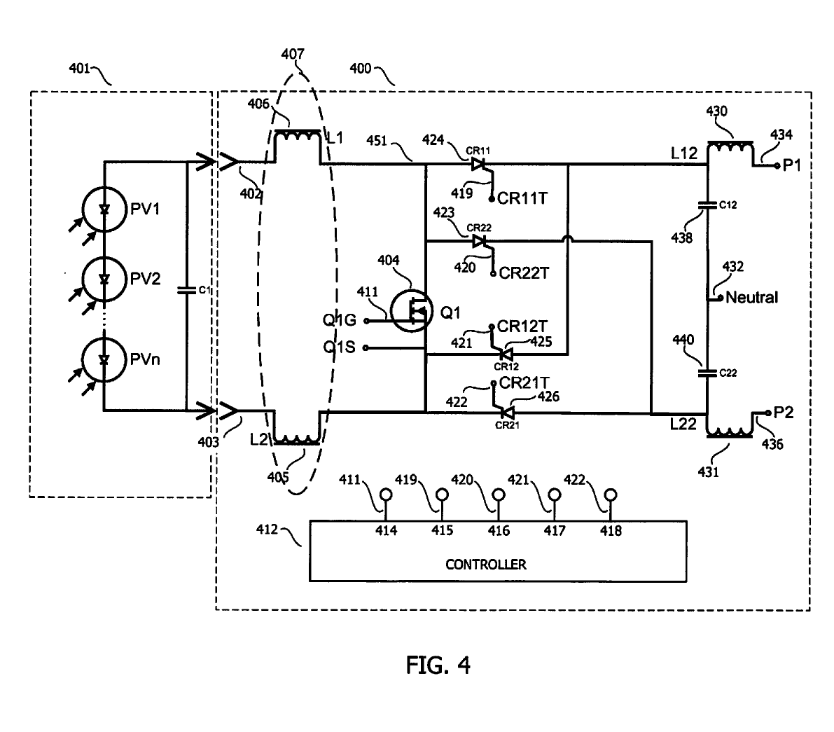

Before discussing an array comprising a plurality of PV-plus-PAMCC modules, an individual PAMCC is described. For example, referring to FIG. 4, a PV panel is electronically represented by the diodes and capacitor C1 shown as reference numeral 401. Collectively, the components comprising a PAMCC (or sometimes “micro inverter”) may be referred to as simply “the PAMCC 400.” Current may be provided by the PV 401 to a positive input terminal 402 and a negative input terminal 403. The positive input terminal 402 may be connected in series with a coil L1 406. The negative input terminal 403 may be connected in series with a coil L2 405. In some embodiments (not shown) coils L1 406 and L2 405 may comprise a one-to-one transformer with two input and two output terminals, wherein the two coils may be magnetically coupled, thereby providing essentially the same current in both paths, which may be advantageous for a single-phase system.

In the embodiment for a three-phase system illustrated in FIG. 4, coils 406 and 405 may be independent of each other, i.e., no magnetic coupling. This arrangement may improve efficiency in a three-phase system, in that within any given switching cycle the power delivered by each coil may be approximately equal to the power delivered by the other coil, but only at certain points in a cycle may the voltage across the two coils 405, 406 be equal. The coil pair of L1 406 and L2 405 is referred to collectively as “TI” 407. A switch Q1 404, for example an NMOS FET, may be connected across the load side of the TI 407, with the source of Q1 404 connected in parallel to the negative terminal of the TI 407 output. Though discussed in relation to an example NMOS FET, switch Q1 404 may be any known type of technology capable of performing a switching function, including relays, transistors, bi-polar transistors, insulated-gate bipolar transistors (IGBTs), silicon carbide relays, nitride transistors, thyristors, MOSFETs, series connected MOSFETs, thyristor emulators, and diodes in series with IGBTs to name just a few. Note that the negative sides of the PV 401 and of the PAMCC 400 may be floating; that is, they may not be grounded. A controller 412 may have an output terminal 414 which provides a signal to the control gate (Q1G) of Q1 404 on a line 411. In some embodiments the controller 412 may be a microprocessor with additional logic that is operated by a program. The controller 412 is discussed in more detail below.

The controller 412 may comprise a plurality of output terminals, each operated independently. Controller 412 output terminals 415, 416, 417, and 418 may be connected to the control terminals of four triacs (CRL11 424; CR22 423; CR12 425; and CR21 426 respectively) by four lines 419, 420, 421, and 422 respectively (inner-connections not shown). Each line, therefore each triac, may be independently controlled by control signals from the controller 412. The anode terminals of CRL11 424 and CR22 423 may be connected in parallel to the positive output terminal of TI 407. The cathode terminals of triacs CR12 425 and CR21 426 may be connected in parallel to the negative output terminal of TI 407. The cathode terminal of triac CR11 424 and the anode terminal of triac CR12 425 may be connected in parallel to a coil L12 430. The cathode terminal of triac CR22 423 and the anode terminal of triac CR21 426 may be connected in parallel to a coil L22 431.

A terminal 434 from coil L12 430 is arbitrarily designated as providing a “phase I” (P1) output and a terminal 436 from coil L22 431 is arbitrarily designated as providing a “phase 2” (P2) output. In some embodiments the coils L12 430 and L22 431 are embodied in a one-to-one transformer. In the embodiment illustrated in FIG. 4 coils L12 430 and L22 431 are separate coils. A capacitor C12 438 may be connected across the input side of coil L12 430 and a neutral output terminal 432. Another capacitor C22 440 may be connected across the input side of coil L22 431 and the neutral output terminal 432. In another embodiment there is no neutral output terminal 432 and there is a single capacitor connected across the input terminals of coil L12 430 and L22 431; and the voltage rating of the capacitor may be at least twice that of capacitors C22 440 and C12 438.

Operation of the system may be implemented by control signals on lines 411 and 419 through 422. In particular the control signal sent to the control gate Q1G on line 411 and signals CR11T on line 419; CR22T on line 420; CR12T on line 421; and CR21T on line 422 may connect and disconnect the current provided by PV 401 in a sequence within the PAMCC 400 with a high-frequency period, for example 30 KHz, which provides a PCM signal which is modulated by a slower, 60 cycle pattern, thereby providing an output whose amplitude is a PAM signal approximating a sine wave.

Referring to FIG. 4, the initial conditions may be as follows: Q1 404, CR11 424, CR22 423, CR12 425 and CR21 426 de-energized; coils L1 406, L2 405, L12 430 and L22 431 empty of current; and photovoltaic cells PV1, PV2, and PVn dark. In this condition the grid AC voltage may be applied between P1 434 and P2 436 and experiences a path through L12 430, C12 438, C22 440 and L22 431. The resonate frequency selected for a reconstruction filter comprising L12 430 and C12 438 may be typically chosen to be about one half the switching frequency of Q1 404. The resonate frequency of a reconstruction filter comprising L22 431 and C22 440 may be chosen to be the same as the reconstruction filter of L12 430 and C12 438. In one embodiment the transistor Q1 404 may selected for a specified switching frequency of approximately 30 kHz and the resonate frequency of the reconstruction filters may then be designed for 15 kHz. With the grid AC voltage typically being 60 Hz, an unimportant amount of capacitive reactive load may be presented to the grid.

Circuit operation may begin with the solar panel 401 being exposed to sufficient light to produce significant current. The presence of the current may be observed as an increase in voltage across Q1 404. At this point Q1 404 may be initially turned on by applying a signal from controller 412 on line 411 between Q1G and Q1S. The interface between the controller 412 and the transistor Q1 404 may be optically isolated, transformer coupled, or the controller 412 may be connected to Q1S. In this state L1 406 and L2 405 may begin to charge with current. When the voltage across PV 401 falls to a predetermined value, the time to charge the coils may be noted in order to calculate the current and standard operation may begin with the next grid zero crossing. In one embodiment this may be when the voltage at P1 crosses above P2 while P1 is going positive and P2 is going negative. At this point signals CR11T on line 419 and CR22T on line 421 may be asserted such that CR11 424 and CR21 426 may conduct when current may be applied to them.

CASE I: PWM modulation for positive half wave of the grid.

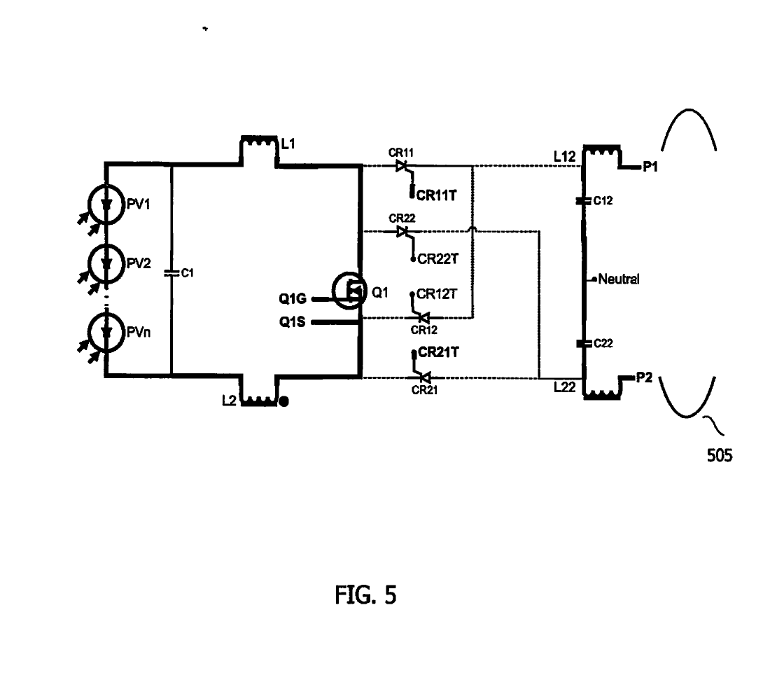

FIG. 5 through FIG. 8 will be referred to in describing the operation of PAMCC 400. Note that the components correspond to those of FIG. 4, but the reference numbers have been left off so as not to obscure the description. However the following description refers to the reference numbers provided by FIG. 4.

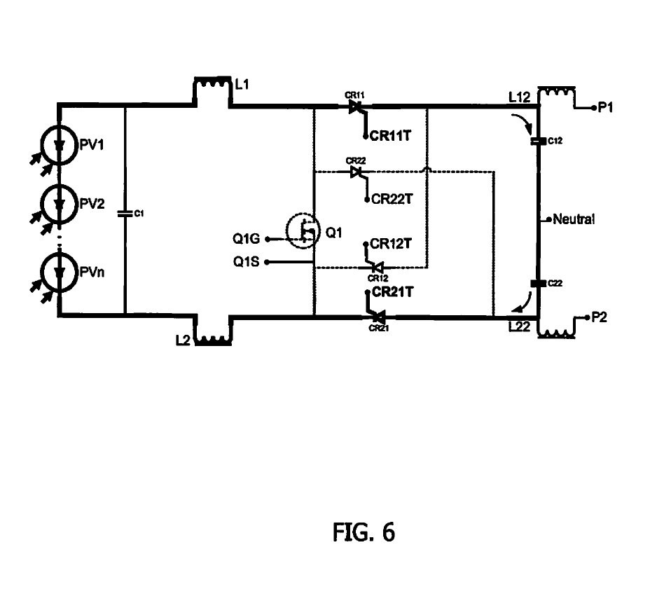

Referring to FIG. 5, with L1 406 and L2 405 charged, Q1 404 may be turned off for a pulse width modulated time. After the off time has expired, Q1 404 may be turned on until the end of the current switching cycle. As illustrated in FIG. 6, during the time that Q1 404 may be off, current previously stored in L1 406 and L2 405, together with the current flowing in PV 401, may be applied to the input terminals of CR11 424 and CR21 426, which may remain enabled as a result of the signals CR11T on line 419 and CR21T on line 421 for the entire positive half cycle of the grid. The positive half cycle of the grid is defined as the condition wherein the voltage at output terminal P1 434 is greater than the voltage at output terminal P2 436. The charge in the current pulse delivered through the triac CR11 424 may be initially stored on capacitor C12 438, creating a voltage more positive on the near end of coil L12 430 relative to the end of coil L12 which may be connected to the output terminal P1 434. The charge in the current pulse delivered through triac CR21 426 may be initially stored on capacitor C22 440, a voltage more negative on the near end of coil L22 431 relative to the end of coil L22 which may be connected to the output terminal P2 436. This may be the initial condition for both the reconstruction filter comprising L12 430, C12 438 and the reconstruction filter comprising L22 431, C22 440. At this point the reconstruction filters may transform the pulse width modulated current pulse delivered to them to a pulse amplitude modulated (PAM) half sine wave of current 505 delivered to the grid as shown in FIG. 5.

The resonate frequency for the reconstruction filters may be chosen to be about one half the switching frequency of Q1 404 so that one half of a sine wave of current may be provided to P1 434 and P2 436 for each pulse width modulated current pulse delivered to them. Since the resonate frequency of each reconstruction filter may be independent of the pulse width of current applied to it, and the charge in the instant current pulse applied to the reconstruction filter may be equal to the charge in the half sine wave of current delivered out of the reconstruction filter to the grid. Changes in the pulse width of input current may be reflected as changes in the amplitude of the output of the reconstruction filters. As the current in the inductors in the reconstruction filters returns to zero, the next pulse of current may be delivered to the capacitors of the reconstruction filters because the frequency of the reconstruction filters may be one half the rate at which pulse width modulated current pulses are produced by Q1 404.

The off time of Q1 404 may be modulated such that the width of current pulses produced may be in the shape of the grid sine wave. The reconstruction filters may transform this sequence of pulse width modulated current pulses into a sequence of pulse amplitude modulated current pulses whose amplitude follows corresponding points of the shape of the grid sine wave.

So long as the grid half cycle remains positive at the terminal P1 434 relative to the output of terminal P2 436, further current pulses may be produced by repeating the process described hereinbefore, beginning at “CASE I: PWM modulation for positive half wave of the grid”.

The negative zero crossing of the grid voltage is defined as the condition wherein the voltage at terminal P1 434 may be equal to the voltage at terminal P2 436 after P1 434 has been more positive than P2 436. Prior to the negative zero crossing, Q1 404 may be turned on, thereby removing current from CR11 424 and CR21 426. At this point the signals CR11T in line 419 and CR21T in line 421 may be de-asserted, preventing triacs CR11 424 and CR21 426 from conducting current during the grid negative half cycle. After the negative zero crossing, with the voltage of terminal P1 434 more negative than the voltage of terminal P2 436, the signals CR22T 420 and CR12T 421 may then be asserted, enabling CR22 423 and CR12 425 to conduct when current is applied to them.

CASE 2: PWM modulation for negative half wave of grid

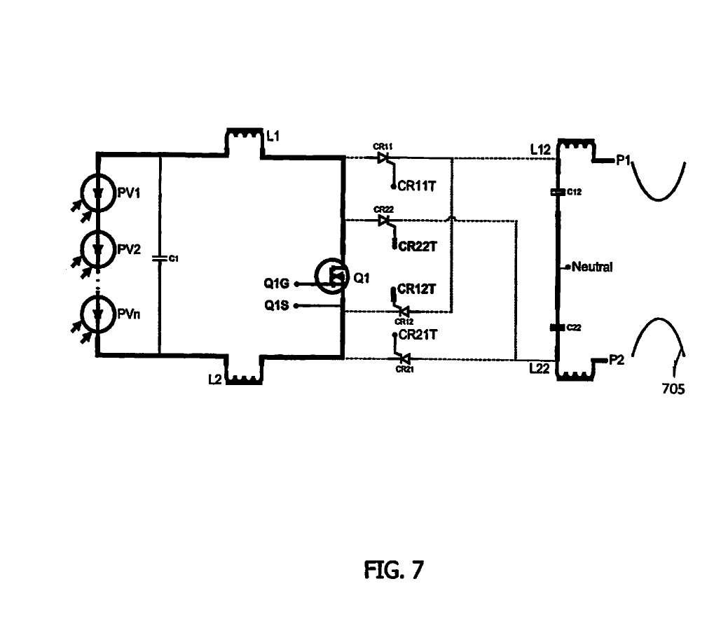

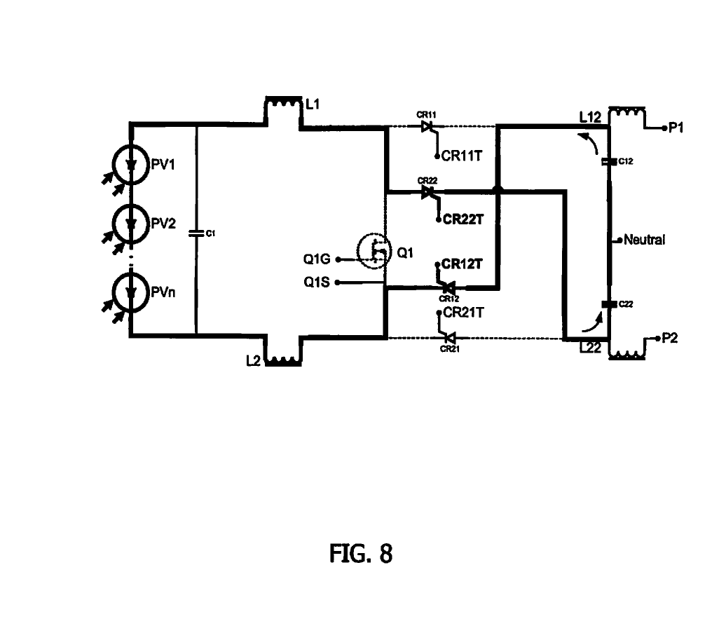

Referring to FIG. 7, with L1 406 and L2 405 charged Q1 404 may be turned off for a pulse width modulated time. After the off time has expired, Q1 404 may be turned on until the end of the instant current switching cycle. As illustrated in FIG. 8, during the time that Q1 404 may be off, current previously stored in L1 406 and L2 405 together with the current flowing in PV 401 may be applied to the input terminals of CR12 425 and CR22 423 which may remain enabled by signals CR22T 420 and CR12T 421 for the entire negative half cycle of the grid. The negative half cycle of the grid may be defined as the condition wherein the voltage at terminal P1 434 is less than the voltage at terminal P2 436. The charge in the current pulse delivered through the triac CR22 423 may be initially stored on capacitor C22 440, creating a voltage more positive on the near end of coil L22 431 relative to the end connected to terminal P2 436. The charge in the current pulse delivered through CR12 425 may be initially stored on C12 438, a voltage more positive on the near end of coil L12 430 relative to the end connected to terminal P1 434. This may be the initial condition for both reconstruction filter comprising L12 430, C12 438 and reconstruction filter comprising L22 431, C22 440. At this point the reconstruction filters may transform the pulse width modulated current pulse delivered to them to a pulse amplitude modulated (PAM) half sine wave of current 705 delivered to the grid as shown in FIG. 7.

The reconstruction filters for Case 2 may be the same components as described in association with Case I; their design and operation are not repeated here.

The off time of Q1 404 is modulated such that the width of current pulses produced may be in the shape of the grid sine wave. The reconstruction filters may transform this sequence of pulse width modulated current pulses into a sequence of pulse amplitude modulated current pulses whose amplitude follow corresponding points of the shape of the grid sine wave.

So long as the grid half cycle remains negative, with the voltage of terminal P1 434 more negative than the voltage of terminal P2 436, further current pulses may be produced by repeating the process described above, beginning at “CASE 2: PWM modulation for negative half wave of grid.”

The positive zero crossing of the grid voltage may be defined as the condition wherein the voltage at terminal P1 434 is equal to P2 436 after the voltage at terminal P1 434 has been more negative than the voltage of terminal P2 436. Prior to the positive zero crossing, Q1 404 may be turned on, removing current from triacs CR12 425 and CR22 423. At this point the signals CR12T 421 and CR22T 420 may be de-asserted, preventing triacs CR12 425 and CR22 423 from conducting current during the grid positive half cycle. After the positive zero crossing with P1 434 more positive than P2 436, signals CR11T 419 and CR21T 421 may be asserted, enabling triacs CR11 424 and CR21 426 to conduct when current is applied to them.

With the grid again positive, the process may again return to the process described above, beginning with the section labeled CASE 1: PWM modulation for positive half wave of the grid.

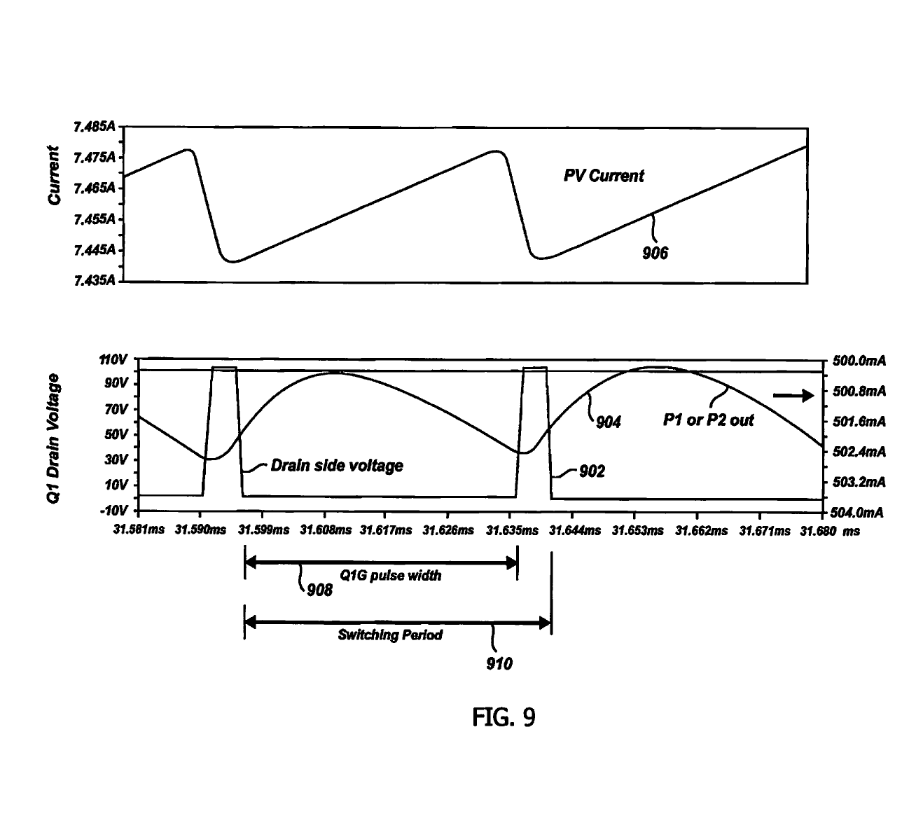

FIG. 9 illustrates a signal diagram of the results of the conversion of a pulse width modulated pulse, translated into a pulse amplitude modulated (PAM) current pulse by a reconstruction filter, such as those previously discussed above (L12 430 and C12 438; L22 431 and C22 440). The short duration roughly rectangular voltage pulses 902 are the voltage on the drain side of Q1 404. The pulse width labeled 908 approximates the pulse width of the signal Q1G on line 411 (FIG. 4) and the period 910 is the switching period of the PAMCC 400. This voltage drives the TI 407 and PV 401 currents through a triac CR11 424 or CR12 425 (depending upon the instant status of the control signals from controller 412, as previously described) into the input of one of the reconstruction filters. The rounded half wave rectified sine wave 904 is the output of the reconstruction filter. As the pulse width 908 (approximately) of the input pulse increases, the amplitude of the output wave form 904 increases. The triangular wave form 906 at the top of the graphs plots the variation of current through PV 401 during the common window of time. Trace 906 shows the effect of TI 407 in maintaining a relatively constant PV 401 current, independent of the relatively large pulse width modulated current pulses provided to the reconstruction filters.

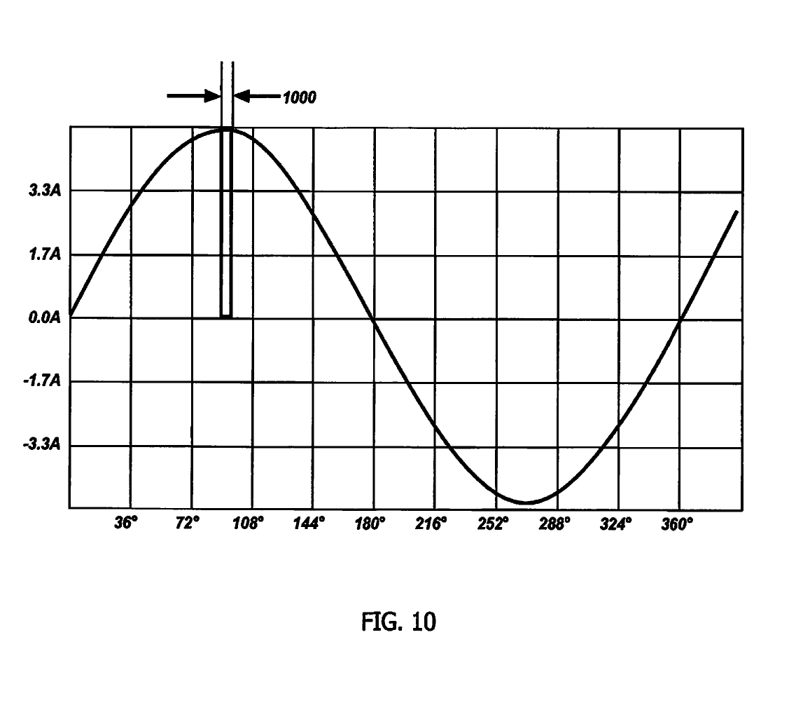

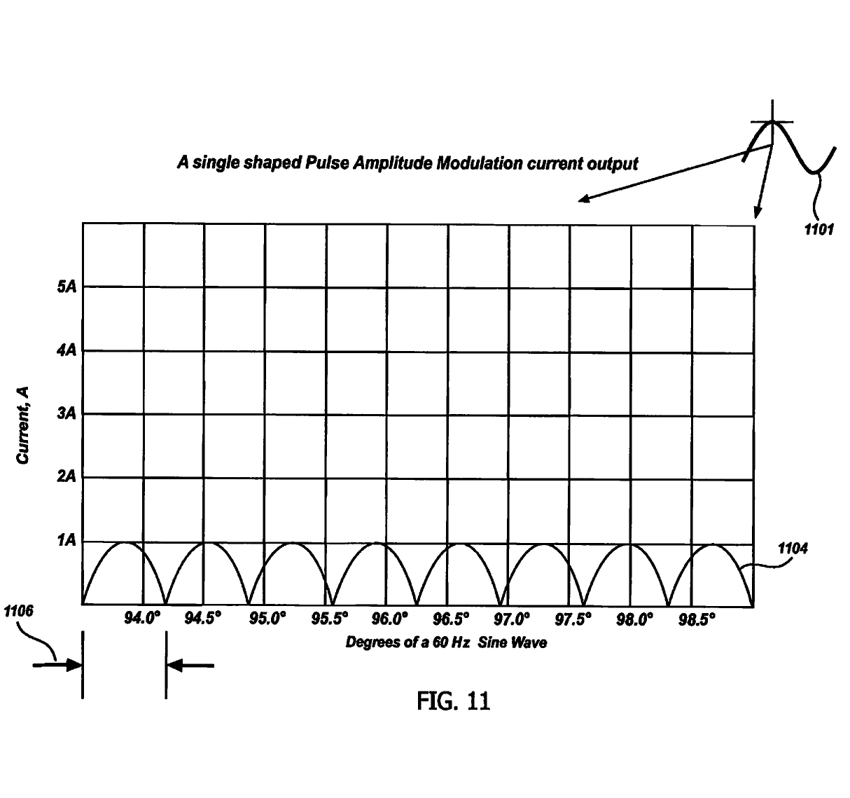

FIG. 10 illustrates the narrow time slice of a grid sine wave cycle to be illustrated in FIGS. 11, 12 and 13.

FIG. 11 illustrates the pulse amplitude modulated output current of a single PAMCC 400. Note that the amplitude shown is for a small portion of time near the positive peak of the grid voltage as indicated on the cycle example 1101. The individual pulses 1104 have a period 1106 equal to the period of the switching frequency, for example ( 1/30 KHz).

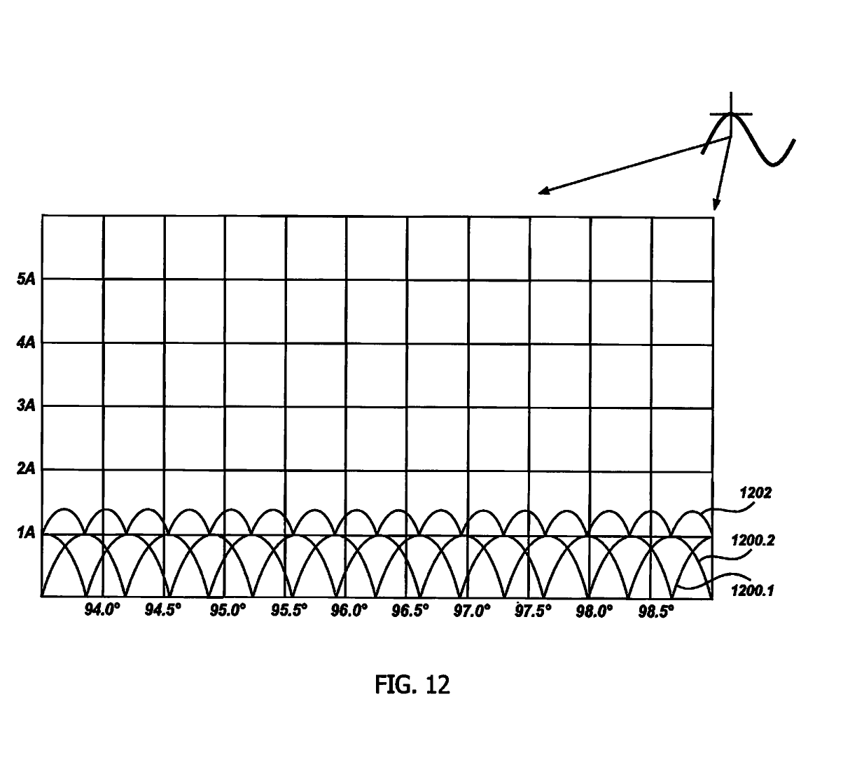

In FIG. 12, two individual currents (1200.1 and 1200.2) of two PAMCCs (each in accordance with the PAMCC 400) are phased apart one half of the period of the switching frequency. The trace 1202 above is the sum of the two PAMCC output currents 1200.1 and 1200.2. Note that the summed current 1202 has a much smaller ripple than the ripple of a single PAMCC (see FIG. 11) and has twice the ripple frequency as of the ripple frequency of a single inverter. The summed current 1202 does not return to zero.

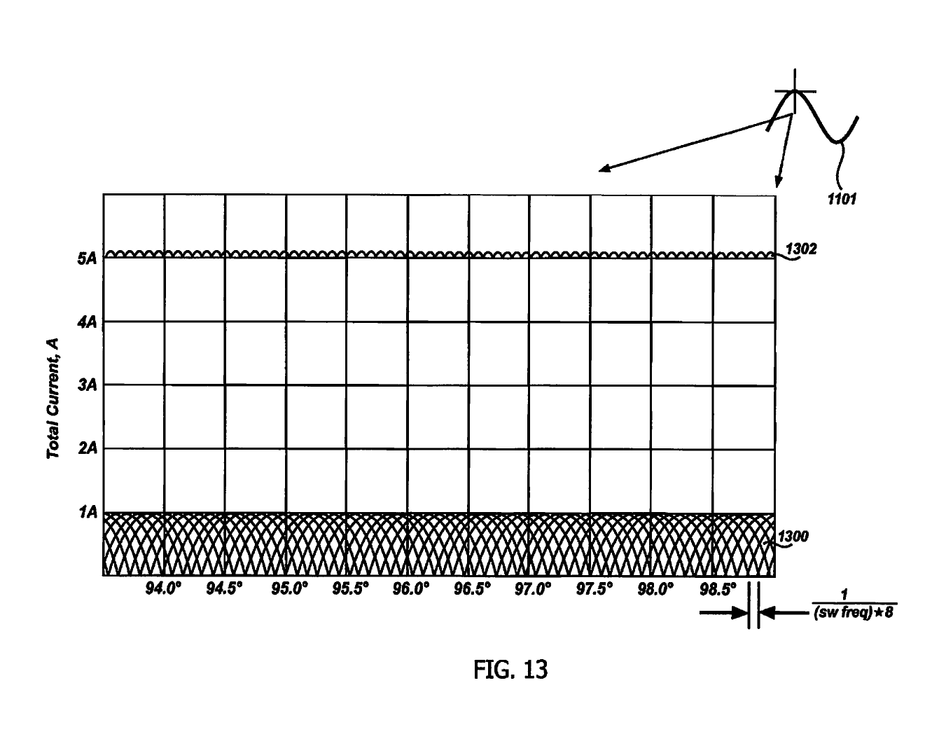

Following on the summation of the currents of two PAMCC 400 outputs, FIG. 13 illustrates the individual output currents of eight PAMCCs (the line 1300 is representative; each waveform is not numbered), each phased evenly across the period of the switching frequency. For example for a system using a 30 KHz switching frequency, the period is 33.3 microseconds and each phase is delayed by (33.3/8), or 4.167 microseconds, relative to the previous output current waveform. Any number of PAMCCs 400 may be so summed. As the number summed increases they are each phase delayed by a smaller number (I/(switching frequency)*n) where “n” is the number of PAMCCs summed. Note that the summed current shown in FIG. 13 has only a fraction of the ripple current of an individual PAMCC (FIG. 12) and has eight times the ripple frequency of that of an individual PAMCC. If each PAMCC 400 is producing a point on a grid sine wave with its sequence of PAM current pulses, phasing and summing a set of PAMCCs, forming an array of converters will effectively demodulate a grid sine wave of current with very high accuracy and very low noise (ripple). Any number of array converters may be phased and summed in this way. As the number of PAMCCs is increased, the ripple amplitude decreases and the ripple frequency increases. In one embodiment two or more of the plurality of PAMCC 400 individual output currents may be in phase with each other. In some embodiments the switching frequency may be selected so as to be unrelated to the grid frequency, for example 60 Hz in the United States, so that the ripple will not represent harmonic distortion. Signals modulated onto the PAMCC output are arbitrary. In some embodiments multiple signals are modulated onto the PAMCC output, wherein one of such signals may, for example, provide for communication between an arbitrary two or more PAMCC modules. The PAMCC modulation is sometimes used to correct for distortion in the grid signal.

One of several ways to choose the phasing of the arrayed PAMCCs 400 may be for each PAMCC 400 to be pre-assigned a timing slot number, with the first slot being scheduled following a zero crossing and each PAMCC 400 firing its PAM signal in the predetermined (i.e., assigned) sequence. In some embodiments, especially where the number of PVs may be large, the phase relationship of individual PAMCCs may not be controlled, in that they will naturally be phase separated across a cycle without deterministic phase scheduling.

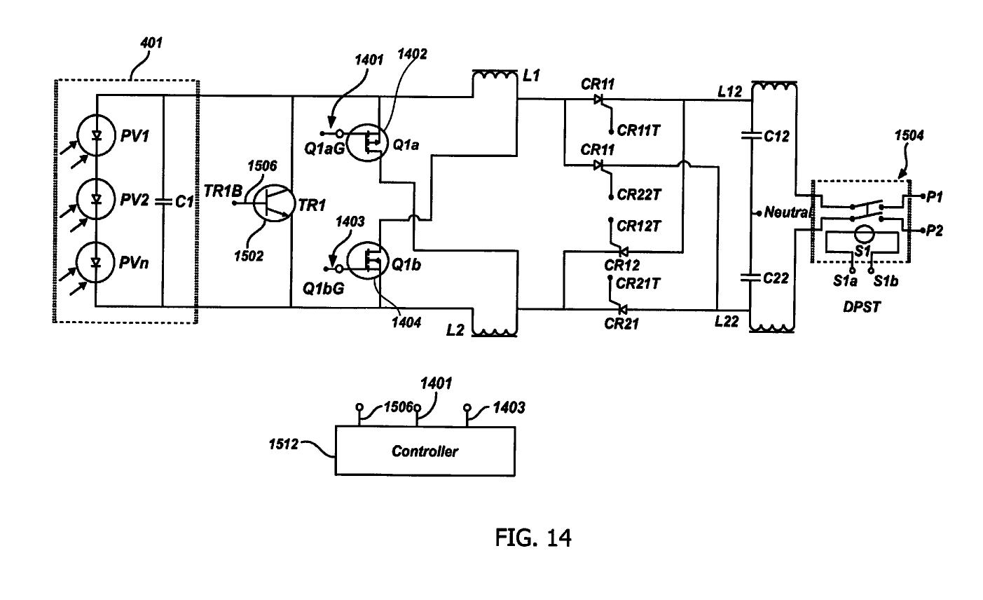

In an alternative embodiment, illustrated in FIG. 14, a second transistor may be added, wherein Q1a 1402 and Q1b 1404 replace the single transistor Q1 404 as was shown and described in the circuit of FIG. 4. Though discussed in relation to example transistors, switches Q1a 1402 and Q1a 1404 may be any known type of technology capable of performing a switching function, including relays, bi-polar transistors, insulated-gate bipolar transistors (IGBTs), silicon carbide relays, nitride transistors, thyristors, NMOS FETs, MOSFETs, series connected MOSFETs, thyristor emulators, and diodes in series with IGBTs to name just a few. Using the two transistors Q1a 1402 and Q1 B 1404 may provide some potential advantages, including reducing the voltage across each transistor, allowing a more relaxed Rds-on (the “on” resistance) requirement for each transistor compared to the Rds-on requirement of Q1 404, and allowing each transistor to be driven with respect to the relatively low voltage and stable anode and cathode ends of PV 401. In this configuration, Q1a 1402 and Q1b 1404 may both be turned on and off at the same times as with Q1 404 in the previous discussion. All other aspects of the circuit operation may remain the same. Q1a 1402 and Q1b 1404 may be of different transistor types, so separate signals to their control gates are provided by the controller 1412. Controller 1412 is otherwise the same as controller 412 of FIG. 4, with the addition of output terminals connected to the control gates of Q1a 1402 and Q1b 1404 via lines 1401 and 1403 respectively.

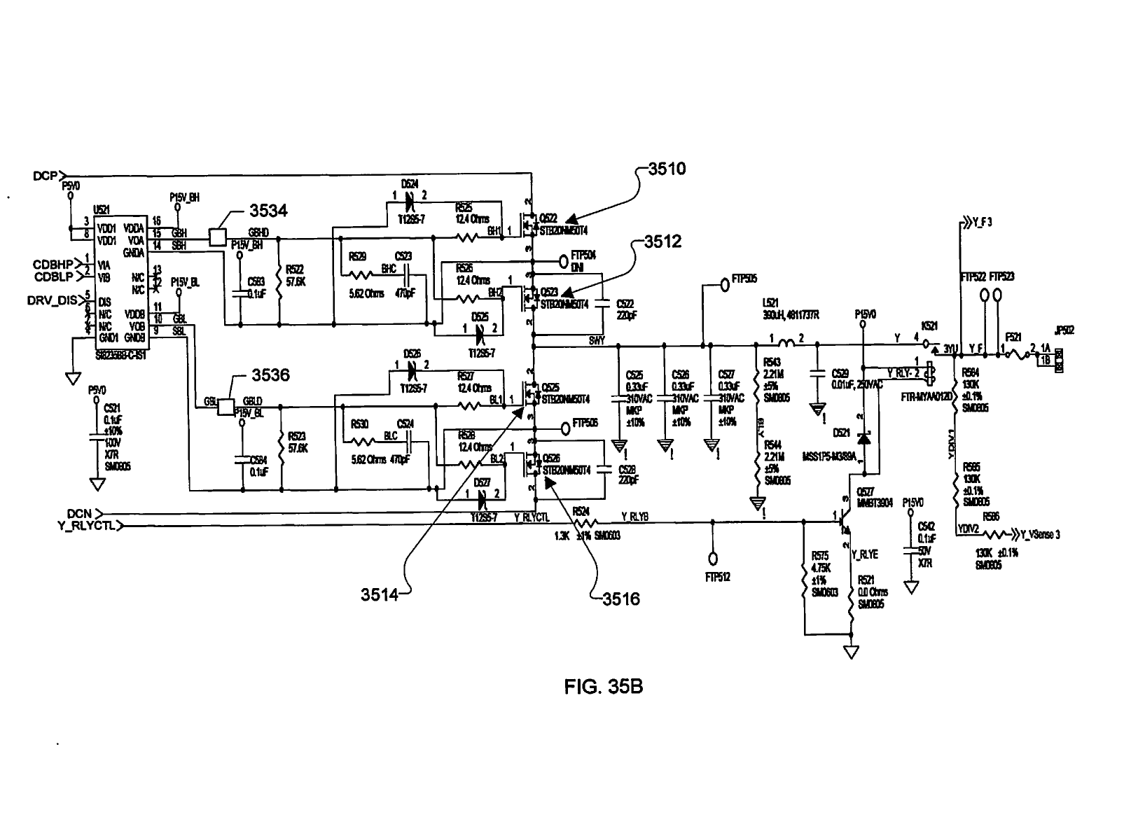

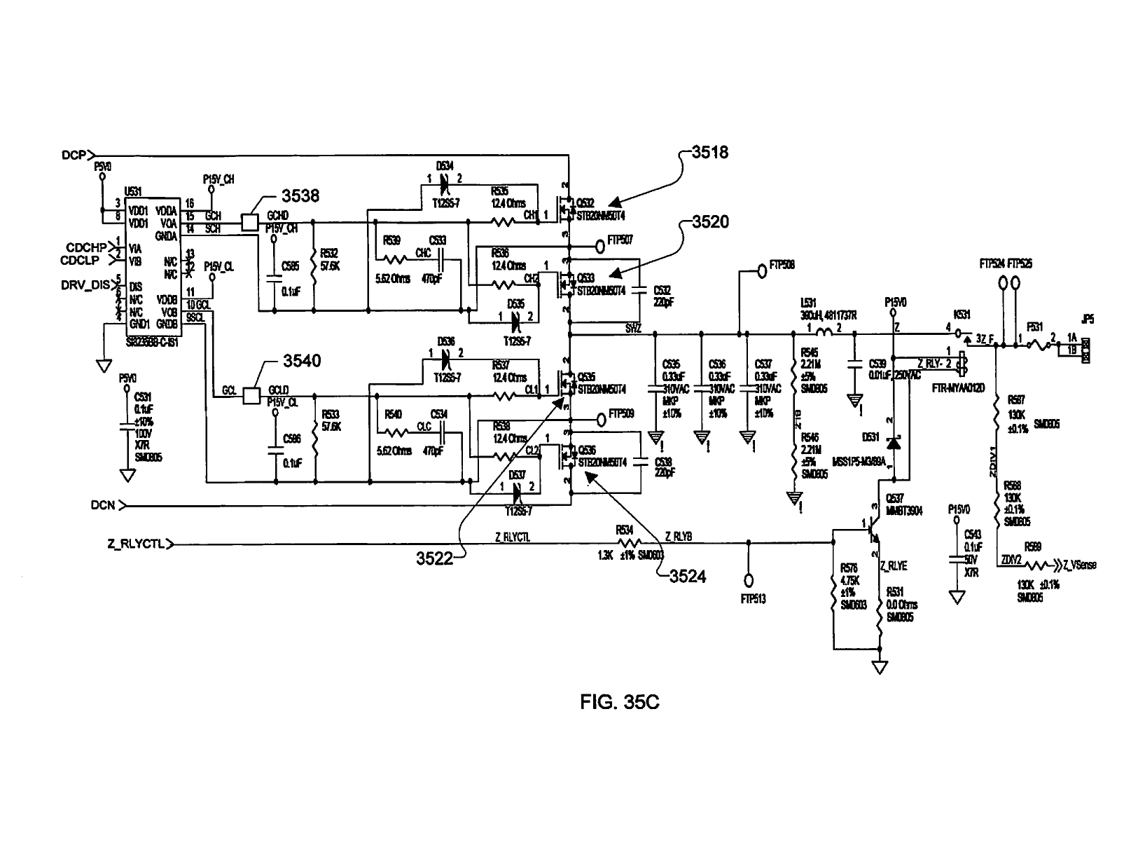

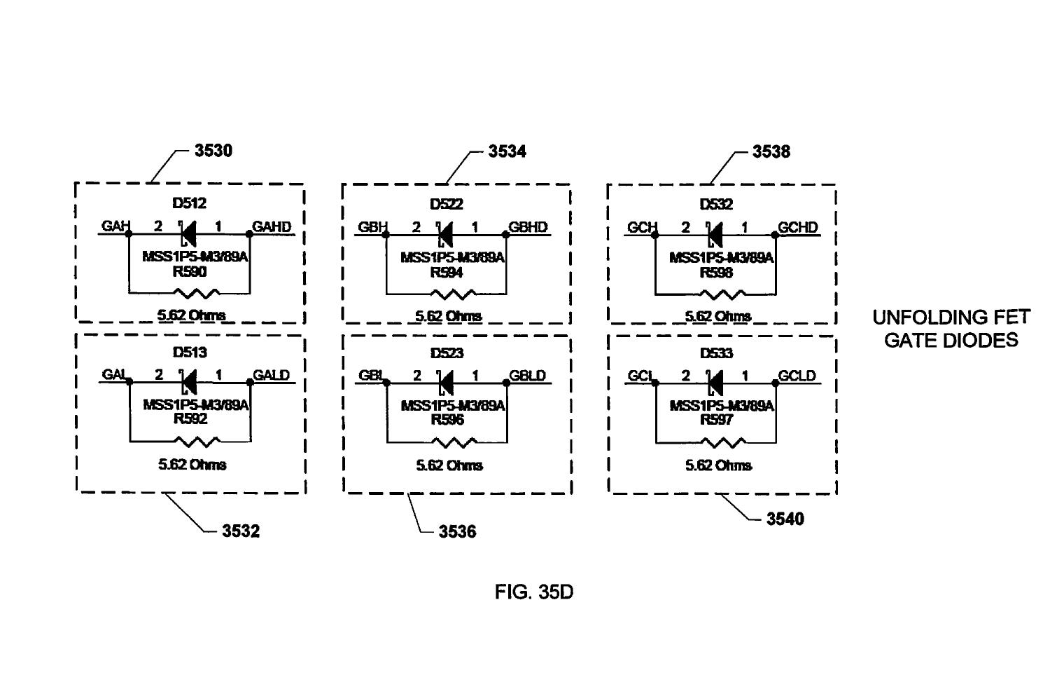

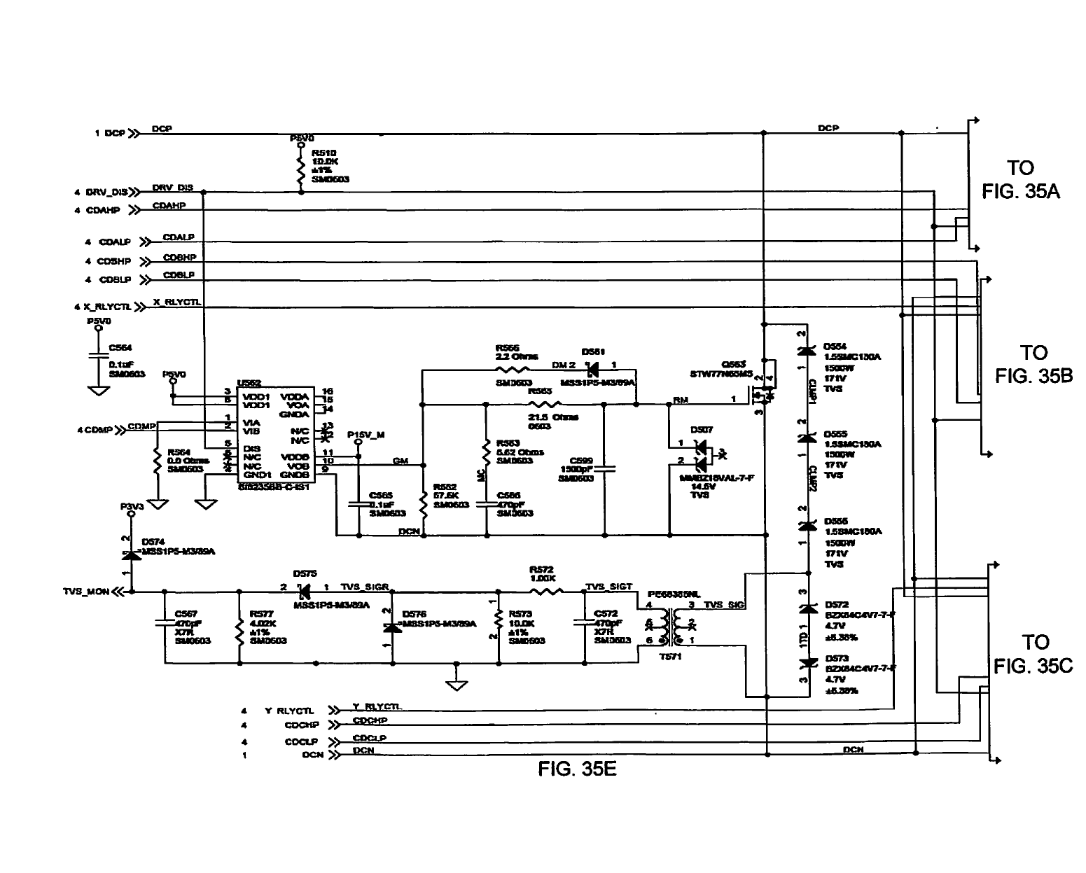

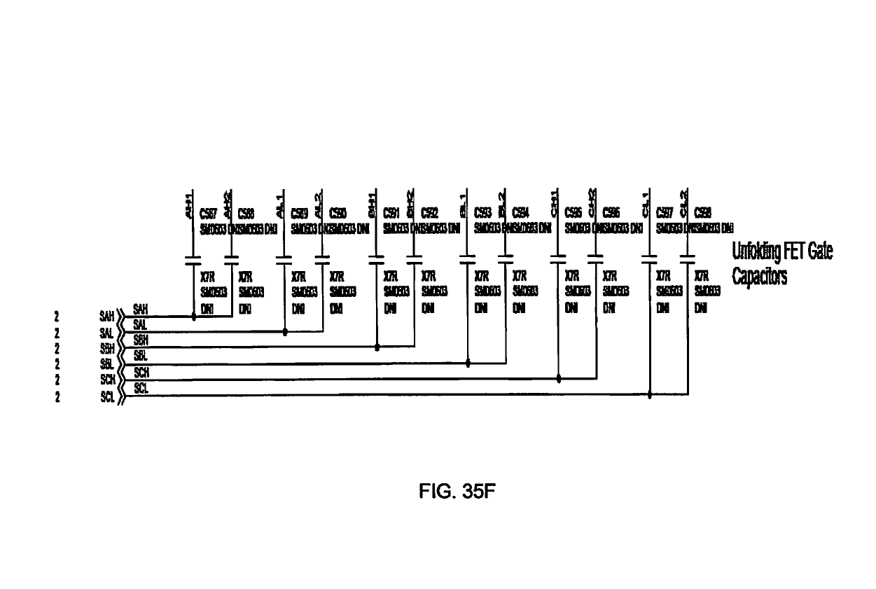

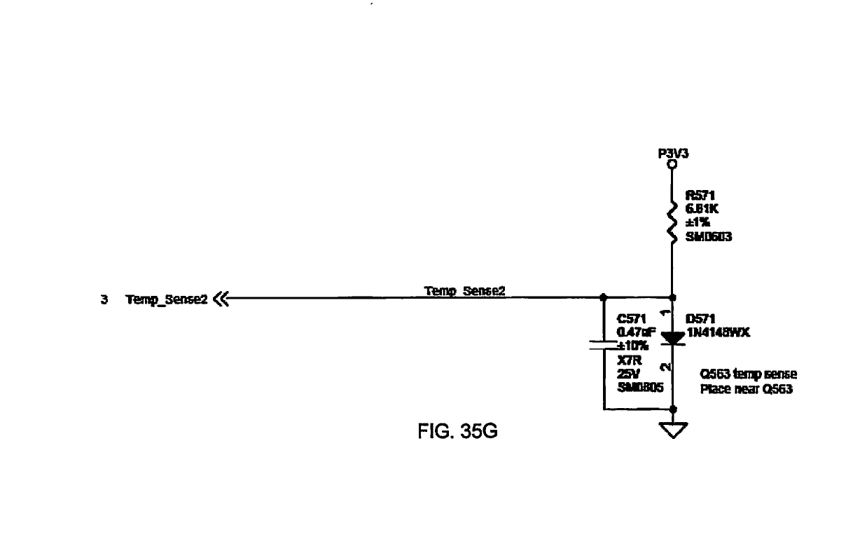

In another alternative embodiment, two pairs of transistors may be used in the output switching section of the single transistor Q1 404 to replace CR11T 424 and CR12T 425. Each pair of transistors may allow the voltage to be higher or lower on either side of the transistor pair. Of each pair, one transistor may function in a manner similar to an efficient diode, and the other may function as a switch because the normal voltage during an ON state may be in one direction from high to low. FIGS. 35A-C illustrate switching sections embodying the two pairs of transistors.

In some embodiments the system may be shut down for safety, maintenance, or other purposes. One example of a shut-down system is illustrated in FIG. 14. A transistor TR1 1502 and a relay S1 1504 are added to a PAMCC. The two transistors Q1a 1402 and Q1b 1404 described in relation to FIG. 14 are shown, however the same shut-down provision may be added to the circuit of FIG. 4, wherein the two transistors Q1a and Q1b may be replaced by the single transistor Q1 404. Transistor TR1 1502 and relay S1 1504 may provide for the safe shutdown of the PAMCC while connected to PV 401, which may be illuminated and producing power. The shutdown process may be initiated by providing a signal TR1B from a controller 1412 on a line 1506, the line 1506 connected to the control gate of the transistor 1502. When transistor TR1 1502 turns on, TR1 1502 may create a short path for current produced by PV 401, which may result in the voltage across PV 401 being reduced to a small level. At this point, Q1a 1402 and Q1b 1404 may be energized to allow the currents in the coils L1 406 and L2 405 to fall to a low level. After the coils L1 406 and L2 405 are discharged, the relay S1 1504 may be opened. With the path to the grid now open, Q1a 1402 and Q1b 1404 may be turned off, followed by turning off transistor TR1 1502. In this configuration, no further power may be produced.

A solar panel may be controlled by an electronic module, the module including means for measuring the temperature of the panel cells, the voltage across the panel, and for controlling the power (current) provided by the panel. A solar panel may be expected to provide a certain output voltage under good operating conditions, as determined by specification, characterization data, or by the experience derived by accumulating performance data over time. The current available may be a function of the intensity of sunlight incident upon the panel, and the voltage a function of the temperature of the cells, assuming otherwise normal conditions for the cells. As described above, a weak cell, due to damage, deterioration, soil, or simply partial shading of the panel, may not provide the same power as may the other, unaffected cells. Because all cells in a string are electrically in series, the current must be in common. Therefore the weak cell may adjust for the instant lower power capacity by lowering the voltage for that cell. Again because the cells are electrically connected in series, the voltage across the string may be the sum of the voltages of all the cells in the string. When a cell in the string loses some voltage, the whole string may lose voltage as well.

An electronic module typically tests a panel periodically, for example once per hour, to determine the maximum power point (MPPT) operating condition. This may be accomplished by varying the current demanded from a panel, measuring the voltage across the panel, then determining the power for that condition as the product of voltage times current. By varying across a certain range of currents, a peak power point may be found. Previously, such MPPT testing was done without regard to whether the condition selected may drive a weak cell in a string into a forward bias condition, thereby causing the bypass diodes to be forward biased, as described hereinbefore.

In the various embodiments, the electronic module may first determine the temperature of the solar panel cells, determine expected panel voltage for the temperature found, and may not allow the current to cause the voltage to drop more than a predetermined amount below the expected voltage. For example, in one embodiment the maximum value below MPP to be allowed may be:

RT MPP−tolerance−degradation(temp)

Wherein RT MPP may be the maximum power point condition for room temperature, “tolerance” may be a value provided by the solar panel manufacturer, and degradation(temp) may be the diode drop value that results from increasing temperature, for example −2.1 my/degree C. for a silicon solar cell. These values may be different for other solar cell chemistries.

As a result, if there were in fact bypass diodes the bypass diodes may never be forward biased, therefore the diodes may not be needed and a solar panel paired with the various electronic module embodiments may be made without bypass diodes, thereby saving the area that would be required for the interconnect of the bypass diodes.

The various embodiments avoid the condition of a hot spot without the use of an efficiency-lowering protection diode. The various embodiment methods assume an apparatus may be used to control the operating conditions of the panel, wherein the apparatus includes means for measuring the total voltage across the strings and means for changing the operating conditions of the panel. Bypass diodes may not be needed nor used, saving the area required for interconnect as required by previous methods. In the various embodiments, the instant voltage may be compared to the expected voltage for a measured operating temperature. If the voltage is less than expected by more than a certain amount, the power (current) demanded from the panel may be reduced such that the voltage may be less than a diode drop of the expected voltage, thereby avoiding a hot spot. In this manner, reducing the current may ensure that the voltage does not decrease below a determined safe limit. With hot spots (i.e., reverse biasing of a weak cell), avoided, bypass diodes may not be needed.

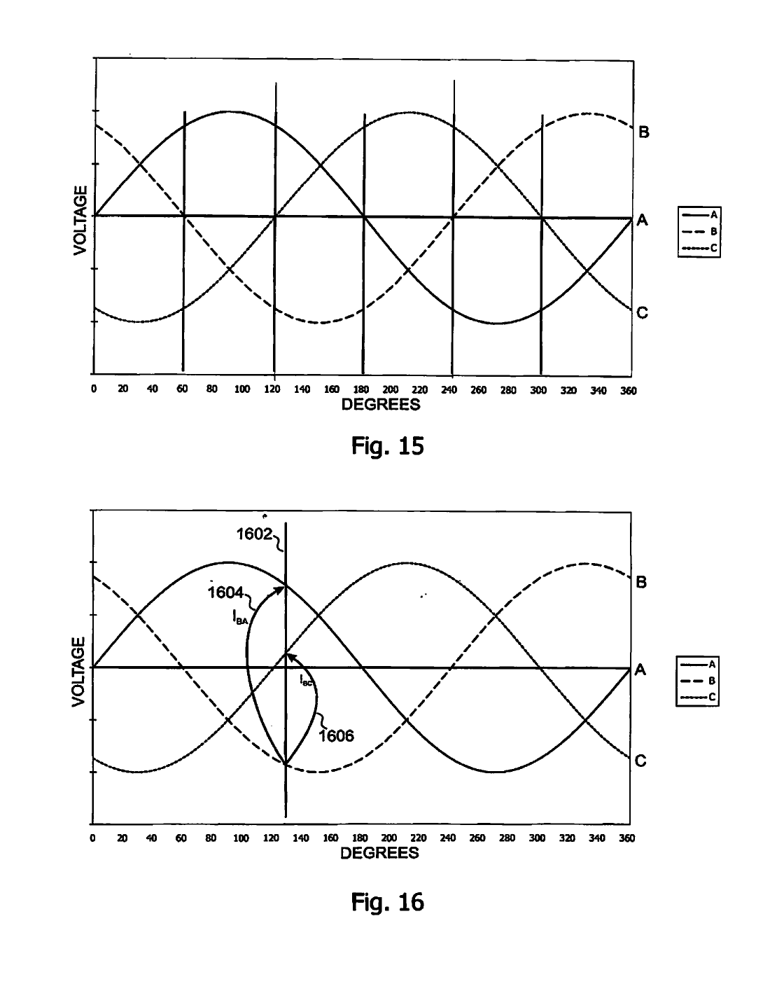

While the preceding description of the pulse amplitude modulation current converter technology addressed a two-phase system, the technology may also be applied to three-phase electrical systems such as typical in electric utility grids. FIG. 15 illustrates the phase relationship between the phases of a three phase system. This and the following graphs label the vertical axis as representing voltage, but for a fixed voltage system the axis would also represent current. The three phases are arbitrarily designates as phases A, B, C. Three phase circuits are configured in a “wye” arrangement or a “delta” arrangement, which is well known in the art. In a wye circuit, the common node is referred to as “N”. As illustrated in FIG. 15, the phases are 120 degrees apart. Note that in any given sixty degree window two phases will be of the same polarity and the third phase will be of the opposite polarity.

For a commercial power generator, the generation system may be connected to a low impedance three phase grid, wherein the power (therefore, the voltage-current product) may be kept the same. Accordingly, for a system according to the various embodiments the power in each of the three phases may be equal.

In a system according to the various embodiments, current may be driven from a common reference of a given polarity to two terminals of the opposite polarity. Referring to FIG. 16, at a point in time of a grid cycle 1602, phase B is a negative voltage and phase A and phase C are both positive voltages. To maintain the desired voltages on phases A and B, current I_{BA} 1604 is driven from Phase B to Phase A, then current I_{BC} 1606 is driven from Phase B to Phase C. Note that positive current is being driven into positive voltage nodes, therefore the power delivered is positive.

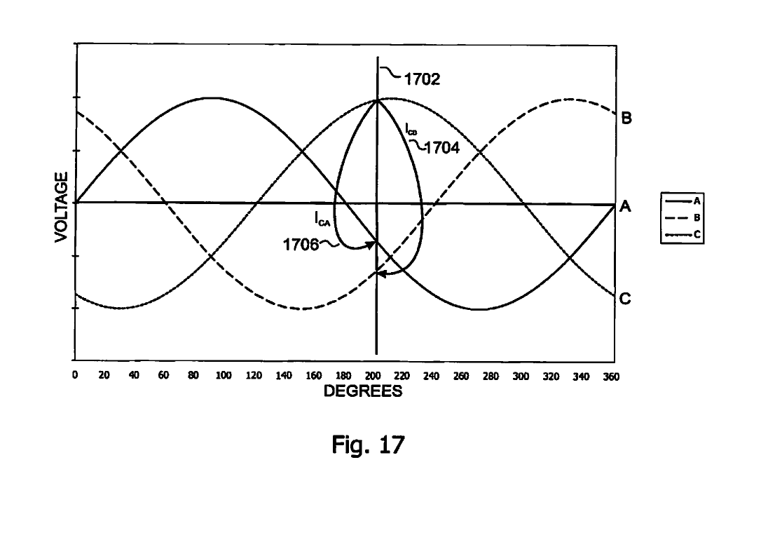

Now referring to FIG. 17, at time 1702 Phase C is a positive voltage and Phases A and B are negative voltages. Therefore Phase C is selected as the common reference, and drive current SLB 1704 from Phase C to Phase B, and then drive current I_{CA} 1706 from Phase C to Phase A.

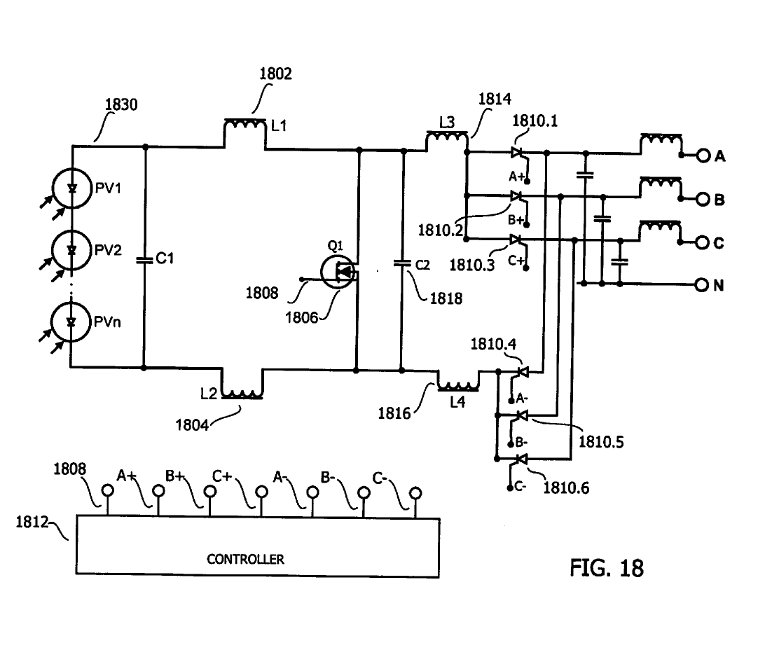

FIG. 18 illustrates an example of an embodiment circuit that may be configured from time to time to charge up the coils L1 1802 and L2 1804, as described above. The charge in the coils may be provided to two output terminals as previously described with reference to FIG. 16 and FIG. 17. In this embodiment the output stage is in a wye configuration.

In the example of FIG. 18, six thyristors 1810.1, 1810.2, 1810.3, 1810.4, 1810.5, and 1810.6 (herein after referred to generally as “1810.n”) provide ON/OFF switching in each of six lines to three output terminals (A, B, C). Control signals to the control gates of the thyristors 1810.n may be provided by a controller 1812, wherein the controller 1812 includes logic, a programmed microprocessor, or other means for making decisions and generating the appropriate control signals in accordance with the method of the present invention. In some embodiments MOSFETs may be used instead of the thyristors 1810.n. Thyristors generally may be slower than MOSFETs. In embodiments using thyristors 1810.n, some embodiments may provide a smoothing circuit comprising a coil L3 1814 in the high side branch, a coil L4 1816 in the low side branch, and a capacitor C2 1818. The smoothing circuit 1814, 1816, and 1818 may provide for a longer time period of current pulses, thereby accommodating the slower response times of thyristors.

A switch Q1 1806, typically a MOSFET, may be driven ON in response to a signal on line 1808 from the controller 1812, thereby charging the coils L1 1802 and L2 1804 with current from the photovoltaic panel 1830, as described in the operation of the two-phase system above. Though discussed in relation to an example MOSFET, switch Q1 1806 may be any known type of technology capable of performing a switching function, including relays, transistors, bi-polar transistors, insulated-gate bipolar transistors (IGBTs), silicon carbide MOSFETs, Gallium nitride transistors, thyristors, NMOS FETs, series connected MOSFETs, thyristor emulators, and diodes in series with IGBTs to name just a few. Referring to the example of FIG. 16, it may be desired to drive current from Phase B to Phase A, then from Phase B to Phase C.

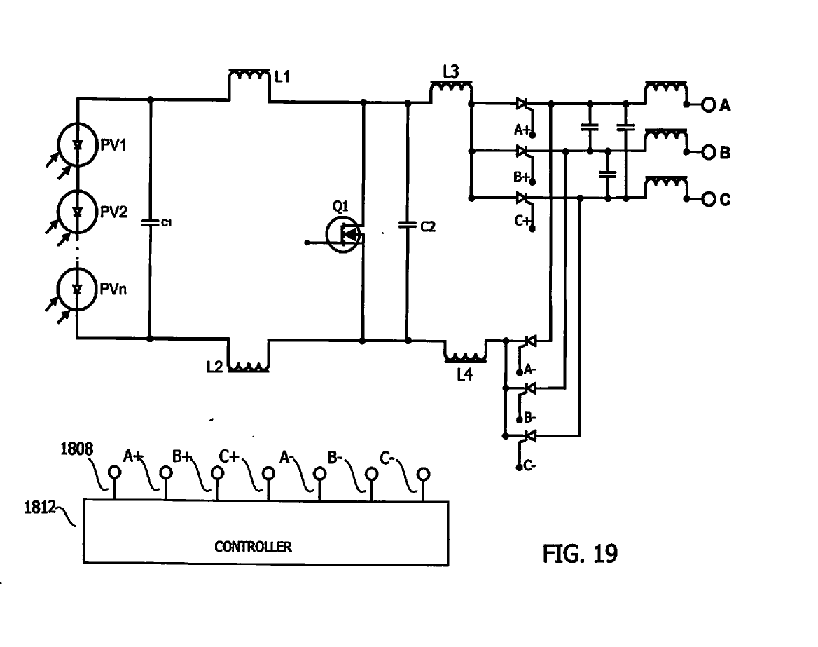

FIG. 19 illustrates an embodiment of the present invention similar to that of FIG. 18, but with the output stage configured as a delta circuit.

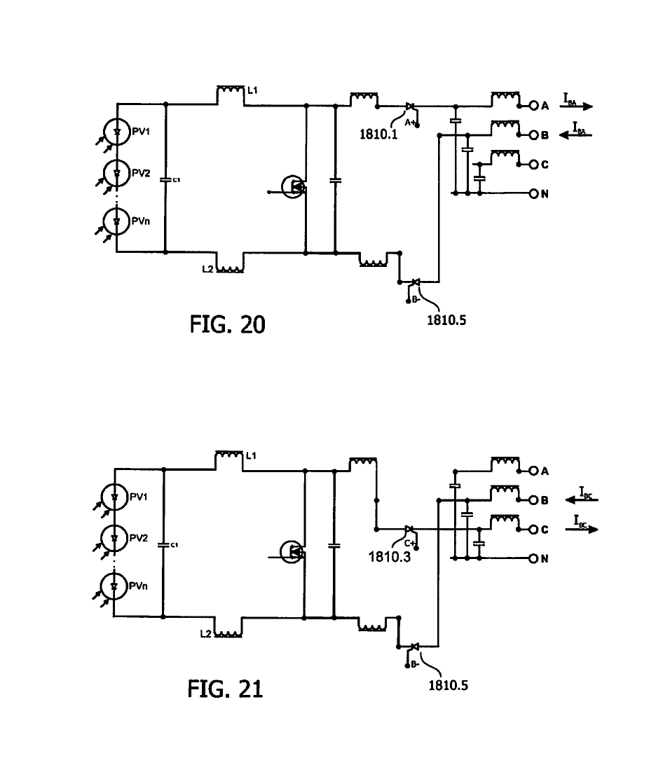

To illustrate the commutation effect of the thyristors, FIG. 20 and FIG. 21 show only those thyristors that are turned on, and unpowered lines are removed for clarity. Referring to FIG. 20, controller 1812 may turn on thyristor B-1810.5 and thyristor A+ 1810.1 with transistor Q1 1806 off. Coils L1 1802 and L2 1804 may be no longer connected through the transistor Q1 1806, therefore their current may be provided into terminal A, and terminal B may be the return path. When terminals B and A have been connected for a predetermined time, thyristor A+ 1810.1 may be turned off and thyristor C+ 1810.3 may be turned on, as shown in FIG. 21.

The process described above may be repeated so long as the phases are within a given sixty degree range. In each case, the thyristor first turned ON may result in the greater voltage change from the common reference. After a time, the thyristor that may result in the lower voltage change may be turned ON. Therefore, during a given sixty degree period the common reference point may always be the same, and during the first thirty degrees one phase may be farther away from the common reference, and during the second thirty degrees the other phase may be farther away. To include all twelve thirty degree time phases, the following thyristors may be controlled to turn ON first, then second for each window per Table 1.

TABLE 1

| | Phase | | | | | | | | | | | |
|---|---|---|---|---|---|---|---|---|---|---|---|---|
| | 0-30 | 30-60 | 60-90 | 90-120 | 120-150 | 150-180 | 180-210 | 210-240 | 240-270 | 270-300 | 300-330 | 330-360 |
| T_{S1} | C−B+ | C−A+ | A+C− | A+B− | B−A+ | B−C+ | C+B− | C+A− | A−C+ | A−B+ | B+A− | B+C− |
| T_{S2} | C−A+ | C−B+ | A+B− | A+C− | B−C+ | B−A+ | C+A− | C+B− | A−B+ | A−C+ | B+C− | B+A− |

In Table 1 the annotations refer to the thyristor labels shown in FIG. 18. For example, “C− B+” indicates to turn on thyristors C− 1810.6 and B+ 1810.2. T_{S1} is the first time period, T_{S2} is the second time period, to be defined hereinafter.

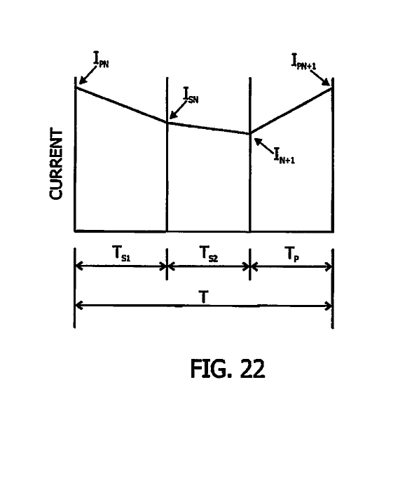

FIG. 22 defines certain time periods and annotation conventions which are used in the following discussion. During time period T_{S1}, current may be driven at an initial value of I_{PN} the common reference to the first (greater difference in voltage, as previously discussed) power rail, the current diminishing to I_{SN} at the end of the time period T_{S1}. At that point the next set of thyristors may be turned on (see Table 1) for a time T_{S2}. The current initially may have a value of I_{SN} and a value of I_{N+1} at the end of the time period T_{S2}. All thyristors may then be turned OFF, and the transistor Q1 1806 may be driven ON by the controller 1812, which provides a signal on line 1808. With Q1 1806 turned ON, the coils L1 1802 and L2 1804 may be recharged by the photovoltaic panel 1830. The period T is a fixed time period, therefore:

Tₚ=T−T_{S1}−T_{S2}

The time period T should be related to a higher frequency than the frequency of the grid being powered. In one embodiment the period T may be related to a frequency that is about 504 times the frequency of the grid, wherein the grid frequency is 60 Hz in the United States and is 50 Hz in most of the rest of the world. The current in each time period of FIG. 22 can be determined in the following manner:

$${I}_{sn} = {I}_{pn} - \frac{( {V}_{o 1} - {V}_{i} )}{L} {T}_{s 1}$$

where V_{O1} is defined as the open circuit voltage for the power rail that is to be driven first, Vi is the voltage from the photovoltaic panel 1830, and L is the equivalent inductance of the two coils L1 1802 and L2 1804, including the effect of mutual inductance. Similarly, the current at the next time period may be calculated from:

$${I}_{n + 1} = {I}_{sn} - \frac{( {V}_{0 \; 2} - {V}_{i} )}{L} {T}_{s 2}$$

where V₀₂ is defined as the open circuit voltage for the power rail that is to be driven second. Referring to FIG. 22,

$${I}_{pn + 1} = {I}_{n + 1} + {V}_{i} \frac{( T - {T}_{s 1} - {T}_{s 2} )}{L} = {I}_{pn} - \frac{( {V}_{o 1} - {V}_{i} )}{L} {T}_{s 1} - \frac{( {V}_{02} - {V}_{i} )}{L} {T}_{s 2} + {V}_{i} \frac{( T - {T}_{s 1} - {T}_{s 2} )}{L}$$

Expanding terms in the equation yields:

$${I}_{pn + 1} = {I}_{pn} + \frac{( - {V}_{01} {T}_{s 1} + {V}_{1} {T}_{s 1} - {V}_{02} {T}_{s 2} + {V}_{i} {T}_{s 2} + {V}_{i} T - {V}_{i} {T}_{s 1} - {V}_{i} {T}_{s 2} )}{L}$$

which after dropping out canceled terms results in:

$${I}_{pn + 1} = {I}_{pn} + \frac{( {V}_{i} T - {V}_{01} {T}_{S 1} - {V}_{02} {T}_{s 2} )}{L}$$

The average current during the time period T_{S1} may be calculated by:

$${i}_{oave 1} = {K}_{R} {V}_{01} = \frac{( {I}_{pn} + {I}_{sn} )}{2} \frac{{T}_{ s 1}}{T} = {I}_{pn} \frac{{T}_{s 1}}{T} - \frac{( {V}_{01} - {V}_{i} )}{2 L} \frac{{T}_{s 1}^{2}}{T}$$

where K_{R} is a conductance term controlled by a slow “outer loop” to provide the current needed. Rewriting terms yields:

$$\frac{{V}_{01} - {V}_{i}}{2 L} \frac{{T}_{s 1}^{2}}{T} - \frac{{I}_{pn}}{T} {T}_{s 1} + {i}_{oave 1} = ∅$$

By defining the terms

$$\frac{{V}_{01} - {V}_{i}}{2 L} \frac{1}{T} = A 1 ;$$

$$\frac{{I}_{pn}}{T} = B 1 ;$$

$${i}_{oave 1} = C 1$$

the following equation can be solve for T_{S1}:

$${T}_{s 1 ( 1 , 2 )} = \frac{B 1 \pm \sqrt{( B {1}^{2} - 4 A 1 C 1 )}}{2 A 1}$$

Similarly for T_{S2}:

$$\begin{matrix}{i}_{oave 2} = {K}_{R} {V}_{02} \\ = \frac{( {I}_{sn} + {I}_{n + 1} )}{2} \frac{{T}_{s 2}}{T} \\ = {I}_{pn} \frac{{T}_{s 2}}{T} - \frac{( {V}_{01} - {V}_{i} ) {T}_{s 1} {T}_{s 2}}{LT} - \frac{( {V}_{02} - {V}_{i} ) {T}_{s 2}^{2}}{2 LT}\end{matrix}$$

$$\frac{{V}_{02} - {V}_{i}}{2 LT} {T}_{s 2}^{2} - \frac{{I}_{pn} - \frac{1}{L} ( {V}_{01} - {V}_{i} ) {T}_{s 1}}{T} \times {T}_{s 2} + {i}_{oave 2} = ∅$$

As before we define the terms:

$$\frac{{V}_{02} - {V}_{i}}{2 LT} = A 2 ; \frac{{I}_{pn} - \frac{1}{L} ( {V}_{01} - {V}_{i} ) {T}_{s 1}}{T} = B 2 ; {i}_{oave 2} = C 2 ;$$

$$then$$

$${T}_{s 2 ( 1 , 2 )} = \frac{B 2 \pm \sqrt{( B {2}^{2} - 4 A 2 C 2 )}}{2 A 2}$$

$${i}_{iave} = {i}_{0 ave 1} + {i}_{0 ave 2} + \frac{( {I}_{n + 1} + {I}_{pn + 1} )}{2} \frac{( T - {T}_{s 1} - {T}_{s 2} )}{T}$$

$${i}_{iave} = {i}_{0 ave 1} + {i}_{0 ave 2} + ( {I}_{pn} + \frac{1}{L} ( - {V}_{01} {T}_{s 1} - {V}_{02} {T}_{s 2} + {V}_{i} \frac{T + {T}_{s 2} + {T}_{s 1}}{2} ) ) ( 1 - \frac{{T}_{s 1} + {T}_{s 2}}{T} )$$

$${V}_{in + 1} - {V}_{i} = Δ {V}_{i} \frac{1}{1 + \frac{{R}_{PV} {C}_{i}}{T}} ( {E}_{PV} - {R}_{PV} {i}_{iave} - {V}_{in} )$$

where EPV and RPV are the Thévenin equivalent of the photovoltaic panel.

A solar powered current source will eventually be unable to provide enough current to meet the demand of the load as the sun sets or storm clouds move in. As the target current approaches the maximum available the target current is gradually reduced to minimize THD.

The various embodiments for controlling a three-phase PAMCC module may include an apparatus for controlling the operation of a PV. For example, the various PAMCCs in an array converter system, each connected to a corresponding PV and further connected in parallel with other PAMCCs, may be controlled to provide a three phase alternating current output. The output voltage may be controlled to match that of a connected grid power system. The current, and therefore power, available may be determined based on the radiance impinging on the PV, efficiency, and other factors. By controlling each PV to operate at or near its individual maximum power point condition, the power available from the system as a whole may be increased as well.

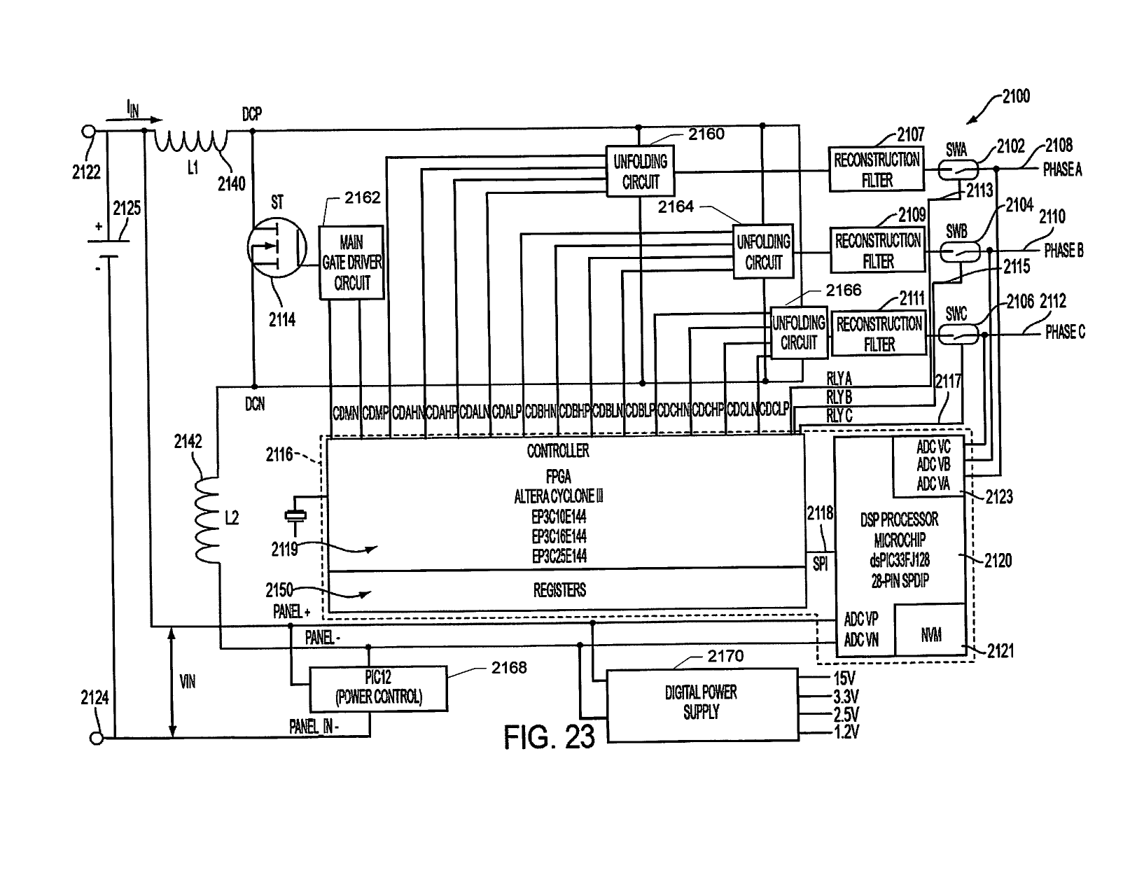

Referring to FIG. 23, a PAMCC 2100 may comprise a controller 2116. Controller 2116 may comprise registers 2150 for saving certain values, a processor 2120, an analog-to-digital converter (“ADC”) 2123, a field programmable gate array (“FPGA”) block 2119, and a communications path 2118 between the FPGA 2119 and the processor 2120. The controller block 2116 is exemplary, in that one skilled in the art will know of various forms of system partitioning that will provide the needed functionality described herein. The registers 2150 may also be used as shared memory for passing values to various control blocks and firmware resident in a processor 2120. The controller may be implemented as an FPGA or alternatively as a programmed processor. Switches SWA 2102, SWB 2104, and SWC 2106 may connect corresponding reconstruction filters 2107, 2109, 2111 to output terminals Phase A 2108, Phase B 2110, and Phase C 2112 wherein the phases correspond to a three phase alternating current. The output terminals may be connected to a three phase load, for example a utility grid. The switches SWA 2102, SWB 2104, and SWC 2106 may be FETs with control gates driven by the controller 2116 with control signals on corresponding lines 2113, 2115, and 2117. A power controller 2168 may be provided. A digital power supply 2170 may also be provided.

The processor 2120 may include an ADC 2123 configured with three inputs or a single input with a MUX (not shown) to sense voltage at the output terminals 2108, 2110, 2112. The ADC 2123 may be configured to provide a digital representation of the sensed voltage to the processor 2120 firmware. In the various embodiments the ADC 2123 may be a discrete ADC which may provide its data output on a bus or via a serial link to the processor 2120. The ADC 2123 may include inputs corresponding to the positive 2122 and negative 2124 terminals of a solar panel, simplified in FIG. 23 as a battery 2125.

A coil L1 2140 and a coil L2 2142 may provide energy storage. Unfolding circuits 2610, 2164, and 2166 may connect the reconstruction filters 2107, 2019, and 2111 to the controller 2116. A connection between coils L1 2140 and L2 2142 may be closed or opened by a switch ST 2114, whose control gate may be controlled by the controller 2116 via the main gate driver circuit 2162. By properly timing the opening and closing of the switch ST 2114 and two of the three output terminal switches, for example SWA 2102 and SWB 2106, a boost converter may be formed, thereby providing current through Phase A and Phase B to Phase C.

FIGS. 35A-35G illustrate an alternative embodiment of a PAMCC that employs two pairs of FETs per unfolding circuit. FIG. 35A illustrates the portion of the PAMCC circuit for providing the first current Phase A. Two pairs of FETs may be included in this embodiment, illustrated as a first pair FETs 3502 and 3504 and a second pair FETs 3506 and 3508. The two of pairs of FETs allow the voltage to be higher or lower on either side of each FET pair. This configuration is usually known as a bidirectional switch implemented with MOSFETs. Two unfolding FET gate diodes 3530 and 3532 (that are detailed in FIG. 35D) are also included in this embodiment and used to control some of the turn on/off gate timing. FIG. 35B illustrates the portion of the PAMCC circuit for providing the second current Phase B. Similarly two pairs of FETs may be included in this portion of the circuit as well, illustrated as a first pair of FETs 3510 and 3512 and a second pair of FETs 3514 and 3516. Two unfolding FET gate diodes 3534 and 3536 are also present. FIG. 35C illustrates the portion of the PAMCC circuit for providing the third current Phase C. This portion of the circuit may also include pairs of FETs, illustrated as first pair of FETs 3510 and 3512 and second pair of FETs 3514 and 3516. Two unfolding FET gate diodes 3538 and 3540 are also included in this embodiment. FIG. 35D illustrates the composition of the FET diodes 3530, 3532, 3534, 3536, 3538, and 3540 used in this embodiment. FIG. 35E illustrates the main MOSFET and associated gate driver circuit and outlines the relationship between FIGS. 35A, 35B, 35C, and 35E in this embodiment. FIG. 35F illustrates a potential construction of unfolding FET gate capacitors that connects in across the gate and source pins of each unfolding MOSFET respectively 3502, 3504, 3506, 3508, 3510, 3512, 3514, 3516, 3518, 3520, 3522 and 3524. FIG. 35G illustrates an embodiment of a temperature sensor for use in the PAMCC. The other circuit elements shown in FIG. 35A-35G otherwise function in a manner consistent with the description of the PAMCC provided above or with their ordinary circuit functions as would be understood by one of skill in the art in view of the entire circuit diagram provided in the figures.

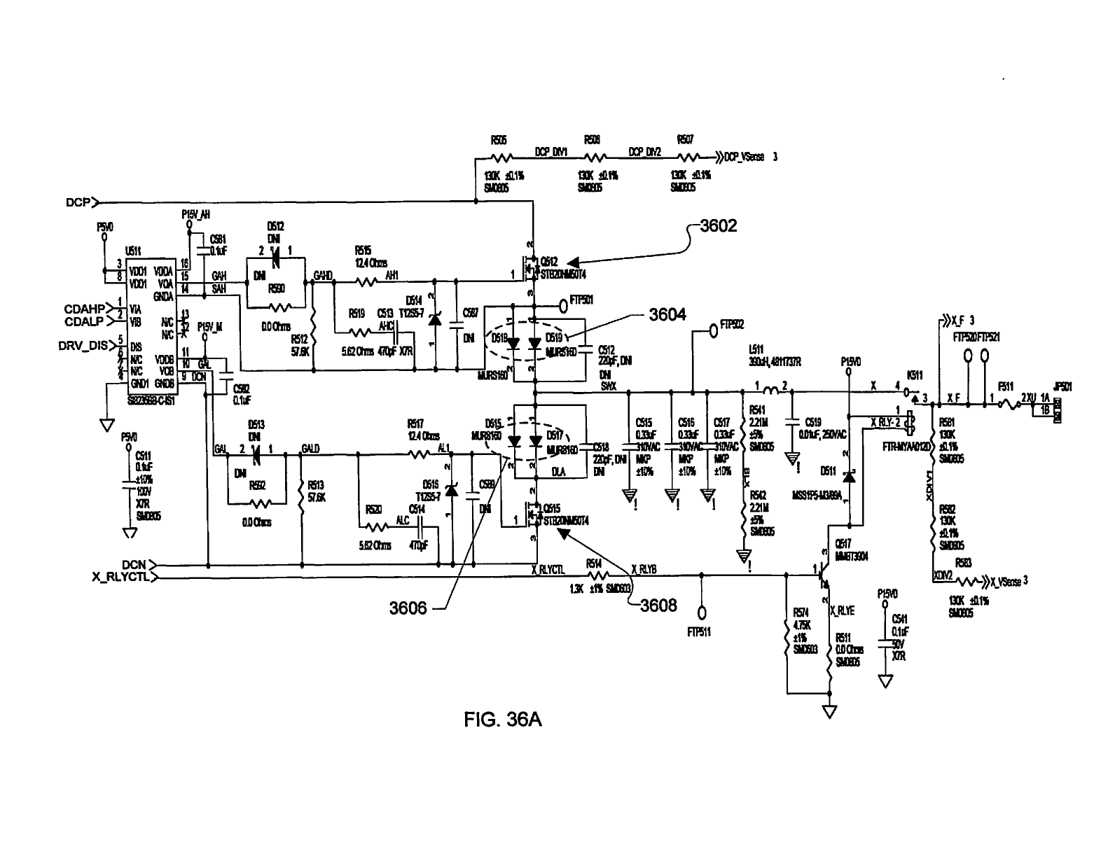

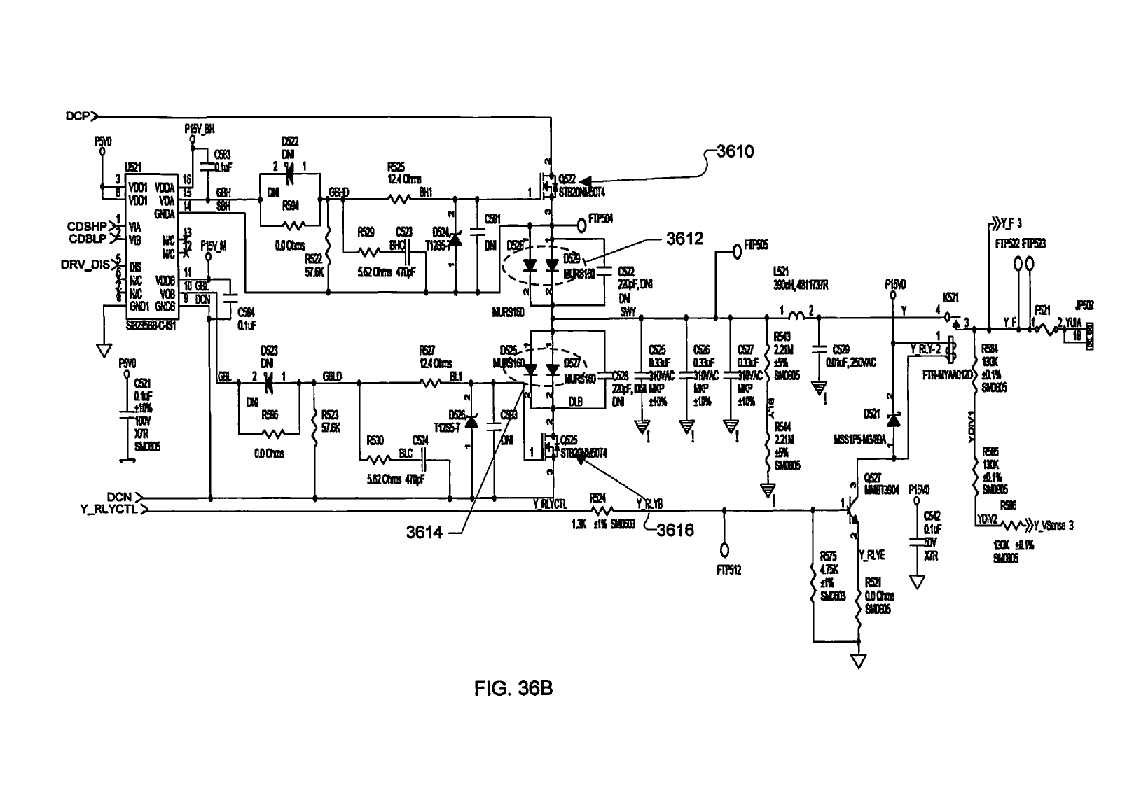

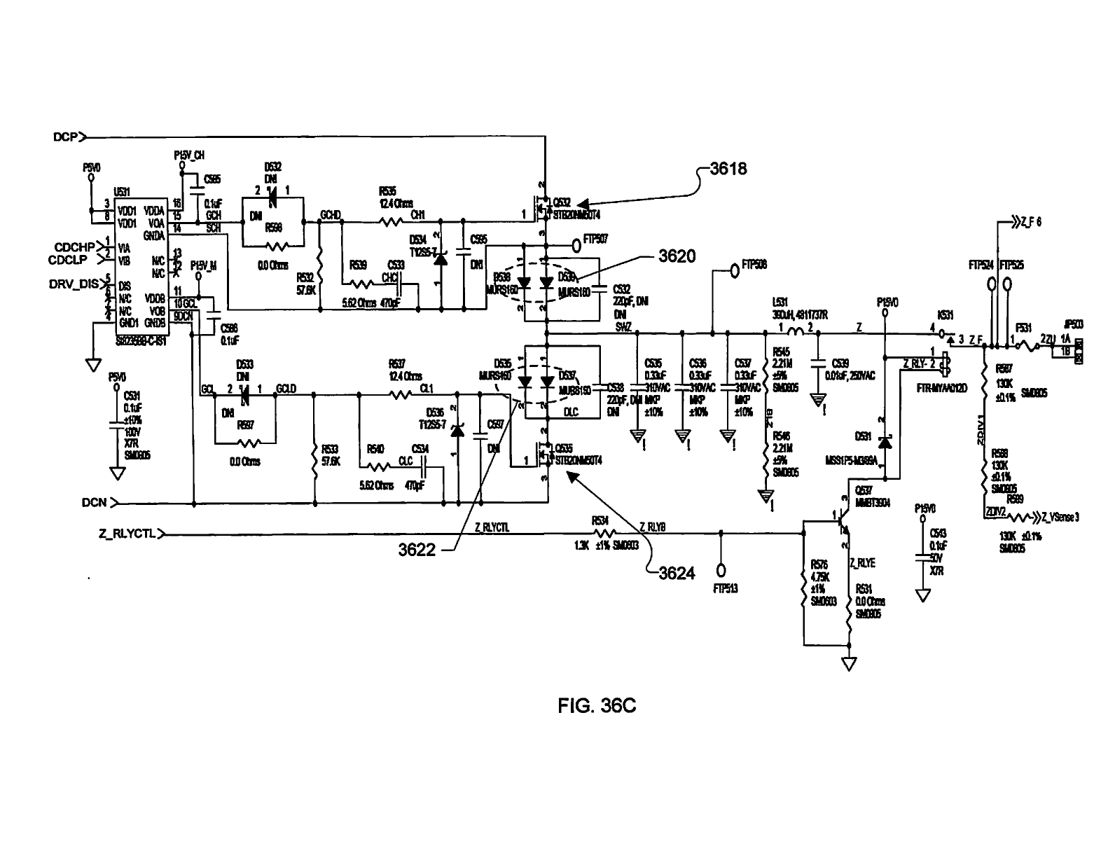

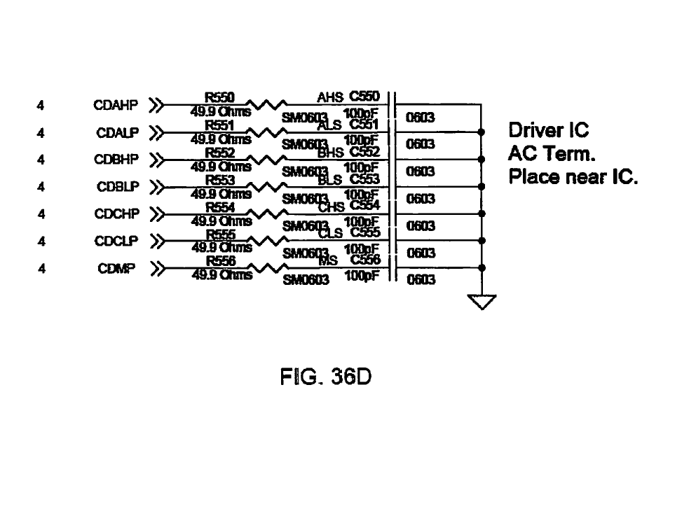

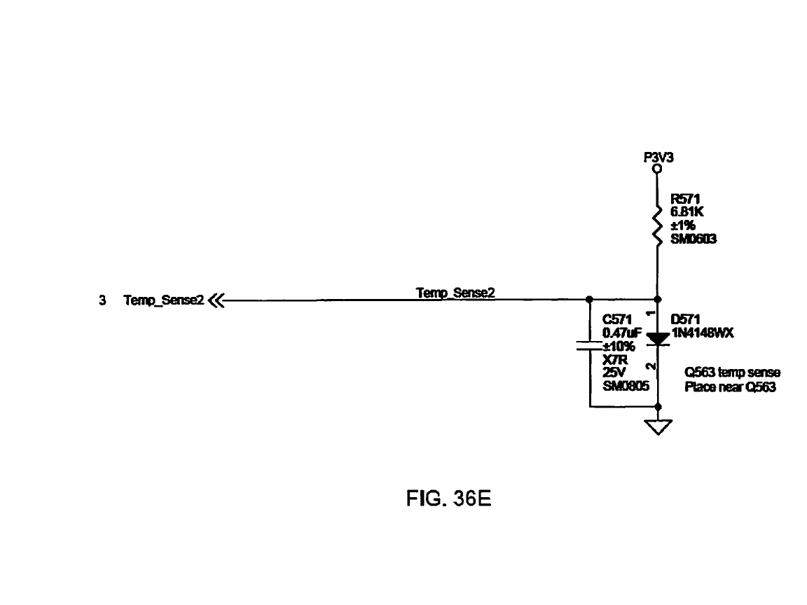

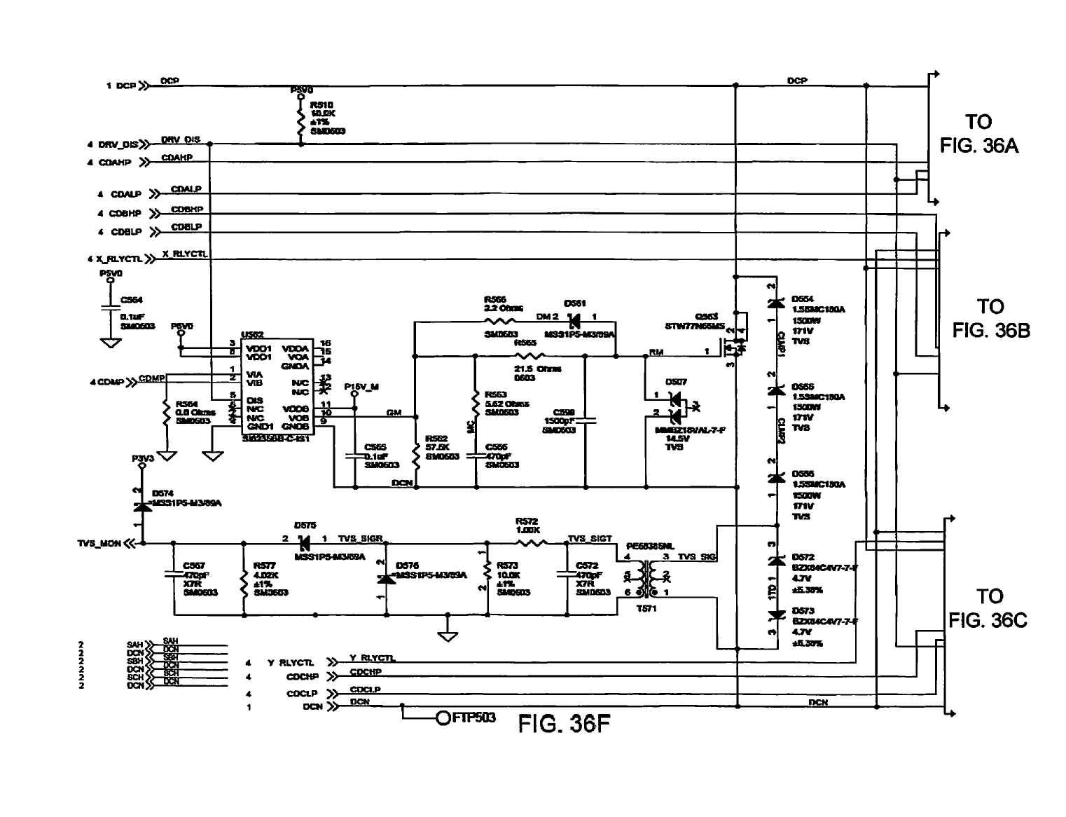

FIGS. 36A-36F illustrate an alternative embodiment of a PAMCC employing diodes in place of some transistors. Two diodes placed in parallel improve the performance, but one diode may be used to provide the desired function. FIG. 36A illustrates the portion of the PAMCC circuit for providing the first current Phase A. Two pairs of diodes 3604 and 3606 are included along with two FETs 3602 and 3606. FIG. 36B illustrates the portion of the PAMCC circuit for providing the second current Phase B. Two pairs of diodes 3612 and 3614 are included along with two FETs 3610 and 3616. FIG. 36C illustrates the portion of the PAMCC circuit for providing the third current Phase C. Two pairs of diodes 3620 and 3622 are included along with two FETs 3618 and 3624. FIG. 36D illustrates the Driver IC. FIG. 36E illustrates an embodiment of a temperature sensor for use in the PAMCC. It should be noted that the details illustrated in FIGS. 36D and 36E are provided only to illustrate a best mode implementation, are not essential to the various embodiments, and embodiments would function well without these circuit elements. FIG. 36F illustrates the main MOSFET and associated gate driver circuit and outlines the relationship between FIGS. 36A, 36B, 36C, and 36E in the overall PAMCC circuit according to this embodiment. The other circuit elements shown in FIG. 36A-36F otherwise function in a manner consistent with the description of the PAMCC provided above or with their ordinary circuit functions as would be understood by one of skill in the art in view of the entire circuit diagram provided in the figures.

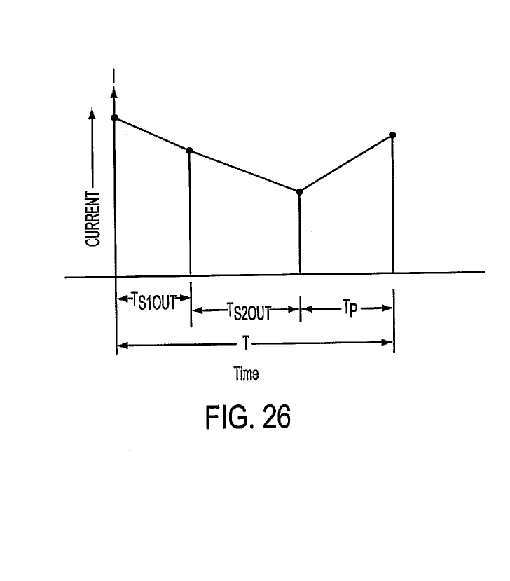

FIG. 26 illustrates an example of current from Phase A 2108 and Phase B 2110 being provided to Phase C 2112. At the beginning of the time T, the switch ST 2114 may be opened. Switch SWA 2102 may be closed for a time T_{S1}. At the expiration of time T_{S1}, switch SWA 2102 may be opened and SWB 2104 may be closed for a time T_{S2}. At the expiration of time T_{S2}, the switch SWB 2104 may be opened and the switch ST 114 may be closed for a time T_{P}, wherein T_{S1}+T_{S2}+T_{P}=T. This describes a boost power converter in continuous current mode (“CCM”). In some embodiments the switch ST 2114 may not be closed when switch SWB 2104 opens. For a three phase power conversion system, during a given sixty degree segment of a grid period, two certain outputs may be selected to be driven in order to generate the third phase. ST 2114 may be opened, then one of SWA, SWB, or SWC may be closed for time T_{S1OUT}, then another of SWA, SWB, or SWC may be closed for time T_{S2OUT}, then ST 2114 may be closed for the remainder of the switching cycle for a system in continuous conduction mode.

At the time of manufacture, a PAMCC 2100 register in NVM 2121 may be populated with values for T_{S1} and T_{S2} which have been predetermined for each switching time, for example 30 μSec, of the PAMCC 2100. Other switching times may be used. These values may be determined by simulation or by laboratory experimentation to determine typical values. In the various embodiments a table value may correspond to the number of clock ticks for a given pulse time. When the PAMCC 2100 begins actual operation these values may be used for initial conditions, then adapted to actual conditions. The initial T_{S1} and T_{S2} values may be saved for an entire 360 degree cycle, or values for sixty degrees saved, the index pointer starting over after each sixty degrees. The T_{S1} and T_{S2} initial values may be saved in tables T_{INIT1} and T_{INIT2}. In the various embodiments T_{INIT1} and T_{INIT2} may be sixteen bit registers. Other bit widths may be used. Additionally, the PAMCC 2100 may store multiple temperature curves and thermal coefficients for use with the various embodiments.

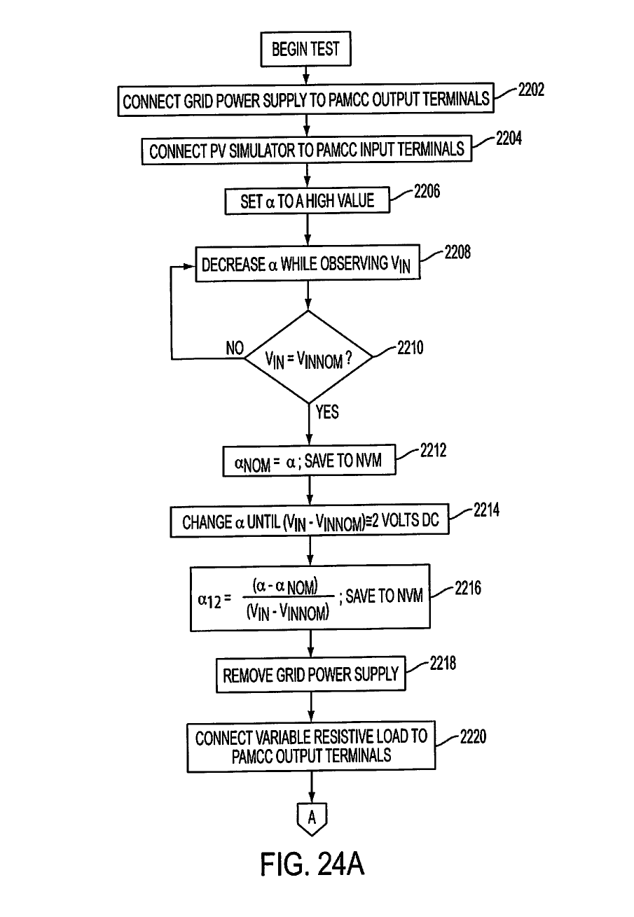

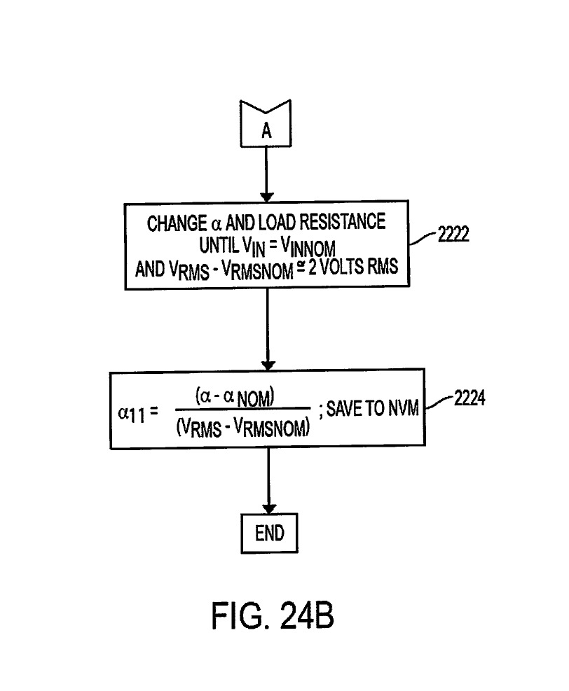

FIGS. 24A and 24B illustrate an embodiment method for testing a PAMCC 2100 at the time of manufacture to determine a nominal value for a scaling factor related to V_{IN} and V_{RMS}, wherein the scaling factor will be used in calculating T_{S1} and T_{S2} times during operation. The scaling factor is described as:

α=α_{NOM}+α₁₁(V_{RMS}−V_{RMSNOM})+α₁₂(V_{IN}−V_{INNOM}).

A nominal value for a is needed. In the various embodiments a nominal value for a may be found while the PAMCC 100 under test is in operating mode. A typical United States three phase grid voltage of 110 volts RMS (defined as V_{RMSNOM}) may be supplied in block 2202 to the output terminals 2108, 2110, 2112. A typical solar panel provided with typical radiance, or a solar panel simulator or other source of direct current, may be connected in block 2204 across the input terminals 2122, 2124 of the PAMCC 2100. The voltage that a panel will produce is a function of how much current is taken from it at a given radiance level, which is simply described by a family of IV curves for the panel. Assuming the initial T_{S1} and T_{S2} values have been previously written into the tables T_{INIT1} and T_{INIT2} in NVM 2121, the test may begin with a very high value of α in block 2206, which the control loop uses to scale the T_{S1} and T_{S2} table values (discussed in detail below) to produce the V_{RMS} output. Because V_{RMSNOM} is being provided by a grid simulator, which may be more powerful than the PAMCC, the three-phase output of the PAMCC 100 is known to be V_{RMSNOM}, while V_{IN} from the PV will be a value depending upon the IV characteristics of the PV or PV simulator (or other source of direct current) and the operation of the PAMCC 2100. The value of α may be slowly decreased while the PV output voltage V_{IN} is observed in block 2208. In determination block 2210 the controller may determine if V_{IN} is equal to V_{INNOM}. If V_{IN} is not equal to V_{INNOM} (i.e., determination block 2210=“No”), at block 2208 monitoring of V_{IN} may continue. If V_{IN} is equal to V_{INNOM} (i.e., determination block 2210=“Yes”), at that point (V_{IN}−V_{INNOM})=(V_{RMS}−V_{RMSNOM})=0, therefore a now equals α_{NOM}. The value of α_{NOM} may be saved at block 2212, for example in NVM 2121. V_{INNOM} may be found by testing a sample of the production PV panels or from specifications for a panel provided by the manufacturer.

While the grid simulator is still attached to the output terminals 2108, 2110, 2112 of the PAMCC 2100, α may be changed such that V_{IN} no longer equals V_{INNOM} at block 2214, so now α₁₂ is known and may be saved to nonvolatile memory (NVM) at block 2216:

$$\frac{( α - {α}_{NOM )}}{( {V}_{IN} - {V}_{INNOM} )} = {α}_{12} .$$

The difference between V_{IN} and V_{INNOM} should be large enough to correspond to several least significant bits (LSBs) of the PAMCC ADC 2123. In the various embodiments approximately two volts may be used.

Next the grid power supply may be removed 2218 and a variable resistive load may be connected at block 2220 to the three-phase output terminals 2108, 2110, 2112 such that VRMS is approximately two volts above V_{RMSNOM} while a is changed to hold V_{IN}=V_{INNOM} at block 2222. In that condition α₁₁ is calculated at block 2224 as:

$$\frac{( α - {α}_{NOM )}}{( {V}_{RMS} - {V}_{RMSNOM} )} = {α}_{11} ,$$

and α₁₁ is saved to NMV 2121.

This procedure may be accomplished during the manufacturing of a PAMCC 2100. Its purpose may be to provide startup values such that when a PAMCC 2100 is operated for the first time it will have reasonable starting values. Once a PAMCC 2100 is operational, the process described in FIGS. 24A and 24B may no longer be needed. Another method for determining the startup condition parameters α_{NOM}, α₁₁ and α₁₂ is to determine these by running the same calibration procedure using a simulation model of the system (using either: equations, behavioral models, circuit simulations) instead of the real circuit.

PVs may be tested by the manufacturer after assembly. Included in the data collected may be data associating a voltage and a corresponding current at certain temperatures and radiances. For example, a manufacturer may heat a given panel to the maximum temperature expected in operation, then remove the heat and expose the panel to a nominal amount of light, for example 0.5 sun and record the voltage and corresponding current produced as a function of temperature while the panel cools. This data is denominated the panel's “IV curve.” The IV curve may then be used, sometimes with other factors, during operation by the PAMCC 2100 as a model for dynamically calculating the maximum power point condition.

Control Loop

As described below, in any sixty degree phase segment there may be two output terminals connected one at a time in a predetermined order to the third output terminal during a switching time T. It is not important which two phases are selected and in which order their switches are closed. The switch amongst SWA 2102, SWB 2104, and SWC 2106 that is connected first may be connected for a first time duration T_{S1}. The switch that is connected second may be connected for a second time duration T_{S2}. The switch ST 2114 may be opened at the beginning of the switching time, then closed for the time duration T_{P}. The timing of these switches may be determined by the control loop.

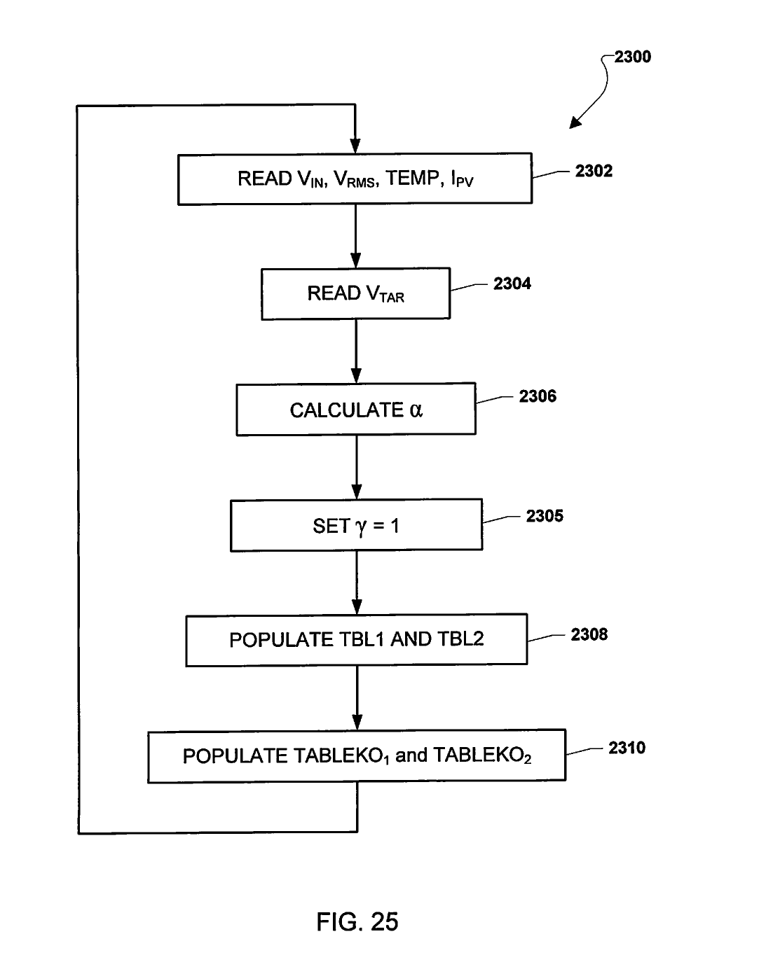

In the various embodiments, adjustments to the control loop may be segmented into those processes that can be executed quickly (fast enough to be accomplished within a single switching cycle time) and other processes that require more time to complete. FIG. 25 illustrates an embodiment method 2300 which may be used for running a control loop repetitively. First V_{IN}, V_{RMS}, the panel temperature (TEMP), and I_{PV} may be read from sensors configured to obtain these measurements at block 2302. The values may be obtained from the ADC 2123 as digital representations of the voltages sensed by the ADC 2123. V_{TAR} may be read at block 2304 from a predetermined memory register location. The value of V_{TAR} may be determined by another process which periodically updates the value of V_{TAR} in accordance with a strategy for maximizing the power provided by the PV, such as described in more detail below. The stored value of V_{TAR} may have been modified, resulting in an operating condition which does not correspond to the MPP condition in order to avoid an unsafe condition or for other considerations. The value in the V_{TAR} register may be updated more or less often than the method 2300 process loop time. V_{TAR} as-read is now the desired instant value for V_{IN} from the PV.

When a PAMCC 2100 is operated for the first time, the initial value of a, found previously, may be used. In succeeding loops a may be updated at block 2306, depending upon the instant value of another scale factor γ. If γ is not numerically equal to one, at block 2306 a new value for α may be found by

α_{NEW}=α_{OLD}*γ

The value of γ may be reset to be equal to a numerical value of one at block 2305.

Alternatively, some embodiments determine a new value for α at block 2306 by

α_{NEW}=p*α_{OLD}*γ+(1−p)*α_{OLD},

where p<1, for example p=0.5, then reset γ at block 2305 by

γ=α_{NEW}/α_{OLD}

In block 2308, the two tables TBL1 and TBL2 may be populated by scaling the corresponding values of TINIT1 and TINIT2 per the formulas

T_{S1TBL1}=T_{INIT1}*α and

T_{S2TBL1}=T_{INIT2}*α.

In a similar fashion, tables TBLKO₁ and TBLKO₂ may be populated at block 2310. Values may be found for each switching time and the tables saved in registers. In the various embodiments the tables TBL1 and TBL2 may be ten bit registers. Using values expressed in fewer bits (e.g., 10 bits) shortens the time required for math operations.

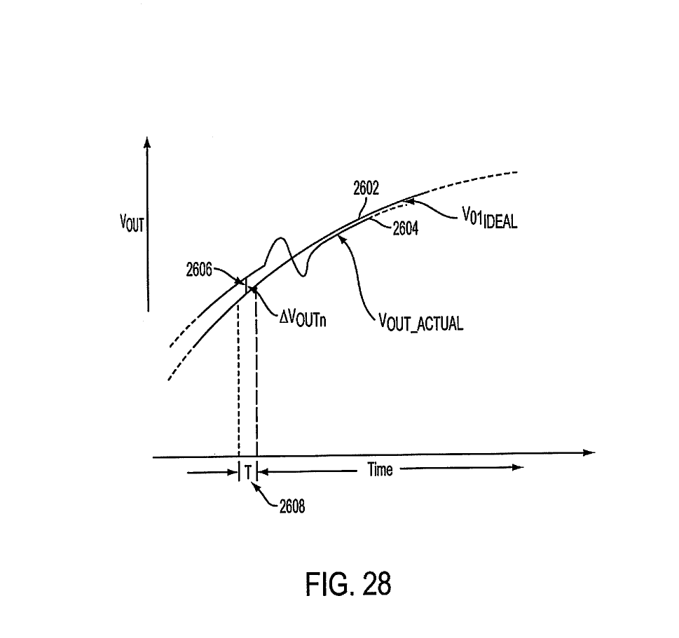

During operation, the PAMCC 2100 may determine the voltage V_{RMS} across a rolling window of several grid cycles, for example ten cycles. V_{RMS} may then be evaluated as an ideal voltage V_{IDEAL} at any instant in time by using a sine function. In this operation the ADC 2123 may read the instant output voltage of each of the two driven phases and compare the value read to the ideal voltage for that time period. Note that the phases may be offset from each other. Any difference may be denominated dVOUT1 and dVOUT2. Referring to FIG. 28, the ideal output voltage 2602 of a given phase is known by a sine function of a VRMS average across a number of grid cycles, for example a rolling window of ten cycles. During each switching cycle 2608 the ADC 2123 may measure the instant voltage 2604 at the phase output terminal. The difference between the actual voltage 2604 and an ideal voltage 2602 may be denominated dVOUTn (n=1,2) 2606. To respond to any error at a phase output terminal a feed-forward correction may be calculated and then applied to the final switching times by

T_{S1OUT}=T_{S1TBL1}*γ−KO₁*(dVOUT1) and

T_{S2OUT}=T_{S2TBL2}*γ−KO₂*(dVOUT2),

where KOₙ (n=1,2) is the ratio (Ts_{INIT}n/V_{IDEAL}). In some embodiments the evaluation of terms may be made faster by populating a table of KOₙ values for a given sixty degree phase window, wherein KOₙ is evaluated for each switching time. The KOₙ tables TBLKO₁ and TBLKO₂ may be repopulated at block 2310 of each cycle of the loop 2300 illustrated in FIG. 25. In another embodiment KOₙ may be zero.

The switching times may be determined during one switching cycle, and applied during a next succeeding switching cycle time, with these two processes running concurrently. Depending upon the conversion speed of the ADC 2123 and the conversion time available, conversion of a dVOUT value may lag by one or more switching cycles.

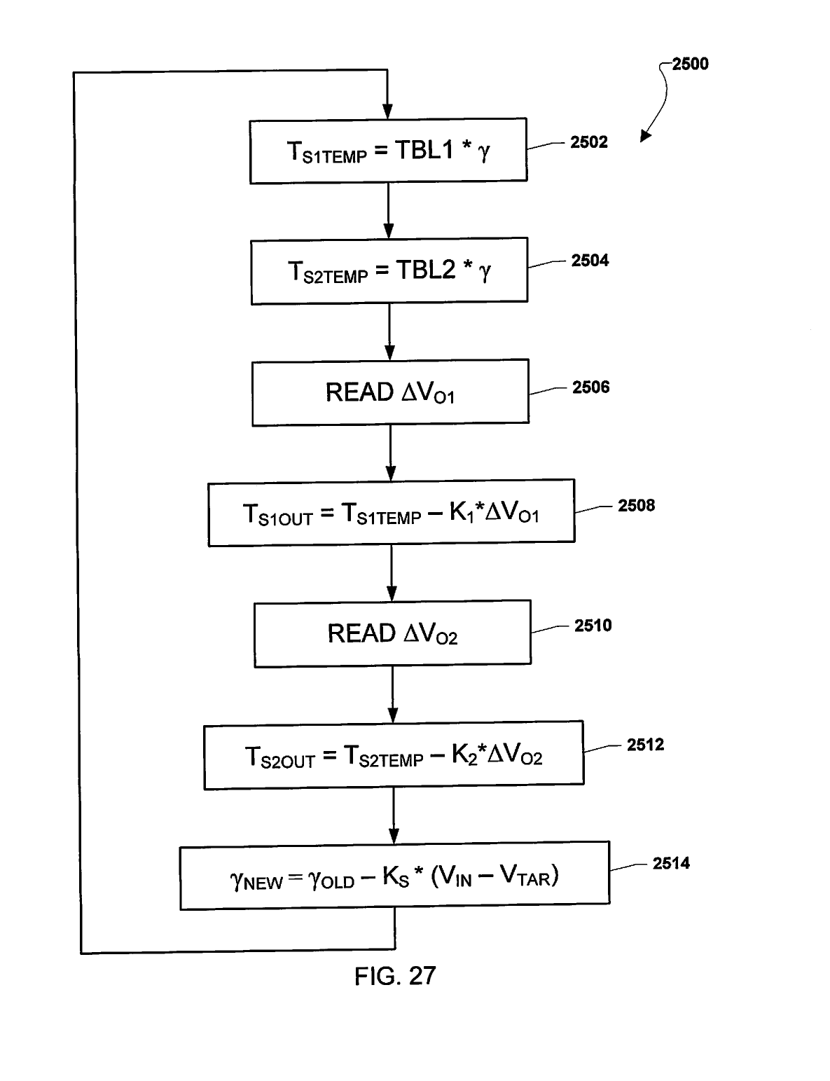

FIG. 27 illustrates an embodiment “inner loop” method 2500 which may be executed within a switching cycle time, providing a fast control loop. A fast control loop may enable control of a PAMCC 2100 system to control PVs that may be exposed to fast transients, for example a shadow moving across a PV from a wind turbine blade or a fast-moving cloud. The method 2500 process operates within a controller continuously within a switching time, making adjustments to the parameter γ at block 2514 as necessary, while the slower outer process method 2300 responds to slower-changing conditions, such as temperature, grid V_{RMS}, etc. As discussed above, method 2300 calculates an updated value for α at block 2306, resets γ at block 2305, and at blocks 2308 and 2310 populates the tables used by process 2500.

Still referring to FIG. 27, temporary values T_{S1Temp} and T_{S2Temp} may be calculated at blocks 2502 and 2504 respectively in the following manner:

T_{S1TEMP}=TBL1*γ and

T_{S2TEMP}=TBL2*γ

dVOUT1(ΔV_{O1}) may be determined in block 2506. T_{S1OUT} may be calculated according to the equation below in step 2508.

T_{S1OUT}=T_{S1TEMP}−K₁*dVOUT1

dVOUT2(ΔV_{O2}) may be determined in step 2510. T_{S2OUT} may be calculated according to the equation below in block 2512.

T_{S2OUT}=T_{S2TEMP}−K₂*dVOUT2

The scaling factor γ may be updated in block 2514 using equation 1 (EQ1)

γ_{NEW}=γ_{OLD}−K_{S}*(V_{IN}−V_{TAR}). [EQ1]

This may provide feedback to steer V_{IN} towards the value desired for maximum power point delivery. The value of K_{S} may be determined such that stability is maintained. For example, in some embodiments a value of Ks may be found by equation 2 (EQ2):

K_{S}=1/(50*V_{TAR}) [EQ2]

γ is intended to be maintained at a value of approximately one. In the slow outer loop method 2300, a may be updated at block 2306 using the instant value of γ, then the stored value of γ is reset to one at block 2305.

The temperature of a PV 401, as measured at the back skin of the panel, plus measured values for voltage and electrical current at the output terminals, together with an electrical and thermal model of the panel, may analytically determine a voltage/current condition corresponding to the maximum power point (“MPP”). Temperature change may be relatively slow, and therefore dealt with by a slow outer control loop (method 2300, FIG. 23). Photo current may have faster variations (typically in the milliseconds or tens of milliseconds range) and may be dealt with by a fast loop (method 2500, FIG. 27) within a MPP controller. The fast loop creates a table of current and corresponding voltage pairs and uses the pairs to regulate the PV panel based on an interpolated IV curve.

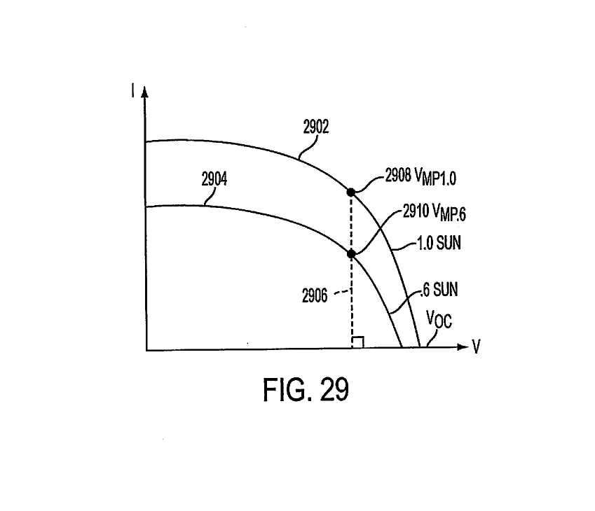

Referring to FIG. 29, a special case may be when the locus of MPP points for various radiance levels approximates a straight line. In this case the controller may maintain the regulation point on a load line and the operating point at the intersection of a load line and a panel IV curve. Generally PV cell manufacturers define a safe limit for reverse voltage across a PV cell in order not to reach reverse breakdown. PV manufacturers may perform a “flash test” after a panel is constructed, in which a standard insolation may be provided to the panel during a test, and voltage versus current data obtained to provide an IV curve 2902 at the known test temperature. A representative curve for a 1.0 sun test (defined as 1,000 watts/meter²) is shown in FIG. 29. For comparison, the curve for the same panel but at lower illumination (for example 0.6 sun) is indicated by line 2904. The MPP conditions are shown on vertical line 2906 by V_{MP1.0} 2908 and V_{MP.6}2910. If the values for MPP voltage for these two cases is very close (as is the case for many silicon based cells) a simple MPP algorithm to maintain the PV 401 voltage constant as the current changes may be used.

In a more general case, the MPP voltage for a range of irradiance values will follow a curve as a function of the MPP current. In the various embodiments the MPP controller, as described above, may operate using a table approximating the IV curve to be followed. If the temperature of a PV 401 (sensed via the back skin temperature sensor) changes, the new MPP curve and its approximation as a table may be calculated by the external loop using method 2300.

Sometimes a PV 401 may not be uniformly illuminated. For example, falling leaves, overhead wind turbine blades, bird droppings, soil, or passing clouds may cause some or as few as one cell in an array of cells of a full PV panel 401 to be shaded. The risk of a shaded cell entering reverse breakdown and dissipating a large amount of power is highest when there is strong illumination over the panel generally but a single cell is shaded. There are two cases of shading to be considered: shading in a cell that is increasing; and shading in a cell that is decreasing.

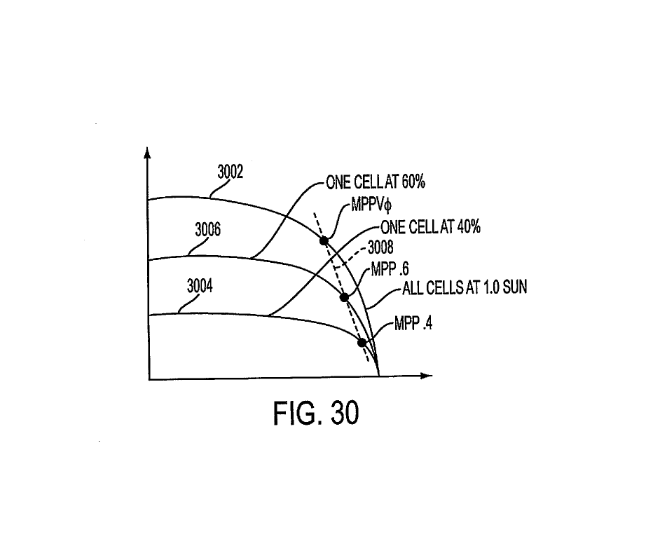

If a cell is shaded relative to the cells in the rest of an array, the IV curve of the panel changes shape because all other cells have the same characteristic, but the shaded cell (in series with the other cells of a common string) has a limited photocurrent. The characteristic curve may be very similar to that illustrated in FIG. 30 for uniform illumination 3002 at higher voltages. At some point the voltage may drop very fast with increasing current, for example FIG. 30 shows a curve 3006 for sixty percent irradiance and a curve 3004 for forty percent irradiance compared to the curve 3002 for fully illuminated cells. Such a partially insolated panel IV curve exhibits shifted MPP points as illustrated. As the percentage of power generated by the shaded cell decreases, the MPP point may follow a line 3008. As this line 3008 reveals, partial shading of one or a few cells has a significant impact on the MPP of the panel.

The voltage drop may be mainly on the shaded diode. So the voltage across the shaded diode may be the voltage difference between the nominal curve and the one with partial shading. For a given PV 401 operating condition, a higher voltage may always be safer than a lower voltage, in that a higher voltage may result in a lower current. So in the various embodiments the voltages corresponding to the MPP, Hot Spot Suppression (“HSS”), and safe operation may be compared and the higher of the three selected. Safe operation is a design consideration, wherein a PV 401 manufacturer may specify the maximum power that a PV cell may deliver without damage. A PV 401 manufacturer may desire to limit the voltage across a reversed cell and may therefore specify a limit voltage as a voltage corresponding to safe operation. Alternatively, a PV 401 manufacturer may limit the reverse power (P_{Lim}). From the P_{Lim} the manufacture may determine a voltage corresponding to safe operation that may be the limited reverse voltage (Vᵣₑᵥ_{_{—}}ₗᵢₘ) by dividing the P_{Lim} by the panel current (I_{Panel}) resulting in the following equation:

Vᵣₑᵥ_{_{—}}ₗᵢₘ=P_{Lim}/I_{Panel}

The fast loop 2500 may follow the MPP and safety limit and effectively protect the shaded diodes from excessive reverse voltage. The slow loop 2300 may determine whether the inner loop 2500 is in a regular MPP condition or a hot spot protection condition. In the later case the slow loop 2300 may determine whether the limit was triggered by partial or uniform shading by observing the MPP position with respect to the regulation point.

Piece Wise Linear Method

In the various embodiments, control of a PV 401 may be effected by a piecewise linear (“PWL”) method. A PWL method may drive the operating point of a panel to be part of a piecewise linear curve with respect to a calculated I-V curve. In such a method the target voltage V_{TAR} may be determined by equation 3 (EQ3):

V_{TAR}=V_{ZERO}−(I−Ioffset)×K_{R}, [EQ3]

where Vzero and K_{R} are constant, Ioffset (in counts) may be based on the ADC result for zero coil current, and I may be the instant ADC value for the current measurement path. The loop may run once every switching cycle, while the current may be updated as fast as possible.

A piecewise linear method may be implemented in an MPP controller by a table of values for Vzero, K_{R} and Ioffset appropriate for various regions corresponding to different desired control behaviors. The values on one line of the table may be applied if I (the instant coil current) is larger than Ioffset on a certain line and smaller than the Ioffset on the line above (the top line corresponds to a single ended comparison).

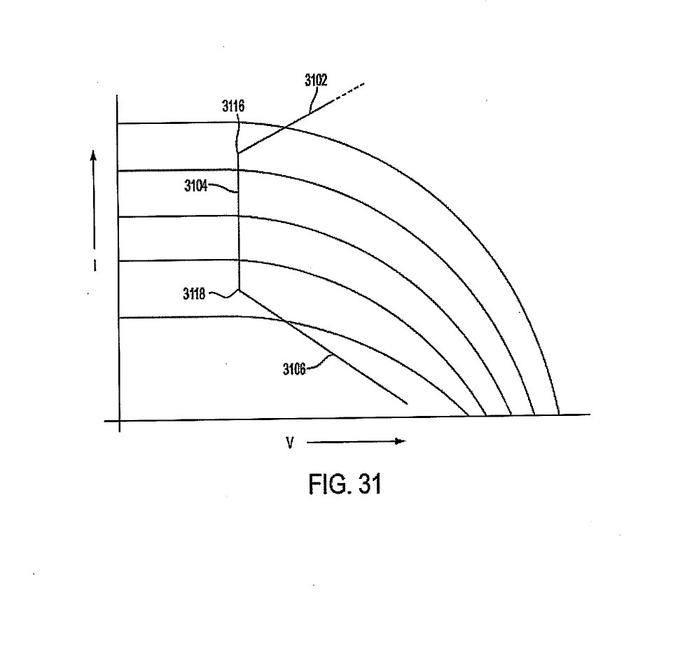

Referring to FIG. 31, three operating zones may be defined: a current limiting zone 3102; a regulation zone 3104; and a protection zone 3106. Three zones are described for clarity, but more or fewer zones may be used to define a piece-wise linear panel load line. A transition point 3116 defines a change from the current limiting zone 3102 and the regulation zone 3104. Another transition point 3118 defines a change from the regulation zone 3104 and the protection zone 3106.

A table may be constructed corresponding to FIG. 31 to include values for V_{ZERO}, Ioffset, and K_{R} for use in equation EQ3. The controller may determine the value of current (I) in each switching cycle, and then based upon where the current value I falls relative to the defined zones, take an action per Table 2.

TABLE 2

| Current (I) | I_{OFFSET} | Vzero | KR | Comment |
|---|---|---|---|---|
| >=4500 mA | 4500 mA | 62 VDC | −10 ohm | Current limit |
| <4500 mA; >=3500 mA | 3500 mA | 62 VDC | 0 ohm | MPP |
| | | | | regulation |
| <3500 mA | −600 mA | 74 VDC | 2.77 ohm | Protection |

Consider an example wherein the instant current value I is 4000 mA. This value falls within the range corresponding to the middle row of Table 1, which corresponds to the regulation zone 3104. V_{TAR} can be calculated using the EQ3 formula above, with the values for Ioffset, V_{ZERO}, and K_{R} found in Table 2. Examination of Table 2 and EQ3 reveals that within the regulation zone 3104 the load line is a vertical line; that is, a constant voltage V_{ZERO}. Above the transition point 3116, corresponding to the top line of Table 1, K_{R} is a negative number, thus V_{TAR} increases. Current I may increase, but at a much slower rate than in the regulation zone.

Likewise for instant current I below transition point 3118, K_{R} is a positive number and Ioffset is a negative number. K_{R} being a positive number and Ioffset being a negative number causes the system to drive down the value of current I by increasing the voltage output of PV 401. V_{TAR} may subsequently be used in EQ1 and EQ2 in the inner loop method 2500 and in turn in the outer loop method 2300.

It should be noted that the regions depicted in FIG. 31 and the corresponding Table 2 correspond to a given temperature. That is, there may be a family of tables like Table 2, with each table in the family corresponding to a certain temperature or temperature range. The various IV curves corresponding to the zones may be each associated with a certain level or range of insolation. This process may be performed periodically by measuring the coil current value and determining the new voltage target per:

V_{TAR}_{_{—}}ₙ=V_{TAR}_{_{—}}ₙ₋₁+K_{S}×(Vzero−(I−Ioffset)×K_{R}−V_{TAR}_{_{—}}ₙ₋₁),

where V_{TAR}_{_{—}}ₙ is the new target voltage and V_{TAR}_{_{—}}ₙ₋₁ is the previous value for target voltage.

In some embodiments dynamic resistance may be used to determine if a panel has experienced a change in overall insolation, or if one or more cells have become partially shaded. This is important if, for example, the operating point has been moved by the PWL protection limit to a new operating condition. The PWL protection limit may be provided by a fast loop for preventing damage due to a hot spot, as previously discussed. In various embodiments a recovery process may determine a new operating condition.

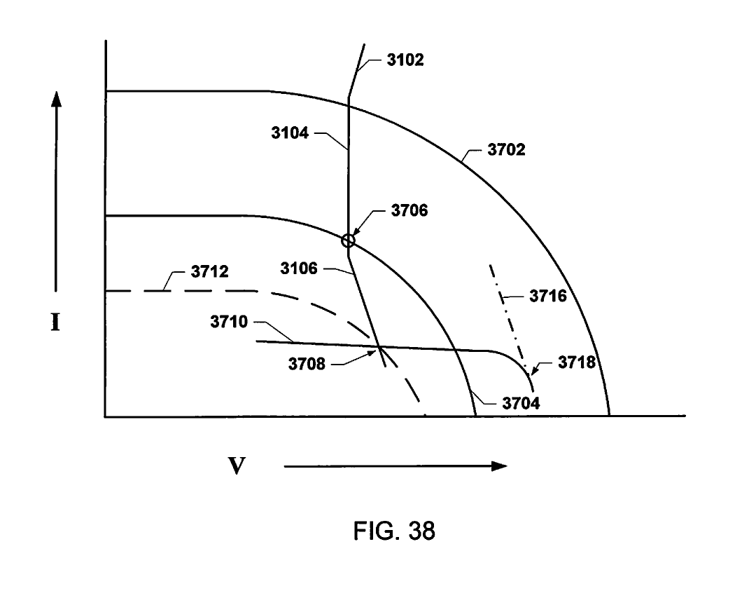

FIG. 38 illustrates an example of a system response to the PWL limits. An I-V curve 3702 may be determined by the panel's manufacturer and saved in the panel controller at the time of assembly. As an example, the I-V curve 3702 may be determined by the panel's manufacturer from an outgoing flash test at standard test conditions (STC), including a standard insolation level. Additionally, multiple temperature curves and thermal coefficients may also be saved in the panel controller at the time of assembly. In operation, a panel may be operating under a different uniform insolation and temperature, for which the controller may generate a new I-V curve 3704 that is associated with the new operating conditions. Examples of the PWL method zones 3106, 3104, and 3102 corresponding to FIG. 31 and previously discussed above are also illustrated.

Upon a first measurement, a panel may be determined to be operating at its maximum power point 3706 on the I-V curve 3704. At a subsequent measurement the operating point may be determined to be at the condition denominated as 3708 by the fast loop of the PWL method. The condition 3708 corresponds to the point at which a current curve 3710 intersects the PWL protection curve 3106. However, the control loop 2300 (FIG. 25) may not know the situation that is causing this operating condition 3708. In other words, while the condition 3708 may be determined by MPP controller in the control loop, the control loop (such as the control loop 2300 illustrated in FIG. 23) operations may not be able to determine the root cause of the condition 3708. One possibility may be that the insolation level has gone down (e.g., with a setting sun) and the panel is now receiving uniform insolation, corresponding to an I-V curve 3712. If that is the case, then the MPP controller in the inner loop needs to establish a new PWL protection envelope and Vmp. Another possibility may be that one or more cells may have become shaded or partially shaded, in which case a new I-V curve 3170 may better represent the current conditions of the panel. The cause of the condition 3708 may be important because in various embodiments a new PWL protection envelope and Vmp may not be established unless the panel is determined to be in a uniform shading condition.

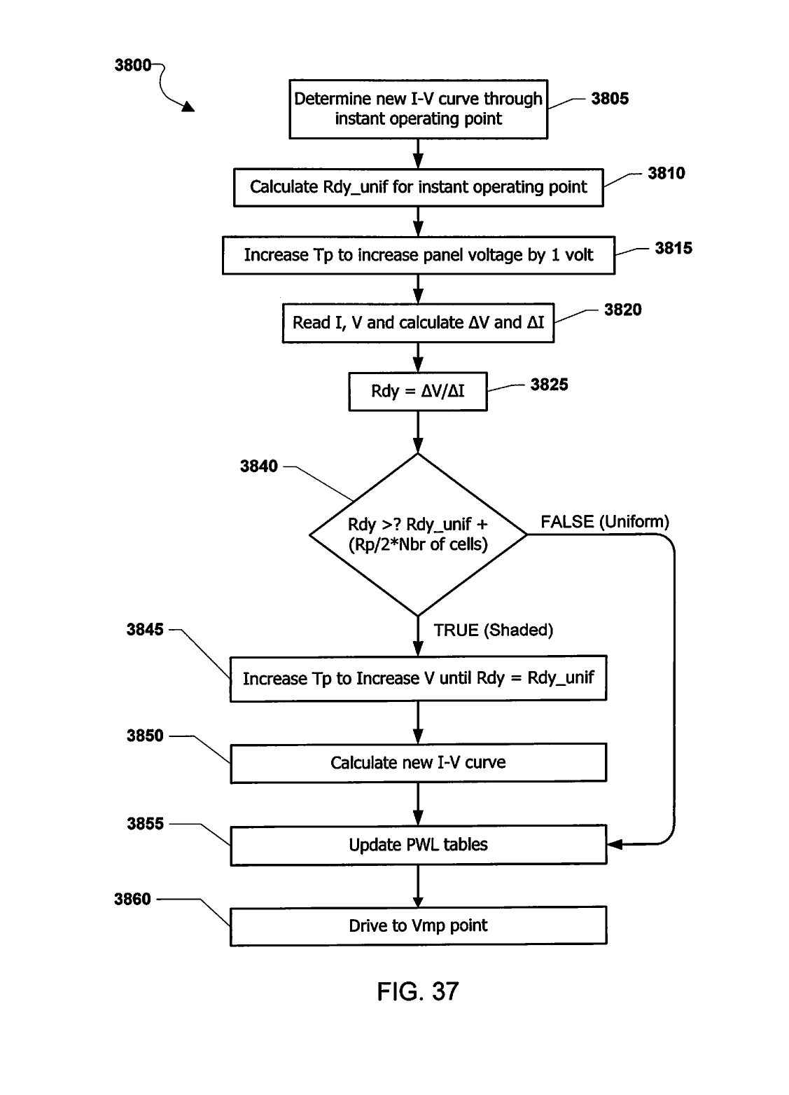

FIG. 37 illustrates an embodiment method 3800 which may be used to update PWL tables in response to panel conditions which change the panel I-V curve. At block 3805, a new I-V curve (for example, I-V curve 3710 illustrated in FIG. 38) may be determined based on the original I-V curve (for example, I-V curve 3702 illustrated in FIG. 38). The new I-V curve may be adjusted for the instant temperature. A graph of the new I-V curve may pass through the current operating point, which may be the only known point on the new I-V curve. An example of this pass through is illustrated in FIG. 38 at point 3708. At block 3810 the uniform dynamic resistance, denominated as Rdy_unif, may be calculated. One example method for calculating the uniform dynamic resistance is to find the slope of the new I-V curve at the current operating point.

At block 3815 Tp may be increased by an amount expected to increase the panel voltage V by approximately one volt. Increasing Tp may be beneficial because increasing the voltage of a panel may be safer than decreasing the voltage of a panel. At the new operating condition resulting from the increase in Tp, at block 3820 V and I for the panel may be read, and ΔI and ΔV may be calculated by taking the instant values of V and I read at this new operating point and subtracting the previous values for 1 and V determined before increasing Tp. At block 3825 dynamic impedance may then be found according to:

$$Rdy = dynamic impedance = \frac{Δ V}{Δ I} .$$

The manufacturer of the solar panel typically provides a value for the shunt resistance, Rp, of the panel, determined by testing at the time of manufacture. Using the shunt resistance Rp and the dynamic impedance Rdy found at block 3825, and the uniform dynamic resistance Rfy_unif calculated in block 3810, at determination block 3840 the dynamic impedance Rdy is compared to the result of the sum of the uniform dynamic resistance and one half the shunt resistance (Rdy_unif+Rp/2*Nbr of cells). The scale factor of (½) is an arbitrary selection; greater or lesser values may be used. What matters is that the discrimination level is spaced from the two impedances that need to be discerned (Rdy_unif and Rdy_unif+Rp/Nbr of cells). If the dynamic impedance Rdy is greater than the result of the sum of the uniform dynamic resistance and one half the shunt resistance (Rdy_unif+Rp/2*Nbr of cells), (determination block 3840=“TRUE”), the change in operating condition (for example, the determined new operating point 3708 illustrated in FIG. 38) was the result of partial shading of the panel and the new operating point (for example, new operating point 3708 illustrated in FIG. 38) does not correspond to the maximum power point (MPPT) condition. To control operation to achieve the MPPT condition, at block 3845 Tp may be increased, thereby increasing V, until the dynamic impedance Rdy and the uniform dynamic resistance Rdy_unif are equal. When the dynamic impedance Rdy and the uniform dynamic resistance Rdy_unif are equal, the panel may be operating along a new I-V curve (for example, I-V curve 3716 partially illustrated in FIG. 38 passing through the operating point 3718), which may be calculated in block 3850.

With a new I-V curve established, the PWL tables may be updated at block 3855, and at block 3850 the operating point is driven to the Vmp point along the newly established I-V curve.

If the dynamic impedance Rdy is less than the result of the sum of the uniform dynamic resistance and one half the shunt resistance (Rdy_unif+Rp/2*Nbr of cells), (determination block 3840=“FALSE”), the I-V curve determined at block 3805 actually is the instant I-V curve, and at block 3855 the PWL tables may be updated. At block 3860 the operating point is driven to the Vmp point along the I-V curve determined at block 3805.

State Diagram Method

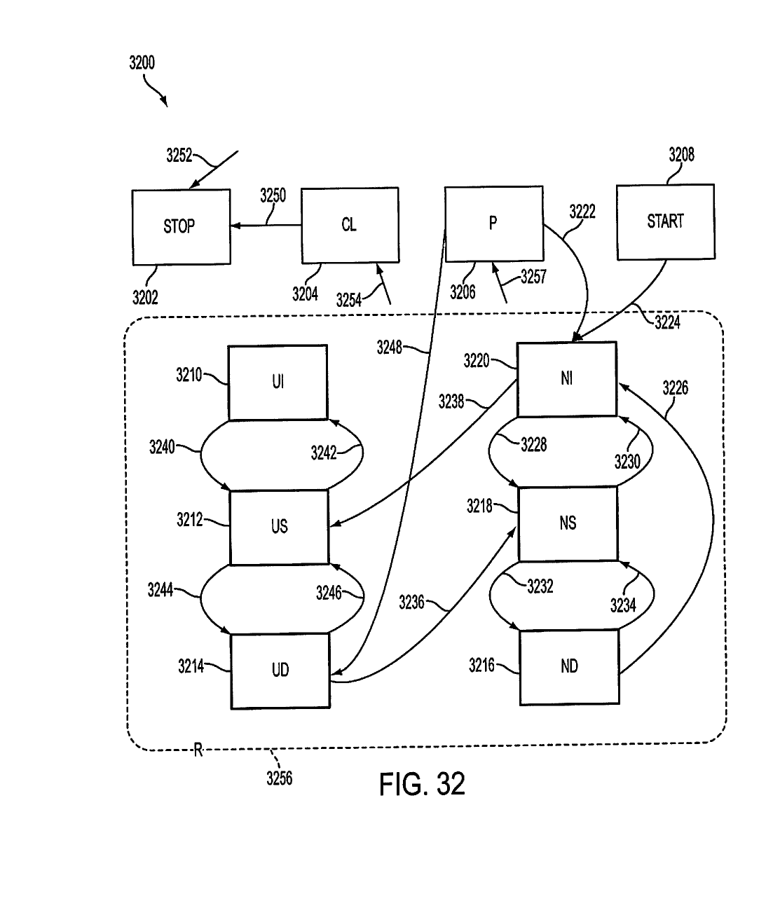

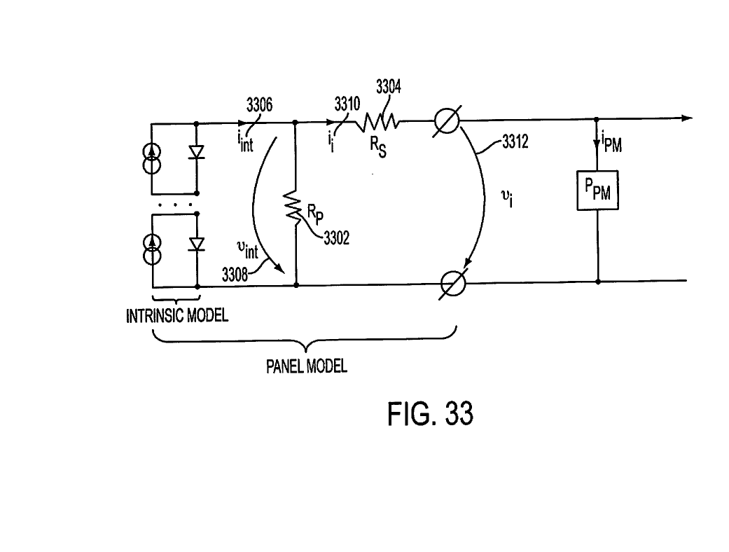

In some embodiments control of a PV 401 may be effected by a parameterized model of the panel data that is instantiated in a programmable processor. An example of such a state diagram is illustrated in FIG. 32 which is described below. Such a state diagram may be based on the primary panel model for the intrinsic panel may be built with a parallel resistance Rp 3302 and a series resistance Rs 3304, which is illustrated in FIG. 33. The value of Rs 3304 may be determined from the high voltage (close to Voc) side of the characteristic curve where the intrinsic diode dynamic resistance becomes very small and may be basically the slope of the panel characteristic in that area. Rp 3302 may be determined as an average (averaging may be needed due to the large errors at high resistance) slope in the low voltage side (near current limit). Rp 3302 and Rs 3304 are part of the parameterized model.

Using the intrinsic model illustrated in FIG. 33, any characteristic of the panel at any photo current may be determined. As an example, for the uniform illumination case, based upon the intrinsic model the lint and Vint may be calculated, and then the current corresponding to Rp 3302 and the voltage corresponding to Rs 3304 may be added, resulting in the Ii and Vi for the whole panel. Vmp may also be calculated as the maximum of a quadratic interpolation in the least mean squared sense for the curve in the neighborhood (e.g. +/−4V) of the known Vmp at another photocurrent. For example, the nominal Vmp may be known initially from flash test data. At low photocurrents the effect of the tare power consumed by the PAMCC 400 may be accounted for. As an example, assuming the PAMCC 400 tare losses at 3W, the extra current at the input due to the PAMCC 400 may be 3W/Vi˜50 mA. Also, during Voc measurements, the tare losses may alter noticeably the result at low irradiance.

The locus of Vmp may be calculated as a function of photocurrent current at nominal temperature by using the panel model. The junction temperature may be calculated based upon the back skin temperature. The Vmp locus may be recalculated using a new Tj value. In some embodiments, the temperature model may not be updated unless there is a change of Tj larger than 5° C. (˜1.2V).

The temperature needed to evaluate the panel electrical model may be the junction temperature Tj. Tj may be measured directly if the panel includes a temperature sensor that is integrated with the cells, or a spare cell may be used to measure the temperature at the level of the cells. Tj may be determined indirectly by measuring the temperature on the back skin of the panel.

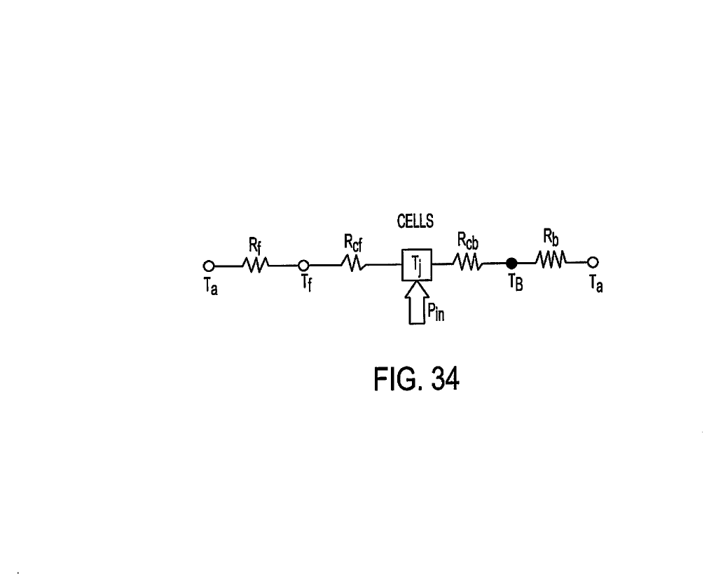

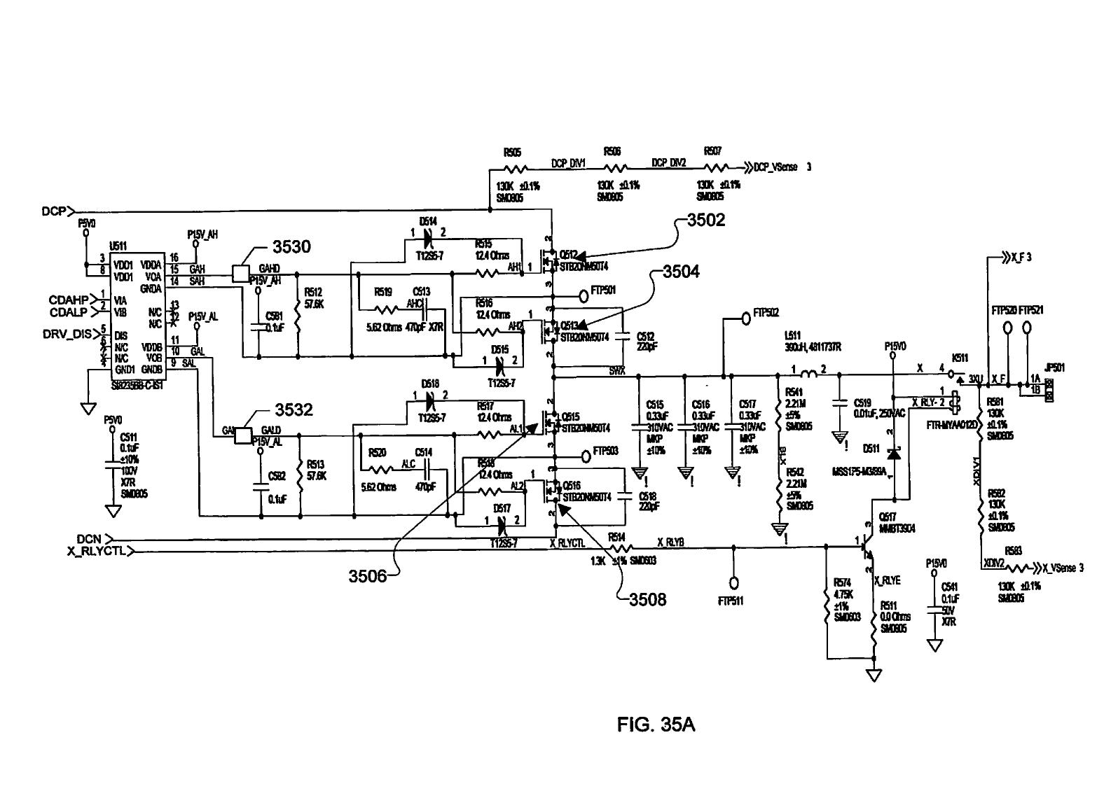

Referring to the thermal model shown in FIG. 34, Ta is the ambient temperature, Rf is the front face to ambient thermal resistance, Rcf is the thermal resistance of the front glass and front air gap, usually much larger than the back skin resistance, Pin is the power dissipated or absorbed in the cells, Rcb is the back skin thermal resistance, Tb is the back skin temperature and Rb is the back skin to ambient thermal resistance. This thermal relationship may result in the following equations:

(Tj−Ta)/(Rf+Rcf)+(Tj−Ta)/(Rcb+Rb)=Pin

Assuming Rcf>Rb, then Pin≈((Tj−Ta)/(Rcb+Rb)=(Tj−Tb)/Rcb) in the static case.

Tj=Tb+Pin*Rcb

Pin=−Ii×Vi+Pth

where Pth is the thermal input power resulting from photon absorption. Pth may be extracted from measured electrical data and meteorological data for a site, the (−Ii×Vi) term is the power that is generated electrically and is transferred to the power modulator. For a clean panel, a value of Pth proportional to Iph current may be used due to the almost linear dependency of Iph to the illumination.

Tj=Tb+Pin*Rcb=Tb+(ξIph−IiVi)Rcb

where ξ is the model parameters that describes the Pin proportionality to Iph.

FIG. 32 is a state diagram of an embodiment system 3200 for state control of a photovoltaic panel 401. The system 3200 is illustrated as a superposition of the states of regulation, protection, and maximum power point. As discussed previously, as the inner loop runs it may transition between the regulation (R) 3256, protection (P) 3206, and current limit (CL) 3204 states. The regulation (R) 3256, protection (P) 3206, and current limit (CL) 3204 states may correspond to the three operating zones discussed above in relation to FIG. 31; a regulation zone 3104; a protection zone 3106, and a current limiting zone 3102, respectively. The outer loop follows the inner loop states and substitutes (R) 3256 with the MPPT regulation states: US (Uniform shaded Stable power) 3212, UI (Uniform shaded Increasing power) 3210, UD (Uniform shaded Decreasing power) 3214, NS (Non-uniform shading Stable power) 3218, NI (Non-uniform shading Increasing power) 3220, or ND (Non-uniform shading decreasing power) 3216.

Initially, the system 3200 may start at in an initial state 3208 which assumes a non-uniform shading environment and needs to find Vmp. Regulation begins at block 3208 at Voc and transitions via pathway 3224 to state NI 3220.

System 3200 may be in (an assumed) state NI 3220 and may slowly walk Vtar towards Vmp of the uniform shaded case by dropping the voltage by a voltage increment, such as 1 volt direct current (VDC), such as approximately 1 VDC, such as 2VDC to 1.75VDC, 1.75VDC to 1.5VDC, 1.5VDC to 1.25VDC, 1.25VDC to 1VDC, 1VDC to 0.75VDC, 0.75VDC to 0.5VDC, 0.5VDC to 0.25VDC, 0.25VDC to 0.01VDC, such as less than 1VDC, such as more than 1VDC, such as approximately 0.5VDC, or such as approximately 0.1VDC. Additionally, the voltage increment may be a voltage selected to allow minimal power variation near a maximum power point of the photovoltaic panel, PV 401, such as a power variation such as 1 watt (W), such as 2W, such as 10W to 5W, 5W to 4W, 4W to 3W, 3W to 2W, 2W to 1W, 1W to 0.5W, 0.5W to 0.4W, 0.4W to 0.3W, 0.3W to 0.2W, 0.2W-0.1W, 0.1W to 0.5W, 0.5W to 0.4W, 0.4W to 0.3W, 0.3W to 0.2W, 0.2W to 0.1W, or such as 0.01W. System 3200 may slowly walk Vtar towards Vmp of the uniform shaded case by dropping the voltage by a single voltage increment at a time while calculating the input power, keeping track of the maximum value. If Vmp is approached by less than the voltage increment a determination that the system 3200 is actually in the uniform shading case may be made, and the system 3200 performs operational controls 3238 to transition to the US state 3212.

In the NI state 3220, if power decreases by more than 1% of the actual maximum value so far, the maximum may be reached, and PV 401 voltage may be decreased by 0.5V. The PAMCC 400 may set up a regulation table with current limit and voltage regulation at the determined value and a safety limit below flash data, for example 2.0 VDC, scaled for Tj, and the system 3200 may perform operational controls 3228 to transition to the NS state 3218.

In the NS state 3218, if there is a non-uniform shading condition, and power increases, the system 3200 may perform operational controls 3230 to transition to the NI state 3220.

In the NS state 3218, if there is a non-uniform shading condition, and power is decreasing, then the new Vmp may be tracked and the system 3200 may perform operational controls 3232 to transition to the ND state 3216. In the ND state 3216, the regulation voltage may be increased by 1.0 VDC.

In the NS state 3218, if power decreases operational controls 3226 may be performed to transition the system 3200 to the NI state 3220.

In the NS state, if power increases, voltage may be increased by 1.0 VDC at a time while keeping track of the maximum. When power decreases by more than 1% of the maximum value so far, voltage may be decreased by 1.5VDC and the PAMCC 400 may set up a regulation table with current limit and voltage regulation at the determined values and safety limit at 2V below flash data scaled for Tj. Operational controls 3234 may be performed to transition to the NS state 3218.

If the system is in a uniform shading environment, the PAMCC 400 may build the regulation table based on assumed current limit, voltage regulation at Vmp@ max irradiance, safety limit 20. VDC below nominal flash data, adjusted for Tj.

If the operating point results in the protection region, regardless of the instant state, operational controls 3257 may be performed to transition to the P state 3206. The protection region may be triggered (reached) anytime the panel current reduces. The panel current may be reduced due to uniform or non-uniform shading conditions. However, a fast loop method 2500 may not know the reason for the current drop, and to protect against unsafe conditions the P state 3206 may be entered and the uniform or non-uniform shading condition may be determined.

In the P state 3206, while increasing voltage by 1 volt direct current (VDC) steps, if power increases then voltage may be increased by 0.5V and operational controls 3222 performed to transition to the NI state 3220, then operational controls 3228 may be performed to transition to the NS state 3218. Then the PAMCC 400 may build a regulation table with current limit and voltage regulation at the determined values and may set a safety limit at 2V below the flash data, adjusted for Tj. In an alternative embodiment (not shown) transition from the P state 3206 directly to the NS state 3218 may be performed.

In the P state 3206, if power decreases, then operational controls 3248 may be performed to transition to the UD state 3214, where the PAMCC 400 may use the original Vmp and may set up a regulation table with current limit and voltage regulation at the determined values and may set a safety limit at 2 VDC below the flash data, adjusted for Tj.

At the US state 3212, if current increases operational controls 3242 may be performed to transition to the UI state 3210, and the PAMCC 400 may set up a regulation table with current limit and voltage regulation at the determined values and may set a safety limit at 2 VDC below the flash data, adjusted for Tj.

At the US state 3212, if current decreases, operational controls 3244 may be performed to transition to the UD state 3214. The controller may determine if the PV is in a uniform or partial shading condition (i.e., the operating condition should be for uniform or partial insolation) by increasing voltage by a voltage increment, such as approximately 1 VDC. such as 1 volt direct current (VDC), such as approximately 1 VDC, such as 2VDC to 1.75VDC, 1.75VDC to 1.5VDC, 1.5VDC to 1.25VDC, 1.25VDC to 1VDC, 1VDC to 0.75VDC, 0.75VDC to 0.5VDC, 0.5VDC to 0.25VDC, 0.25VDC to 0.01VDC, such as less than 1VDC, such as more than 1VDC, such as approximately 0.5VDC, or such as approximately 0.1VDC. Additionally, the voltage increment may be a voltage selected to allow minimal power variation near a maximum power point of the photovoltaic panel, PV 401, such as a power variation such as 1 watt (W), such as 2W, such as 10W to 5W, 5W to 4W, 4W to 3W, 3W to 2W, 2W to 1W, 1W to 0.5W, 0.5W to 0.4W, 0.4W to 0.3W, 0.3W to 0.2W, 0.2W-0.1W, 0.1W to 0.5W, 0.5W to 0.4W, 0.4W to 0.3W, 0.3W to 0.2W, 0.2W to 0.1W, or such as 0.01W.

At the UD state 3214, if a partial shading case is determined, the processor may perform operational controls 3236 to transition to the NS state 3218. If power increases then voltage may be increased by 0.5 VDC and the PAMCC 400 may set up a regulation table with current limit and voltage regulation at the determined values, and may set a safety limit at 2V below the flash data, adjusted for Tj.

At the UD state 3214, if a uniform shading case is determined, operational controls 3246 may be performed to transition to the US state 3212. The original Vmp may be returned to and the PAMCC 400 controller may set up a regulation table with current limit and voltage regulation at the determined values and may set a safety limit at 2V below the flash data, adjusted for Tj.

In the UD state, periodic testing may be performed to determine that the PV 401 is still in fully shaded (uniform) case, increasing voltage by a voltage increment such as 1 volt direct current (VDC), such as approximately 1 VDC, such as 2VDC to 1.75VDC, 1.75VDC to 1.5VDC, 1.5VDC to 1.25VDC, 1.25VDC to 1VDC, 1VDC to 0.75VDC, 0.75VDC to 0.5VDC, 0.5VDC to 0.25VDC, 0.25VDC to 0.01VDC, such as less than 1VDC, such as more than 1VDC, such as approximately 0.5VDC, or such as approximately 0.1VDC. Additionally, the voltage increment may be a voltage selected to allow minimal power variation near a maximum power point of the photovoltaic panel, PV 401, such as a power variation such as 1 watt (W), such as 2W, such as 10W to 5W, 5W to 4W, 4W to 3W, 3W to 2W, 2W to 1W, 1W to 0.5W, 0.5W to 0.4W, 0.4W to 0.3W, 0.3W to 0.2W, 0.2W-0.1W, 0.1W to 0.5W, 0.5W to 0.4W, 0.4W to 0.3W, 0.3W to 0.2W, 0.2W to 0.1W, or such as 0.01W. As the voltage is increased by the voltage increment, if power increases the voltage may increase by 0.5V and the PAMCC may set up a regulation table with current limit and voltage regulation at the determined values and may set a safety limit at 2V below flash data, adjusted for Tj. The system transitions 3236 to the NS state 3218. If the power does not increase, the controller may return to the original Vmp and set up a regulation table with current limit and voltage regulation at the determined values and may set a safety limit at 2V below flash data, adjusted for Tj. At this point the system transitions 3246 to the US state 3212.

If the current increases beyond the higher limit in the MPPT regulation segment the inner loop transitions in the current limiting segment, the outer loop observes this and transitions (arc 3545) to the CL 3204 state. In this state if current increases further the outer loop will transition to the STOP 3202 state via the 3250 transition arc. Other hardware errors or operating conditions like switching errors, input bound conditions, arithmetic exceptions, license expiration, could set the transition to STOP 3202 over 3252 arc. If current falls back then the outer loop will follow the inner loop to UD state.

While discussed in relation to a PAMCC the MPPT control, piecewise linear method, and state machine processes may be used in conjunction with any controller and are not dependent on the use of a PAMCC in a solar panel system. The various embodiments described herein may provide a combined method for controlling solar panel system operations using a calibrated panel model and panel back skin temperature based MPPT determination, identifying uniform versus non-uniform panel shading conditions, and setting protection limits as a form of hot spot suppression all in a unified control routine.

Power Line Communication

The PAMCC 400 may be configured to communicate information to other PAMCC units as well as to centralized controllers or monitoring servers via power line communications over the same wires that deliver generated electric power. As discussed above, the output signal configurations of the PAMCC 400 may include adaptive signals by modifying the output waveforms on a cycle-by-cycle or other time period basis to include symbols modulated or superimposed on the base (carrier) signal. These additional signals may be modulated onto the base signal using any known modulation scheme, including as examples, amplitude modulation (AM), frequency modulation (FM), phase shift keying (PSK), and quadrature amplitude modulation (QAM). Such additional signal may be included as a modulated ripple on the base signal, or as small a modification of the base signal (e.g., in amplitude, frequency or a combination of both) which can be recognized by a receiver circuit configured to detect such modulation without adversely affecting the three-phase power base signal required by the electrical grid. Information may be encoded in such power line modulations using any known information coding technique, including one bit, two bit and four bit encoding. Further, since the power lines coupled to the electrical grid are likely to be noisy, the information encoding mechanisms may also implement well known methods for detecting and correcting errors (e.g., parity bits, forward error correct (FEC) encoding, etc.), and providing protections against data loss (e.g., interleaving, Viterbi encoding, etc.). Such power line communications may be implemented within the PAMCC modules by including a transceiver circuit which includes a data encoding module and a modulator for modulating encoded data onto the power line signal, and a demodulator configured to recognized adaptive signal present on the power line signal and translate (i.e., demodulate) the received adaptive signals into data that may be processed by a processor of the PAMCC, the controller or another computer (e.g., a system server). Circuits for encoding and receiving data signals transmitted over power lines, such as within the power lines of a typical residence, are well known in the art and may be adapted for use in the PAMCC module. Alternatively, the PAMCC controller may be configured to adjust the amplitude modulations of individual pulses to add a secondary adaptive signal to the output power pulses.

By using power line communications PAMCC modules can communicate PV performance data (e.g., current conditions of their respective PV panels), current power output conditions (e.g., control voltages, output current, output power, etc.), synchronizing signals, phase offset settings of each module, system control signals (e.g., from a central controller), error messages, and other information that may facilitate operation of a PV power generation system. Further, multiple signals may be modulated onto the PAMCC output, such as to enable communication of information to two or more different destination devices (e.g., an arbitrary two or more PAMCC modules and a system monitor server) simultaneously.

In an embodiment the controller 2116 illustrated in FIG. 23 may include a data encoding modulator/demodulator (modem) circuit coupled to the power line and configured to modulate multiple signals onto the PAMCC output and receive multiple signals via the grid. In another embodiment, the PAMCC controller may be 2116 configured to adjust the pulse amplitude modulation to include data-carrying variations in the output power pulses. Receiver circuits may be configured to recognize such data-carrying adaptive modulations within the power line, such as by filtering the power line for signals with a predetermined frequency different than that of the base (grid) signal or the individual pulses produced by the PAMCC. The ability to receive a communication signal from the grid may be provided by a transceiver or modem (not shown) in or coupled to the controller 2116. The controller may communicate information such as operating conditions, faults, identification information, or other information related to the operation of the PAMCC.

The various embodiments described herein may be useful for controlling any source of direct current and converting the direct current to three phase alternating current. Examples of direct current sources include solar panel, wind turbine, battery, geothermal, tidal, hydroelectric, thermoelectric and piezoelectric power systems. For the purpose of discussion, the example of a solar system embodiment is used as an example for describing the functioning and capabilities of the various embodiments. However, one skilled in the art would recognize that the circuits and processes described herein may be applied to other direct current sources as well. Accordingly, the scope of the claims should not be limited to solar power applications except as expressly recited in the claims.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a tangible non-transitory computer-readable medium or processor-readable medium. Non-transitory computer-readable and processor-readable media may be any available media that may be accessed by a computer or processor. By way of example, and not limitation, such non-transitory computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A device for generating three phase alternating electrical current from a direct electrical current, the device comprising:
a first input terminal for receiving a positive pulse amplitude modulated electrical current;
a second input terminal for receiving a negative pulse amplitude modulated electrical current;
a first, a second, and a third switch connected in parallel with the first input terminal;
a fourth, a fifth, and a sixth switch connected in parallel with the second input terminal;
a first output terminal connected to an output of the first switch and an output of the fourth switch;
a second output terminal connected to an output of the second switch and an output of the fifth switch;
a third output terminal connected to an output of the third switch and an output of the sixth switch; and
a controller coupled to the first, second, third, fourth, fifth, and sixth switches, wherein the controller is configured to control the operation of each switch to generate a first phase of power on the first output terminal, a second phase of power on the second output terminal, and a third phase of power on the third output terminal.

2. The device of claim 1, wherein the first, second, and third output terminals are connected in a delta configuration.

3. The device of claim 1, wherein the first, second, and third output terminals are connected in a wye configuration.

4. The device of claim 1, wherein the first, second, third, fourth, fifth, and sixth switches are thyristors, metal-oxide-semiconductor field-effect transistors (MOSFETs), relays, transistors, bi-polar transistors, insulated-gate bipolar transistors, silicon carbide MOSFETs, Gallium nitride transistors, N-type metal-oxide-semiconductor (NMOS) field effect transistors (FETs), series connected MOSFETs, thristor emulators, or diodes in series with insulated-gate bipolar transistors.

5. The device of claim 1, wherein the controller is a processor, the device further comprising:
a memory coupled to the processor; and
wherein the processor is configured with software instructions to perform steps comprising:
opening and closing the first, second, third, fourth, fifth, and sixth switches in response to a switch time table stored in the memory.

6. A pulse amplitude modulated current converter (“PAMCC”) for generating three phase alternating electrical current from direct electrical current, the device comprising:
a first input terminal for receiving a positive electrical current from a direct electrical current source;
a second input terminal for receiving a negative electrical current from the direct electrical current source;
a main switch connected across the first input terminal and the second input terminal;
a controller coupled to the main switch, the controller configured to control the main switch to generate a positive pulse amplitude modulated electrical current at the first input terminal and a negative pulse amplitude modulated electrical current at the second input terminal;
a first unfolding circuit connected across the first input terminal and the second input terminal, the first unfolding circuit coupled to the processor, and an output of the first unfolding circuit connected to a first output terminal;
a second unfolding circuit connected across the first input terminal and the second input terminal, the second unfolding circuit coupled to the processor, and an output of the third unfolding circuit connected to a second output terminal; and
a third unfolding circuit connected across the first input terminal and the second input terminal, the third unfolding circuit coupled to the processor, and an output of the third unfolding circuit connected to a third output terminal;
wherein the controller is further configured to control the operation of each unfolding circuit to generate a first phase of power on the first output terminal, a second phase of power on the second output terminal, and a third phase of power on the third output terminal.

7. The PAMCC of claim 6, wherein the first unfolding circuit comprises a first bidirectional switch comprising a first pair of field effect transistors (FETs) and a second bidirectional switch comprising a second pair of FETs;
wherein the second unfolding circuit comprises a third bidirectional switch comprising a third pair of FETs and a fourth bidirectional switch comprising a fourth pair of FETs;
wherein the third unfolding circuit comprises a fifth bidirectional switch comprising a fifth pair of FETs and a sixth bidirectional switch comprising a sixth pair of FETs; and
wherein the controller is coupled to each FET of each bidirectional switch to control the operation of each unfolding circuit.

8. The PAMCC of claim 6, wherein the first unfolding circuit comprises a first FET connected to a first diode and a second FET connected to a second diode;
wherein the second unfolding circuit comprises a third FET connected to third diode and a fourth FET connected to fourth diode;
wherein the third unfolding circuit comprises a fifth FET connected to a fifth diode and a sixth FET connected to a sixth diode; and
wherein the controller is coupled to each FET of each unfolding circuit to control the operation of each unfolding circuit.

9. The PAMCC of claim 8, wherein the first diode, the second diode, the third diode, the fourth diode, the fifth diode, and the sixth diode each comprise a diode pair.

10. A method for determining a scaling factor for a pulse amplitude modulated current converter (“PAMCC”), wherein the PAMCC comprises a memory and a processor couple to the memory, the processor configured to control the operation of the PAMCC, the method comprising:
connecting a grid power supply to an output terminal of the PAMCC;
providing a voltage from the grid power supply to the PAMCC equal to a desired nominal three phase voltage;
connecting a source of direct current to an input terminal of the PAMCC;
setting a first value of the scaling factor for the PAMCC to a high value;
scaling a switch time table stored in the memory using the first value of the scaling factor to produce a three phase output from the PAMCC equal to the voltage being supplied by the grid power supply;
decreasing the scaling factor set in the PAMCC while observing a voltage input from the source of direct current to the PAMCC until the voltage input to the PAMCC equals a desired nominal voltage;
storing the value of the scaling factor set in the PAMCC when the voltage input to the PAMCC equals a desired nominal voltage as a first scaling factor in the memory;
changing the value of the scaling factor set in the PAMCC such that the voltage input to the PAMCC is different from the desired nominal voltage;
storing a second scaling factor in the memory, the second scaling factor determined by dividing the difference between the changed value of the scaling factor set in the PAMCC when the voltage input to the PAMCC is different from the desired nominal voltage and the stored first scaling factor by the difference between the PAMCC voltage at the changed scaling factor and the desired nominal voltage;
removing the grid power supply from the PAMCC output terminal;
connecting a variable resistive load to the PAMCC output terminal;
changing the value of the scaling factor set in the PAMCC and a resistance of the variable resistive load such that the voltage input to the PAMCC equals the desired nominal voltage and the three phase output of the PAMCC is two volts above the desired nominal three phase voltage; and
storing a third scaling factor in the memory, the third scaling factor determined by dividing the difference between the changed value of scaling factor set in the PAMCC after changing the scaling factor and resistive load and the stored first scaling factor by the difference between the three phase output of the PAMCC and the desired nominal three phase voltage.

11. The method of claim 10, further comprising:
adding the first scaling factor, the second scaling factor, and the third scaling factor to determine a nominal scaling factor; and
storing the nominal scaling factor in the memory.

12. A system for generating three phase alternating electrical current power, the system comprising:
a plurality of photovoltaic panels each configured to output direct electrical current from output leads when exposed to light;
a plurality of pulse amplitude modulated current converters (“PAMCCs”) each connected to the direct electrical current output leads of one of the plurality of photovoltaic panels, each of the plurality of PAMCCs comprising input terminals, first, second and third output terminals, and a controller configured to perform operations comprising outputting a first pulse amplitude modulated current pulse at a first phase from the first output terminal, outputting a second pulse amplitude modulated current pulse at a second phase from the second output terminal, and outputting a third pulse amplitude modulated current pulse at a third phase from the third output terminal,
wherein the first output terminal of each PAMCC is electrically connected in parallel with the first output terminals of others of the plurality of PAMCCs, the second output terminal of each PAMCC is electrically connected in parallel with the second output terminals of others of the plurality of PAMCCs, and the third output terminal of each converter is electrically connected in parallel with the third output terminals of others of the plurality of PAMCCs, and
wherein the first, second and third current pulses of at least two of the plurality of PAMCCs are out of phase with respect to the first, second and third current pulses of each other such that the current pulses of each phase of the plurality of PAMCCs are summed in the system so that a signal modulated onto the pulse output of the converters is demodulated to produce three-phase alternating current output from the system.

13. The system of claim 12, wherein the controller of each of the plurality of PAMCCs comprises:
a memory; and
a processor coupled to the memory and configured with processor-executable instructions to perform operations comprising:
retrieving a stored target output voltage for the photovoltaic panel from the memory;
determining an instant voltage output of the photovoltaic panel; and
controlling the operation of the PAMCC such that the current drawn from the photovoltaic panel causes the instant voltage output of the photovoltaic panel to approach the target output voltage for the photovoltaic panel.

14. The system of claim 13, wherein the controlling the operation of the PAMCC such that the current drawn from the photovoltaic panel causes the instant voltage output of the photovoltaic panel to approach the target output voltage for the photovoltaic panel comprises:
populating a table resident in the memory with values corresponding to a length of time for closing switches connected to the first, second, and third output terminals of the PAMCC, the values for the switch closings being calculated using, at least in part, a scaling factor for the PAMCC stored in the memory.

15. The system of claim 14, wherein the processor is configured with processor-executable instructions to perform operations further comprising determining a temperature of the photovoltaic panel,
wherein retrieving a stored target output voltage for the photovoltaic panel from memory comprises selecting a target output voltage corresponding to the temperature of the photovoltaic panel; and
wherein populating a table resident in the memory with values corresponding to a length of time for closing switches connected to the first, second, and third output terminals of the PAMCC further includes calculating the values for the switch closing using, at least in part, the temperature of the photovoltaic panel.

16. The system of claim 12, wherein the controller of each of the plurality of PAMCCs comprises:
a memory; and
a processor coupled to the memory and configured with processor-executable instructions to perform operations comprising:
determining a temperature of the connected photovoltaic panel;
determining a voltage provided from the photovoltaic panel to the PAMCC;
determining a parameter based on the voltage and the temperature of the photovoltaic panel;
populating a first table stored in the memory with values corresponding to a length of time for closing a first switch set, the values for the first switch set closing calculated using, at least in part, the determined parameter;
populating a second table resident in the memory with values corresponding to a length of time for closing a second switch set, the values for the second switch set closing calculated using, at least in part, the determined parameter;
determining a first PAMCC switch set opening time duration based on the first table, the voltage, and the parameter;
determining a second PAMCC switch set opening time duration based on the second table, the voltage, and the parameter;
opening the first PAMCC switch set for the determined first switch set opening time duration;
opening the second PAMCC switch set for the determined second switch set opening time duration; and
determining a new parameter based on the parameter, the voltage, and a target voltage output value for the PAMCC.

17. The system of claim 12, wherein the controller of each of the plurality of PAMCCs comprises:
a memory;
a processor coupled to the memory and configured with processor-executable instructions to perform operations comprising:
executing a first control loop in which the processor controls a voltage output of the system in a single switching time cycle; and
executing a second control loop in which the processor controls the voltage output of the system over a time scale longer than a single switching time cycle.

18. The system of claim 12, wherein the controller of each of the plurality of PAMCCs comprises:
a memory;
a processor coupled to the memory and configured with processor-executable instructions to perform operations comprising:
determining a temperature of the photovoltaic panel;
determining an expected output voltage of the photovoltaic panel as a function of the temperature of the photovoltaic panel;
determining an instant value of the output voltage of the photovoltaic panel;
comparing the instant value of the output voltage of the photovoltaic panel to the expected value of the output voltage of the photovoltaic panel; and
controlling the operation of the PAMCC such that a value of current drawn from the photovoltaic panel prevents the instant value of the output voltage from exceeding a negative difference value of the expected output voltage.

19. The system of claim 18, wherein the processor is configured with processor-executable instructions to perform operations further comprising:
determining a maximum power point for the photovoltaic panel at the temperature of the photovoltaic panel;
determining a target voltage value corresponding to the maximum power point; and
controlling the operation of the PAMCC such that a value of current drawn from the photovoltaic panel causes the instant value of the output voltage to approach the target voltage value without exceeding the negative difference value of the expected output voltage.

20. The system of claim 12, wherein the controller of each of the plurality of PAMCCs comprises:
a memory;
a processor coupled to the memory and configured with processor-executable instructions to perform operations comprising:
determining an initial temperature of the photovoltaic panel;
determining an instant voltage of the photovoltaic panel;
determining an instant current of the photovoltaic panel;
determining a current versus voltage characteristic curve (“IV curve”) for the photovoltaic panel based at least in part on the initial temperature, the instant voltage, the instant current, and a thermal model of the photovoltaic panel;
determining an expected voltage of the photovoltaic panel as a function of the value of the initial temperature;
determining a minimum current value, the minimum current value corresponding to a greatest value of current drawn from the photovoltaic panel which will result in the output value of the voltage of the photovoltaic panel exceeding a negative difference value of the expected output voltage of the photovoltaic panel;
determining a target voltage value that maximizes the power generated by the photovoltaic panel for the determined IV curve;
controlling the operation of the PAMCC to drive the output voltage of the photovoltaic panel toward the target voltage value;
determining a new instant current of the photovoltaic panel; and
controlling the operation of the PAMCC to increase the output voltage of the photovoltaic panel if the new instant current is below the minimum current value.

21. The system of claim 20, wherein the processor is configured with processor-executable instructions to perform operations further comprising:
determining a new temperature of the photovoltaic panel;
determining a new instant voltage of the photovoltaic panel; and
determining whether the photovoltaic panel is uniformly illuminated or non-uniformly illuminated based at least in part on the new instant voltage and instant current of the photovoltaic panel;
when it is determined that the photovoltaic panel is uniformly illuminated:
determining a new IV curve for the photovoltaic panel based at least in part on the new temperature, the new instant voltage, the new instant current, and the thermal model of the photovoltaic panel;
determining a new expected voltage of the photovoltaic panel as a function of the value of the new temperature;
determining a new minimum current value, the new minimum current value corresponding to a greatest value of current drawn from the photovoltaic panel which will result in the output value of the voltage of the photovoltaic panel exceeding a negative difference value of the new expected output voltage of the photovoltaic panel;
determining a new target voltage value that maximizes the power generated by the photovoltaic panel for the new determined IV curve; and
controlling the operation of the PAMCC to drive the output voltage of the photovoltaic panel toward the new target voltage value; and
when it is determined that the photovoltaic panel is non-uniformly illuminated:
controlling the operation of the PAMCC to cause the output voltage of the photovoltaic panel to correspond to a safe operating voltage for the photovoltaic panel.

22. The system of claim 21, wherein the determining whether the photovoltaic panel is uniformly illuminated or non-uniformly illuminated comprises:
controlling the operation of the PAMCC to increase the output voltage of the photovoltaic panel by a voltage increment;
comparing the output voltage of the photovoltaic panel to the target voltage value;
determining the photovoltaic panel is uniformly illuminated if the output voltage is within the voltage increment of the target value; and
determining the photovoltaic panel is non-uniformly illuminated if the output voltage is not within the voltage increment of the target value.

23. The system of claim 22, wherein the voltage increment is approximately 1 volt.

24. The system of claim 22, wherein the voltage increment is a voltage selected to allow a minimal power variation near a maximum power point of the photovoltaic panel.

25. The system of claim 20, wherein the processor is configured with processor-executable instructions to perform operations further comprising:
determining a maximum current value, the maximum current value corresponding to safe current level for the photovoltaic panel; and
controlling the operation of the PAMCC to reduce the current output of the photovoltaic panel if the new instant current is above the maximum current value.

26. The system of claim 20, wherein the processor is configured with processor-executable instructions to perform operations further comprising:
determining a maximum current value, the maximum current value corresponding to a safe current level for the photovoltaic panel; and
controlling the operation of the PAMCC to stop generation of power by the photovoltaic panel if the new instant current is above the maximum current value.

27. The system of claim 12, wherein the controller of each of the plurality of PAMCCs comprises:
a transceiver coupled to the output;
a memory; and
a processor coupled to the memory and the transceiver, the processor configured with processor-executable instructions to perform operations comprising:
encoding information onto the current pulses of the PAMCC; and
receiving information from a signal received via the PAMCC output terminals.

28. A method for controlling a pulse amplitude modulated current converter (“PAMCC”) connected to the direct electrical current output leads of a photovoltaic panel, the PAMCC comprising input terminals, first, second and third output terminals, and a controller configured to perform operations comprising outputting a first pulse amplitude modulated current pulse at a first phase from the first output terminal, outputting a second pulse amplitude modulated current pulse at a second phase from the second output terminal, and outputting a third pulse amplitude modulated current pulse at a third phase from the third output terminal, the method comprising:
retrieving a stored target output voltage for the photovoltaic panel from a memory;
determining an instant voltage output of the photovoltaic panel; and
controlling the operation of the PAMCC such that the current drawn from the photovoltaic panel causes the instant voltage output of the photovoltaic panel to approach the target output voltage for the photovoltaic panel.

29. The method of claim 28, wherein the controlling the operation of the PAMCC such that the current drawn from the photovoltaic panel causes the instant voltage output of the photovoltaic panel to approach the target output voltage for the photovoltaic panel comprises:
populating a table resident in the memory with values corresponding to a length of time for closing switches connected to the first, second, and third output terminals of the PAMCC, the values for the switch closings calculated using, at least in part, a scaling factor for the PAMCC stored in the memory.

30. The method of claim 29, further comprising determining a temperature of the photovoltaic panel,
wherein retrieving a stored target output voltage for the photovoltaic panel from a memory comprises selecting a target output voltage corresponding to the temperature of the photovoltaic panel; and
wherein populating a table resident in the memory with values corresponding to a length of time for closing switches connected to the first, second, and third output terminals of the PAMCC further includes calculating the values for the switch closing using, at least in part, the temperature of the photovoltaic panel.

31. A method for controlling a pulse amplitude modulated current converter (“PAMCC”) connected to the direct electrical current output leads of a photovoltaic panel, the PAMCC comprising input terminals, first, second and third output terminals, and a controller configured to perform operations comprising outputting a first pulse amplitude modulated current pulse at a first phase from the first output terminal, outputting a second pulse amplitude modulated current pulse at a second phase from the second output terminal, and outputting a third pulse amplitude modulated current pulse at a third phase from the third output terminal, the method comprising:
determining a temperature of the connected photovoltaic panel;
determining a voltage provided from the photovoltaic panel to the PAMCC;
determining a parameter based on the voltage and the temperature of the photovoltaic panel;
populating a first table stored in a memory with values corresponding to a length of time for closing a first switch set, the values for the first switch set closing calculated using, at least in part, the determined parameter;
populating a second table resident in the memory with values corresponding to a length of time for closing a second switch set, the values for the second switch set closing calculated using, at least in part, the determined parameter;
determining a first PAMCC switch set opening time duration based on the first table, the voltage, and the parameter;
determining a second PAMCC switch set opening time duration based on the second table, the voltage, and the parameter;
opening the first PAMCC switch set for the determined first switch set opening time duration;
opening the second PAMCC switch set for the determined second switch set opening time duration; and
determining a new parameter based on the parameter, the voltage, and a target voltage output value for the PAMCC.

32. A method for controlling a pulse amplitude modulated current converter (“PAMCC”) connected to direct electrical current output leads of a photovoltaic panel, the PAMCC comprising input terminals, first, second and third output terminals, and a controller configured to perform operations comprising outputting a first pulse amplitude modulated current pulse at a first phase from the first output terminal, outputting a second pulse amplitude modulated current pulse at a second phase from the second output terminal, and outputting a third pulse amplitude modulated current pulse at a third phase from the third output terminal, the method comprising:
executing a first control loop in which the processor controls a voltage output of the system in a single switching time cycle; and
executing a second control loop in which the processor controls the voltage output of the system over a time scale longer than a single switching time cycle.

33. A method for controlling a pulse amplitude modulated current converter (“PAMCC”) connected to the direct electrical current output leads of a photovoltaic panel, the PAMCC comprising input terminals, first, second and third output terminals, and a controller configured to perform operations comprising outputting a first pulse amplitude modulated current pulse at a first phase from the first output terminal, outputting a second pulse amplitude modulated current pulse at a second phase from the second output terminal, and outputting a third pulse amplitude modulated current pulse at a third phase from the third output terminal, the method comprising:
determining a temperature of the photovoltaic panel;
determining an expected output voltage of the photovoltaic panel as a function of the temperature of the photovoltaic panel;
determining an instant value of the output voltage of the photovoltaic panel;
comparing the instant value of the output voltage of the photovoltaic panel to the expected value of the output voltage of the photovoltaic panel; and
controlling the operation of the PAMCC such that a value of current drawn from the photovoltaic panel prevents the instant value of the output voltage from exceeding a negative difference value of the expected output voltage.

34. The method of claim 33, further comprising:
determining a maximum power point for the photovoltaic panel at the temperature of the photovoltaic panel;
determining a target voltage value corresponding to the maximum power point; and
controlling the operation of the PAMCC such that the a value of current drawn from the photovoltaic panel causes the instant value of the output voltage to approach the target voltage value without exceeding the negative difference value of the expected output voltage.

35. A method for controlling a pulse amplitude modulated current converter (“PAMCC”) connected to the direct electrical current output leads of a photovoltaic panel, the PAMCC comprising input terminals, first, second and third output terminals, and a controller configured to perform operations comprising outputting a first pulse amplitude modulated current pulse at a first phase from the first output terminal, outputting a second pulse amplitude modulated current pulse at a second phase from the second output terminal, and outputting a third pulse amplitude modulated current pulse at a third phase from the third output terminal, the method comprising:
determining an initial temperature of the photovoltaic panel;
determining an instant voltage of the photovoltaic panel;
determining an instant current of the photovoltaic panel;
determining a current versus voltage characteristic curve (“IV curve”) for the photovoltaic panel based at least in part on the initial temperature, the instant voltage, the instant current, and a thermal model of the photovoltaic panel;
determining an expected voltage of the photovoltaic panel as a function of the value of the initial temperature;
determining a minimum current value, the minimum current value corresponding to the greatest value of current drawn from the photovoltaic panel which will result in the output value of the voltage of the photovoltaic panel exceeding a negative difference value of the expected output voltage of the photovoltaic panel;
determining a target voltage value that maximizes the power generated by the photovoltaic panel for the determined IV curve;
controlling the operation of the PAMCC to drive the output voltage of the photovoltaic panel toward the target voltage value;
determining a new instant current of the photovoltaic panel; and
controlling the operation of the PAMCC to increase the output voltage of the photovoltaic panel if the new instant current is below the minimum current value.

36. The method of claim 35, further comprising:
determining a new temperature of the photovoltaic panel;
determining a new instant voltage of the photovoltaic panel;
determining whether the photovoltaic panel is uniformly illuminated or non-uniformly illuminated based at least in part on the new instant voltage and instant current of the photovoltaic panel;
when it is determined that the photovoltaic panel is uniformly illuminated:
determining a new IV curve for the photovoltaic panel based at least in part on the new temperature, the new instant voltage, the new instant current, and the thermal model of the photovoltaic panel;
determining a new expected voltage of the photovoltaic panel as a function of the value of the new temperature;
determining a new minimum current value, the new minimum current value corresponding to the greatest value of current drawn from the photovoltaic panel which will result in the output value of the voltage of the photovoltaic panel exceeding a negative difference value of the new expected output voltage of the photovoltaic panel;
determining a new target voltage value that maximizes the power generated by the photovoltaic panel for the new determined IV curve; and
controlling the operation of the PAMCC to drive the output voltage of the photovoltaic panel toward the new target voltage value; and
when it is determined that the photovoltaic panel is non-uniformly illuminated:
controlling the operation of the PAMCC to cause the output voltage of the photovoltaic panel to correspond to a safe operating voltage for the photovoltaic panel.

37. The method of claim 36, wherein determining whether the photovoltaic panel is uniformly illuminated or non-uniformly illuminated further comprises:
controlling the operation of the PAMCC to increase the output voltage of the photovoltaic panel by a voltage increment;
comparing the output voltage of the photovoltaic panel to the target voltage value;
determining the photovoltaic panel is uniformly illuminated if the output voltage is within the voltage increment of the target value; and
determining the photovoltaic panel is non-uniformly illuminated if the output voltage is not within the voltage increment of the target value.

38. The method of claim 37, wherein the voltage increment is approximately 1 volt.

39. The method of claim 37, wherein the voltage increment is a voltage selected to allow a minimal power variation near a maximum power point of the photovoltaic panel.

40. The method of claim 35, further comprising:
determining a maximum current value, the maximum current value corresponding to safe current level for the photovoltaic panel; and
controlling the operation of the PAMCC to reduce the current output of the photovoltaic panel if the new instant current is above the maximum current value.

41. The method of claim 35, further comprising:
determining a maximum current value, the maximum current value corresponding to safe current level for the photovoltaic panel; and
controlling the operation of the PAMCC to stop generation of power by the photovoltaic panel if the new instant current is above the maximum current value.

42. A method for controlling a pulse amplitude modulated current converter (“PAMCC”) connected to the direct electrical current output leads of a photovoltaic panel, the PAMCC comprising input terminals, first, second and third output terminals, and a controller configured to perform operations comprising outputting a first pulse amplitude modulated current pulse at a first phase from the first output terminal, outputting a second pulse amplitude modulated current pulse at a second phase from the second output terminal, and outputting a third pulse amplitude modulated current pulse at a third phase from the third output terminal, the method comprising:
encoding information onto the current pulses of the PAMCC; and
receiving information from a signal received via the PAMCC output terminals.

43. A non-transitory processor-readable medium having stored thereon processor-executable instructions configured to cause a processor of a pulse amplitude modulated current converter (“PAMCC”) connected to the direct electrical current output leads of a photovoltaic panel and comprising input terminals, first, second, and third output terminals to perform operations comprising:
determining a temperature of the connected photovoltaic panel;
determining a voltage provided from the photovoltaic panel to the PAMCC;
determining a parameter based on the voltage and the temperature of the photovoltaic panel;
populating a first table stored in a memory with values corresponding to a length of time for closing a first switch set, the values for the first switch set closing calculated using, at least in part, the determined parameter;
populating a second table resident in the memory with values corresponding to a length of time for closing a second switch set, the values for the second switch set closing calculated using, at least in part, the determined parameter;
determining a first PAMCC switch set opening time duration based on the first table, the voltage, and the parameter;
determining a second PAMCC switch set opening time duration based on the second table, the voltage, and the parameter;
opening the first PAMCC switch set for the determined first switch set opening time duration;
opening the second PAMCC switch set for the determined second switch set opening time duration; and
determining a new parameter based on the parameter, the voltage, and a target voltage output value for the PAMCC.
